(19) United States
(12) Patent Application Publication
(10) Pub. No.: US 2026/0186248 A1
(43) Pub. Date: Jul. 2, 2026

(54) OPTICAL SYSTEM AND CAMERA MODULE COMPRISING SAME

(71) Applicant: LG INNOTEK CO., LTD., Seoul (KR)

(72) Inventor: Hyung Rok SHIM, Seoul (KR)

(21) Appl. No.: 18/847,101

(22) PCT Filed: Sep. 15, 2023
(86) PCT No.: PCT/KR2023/013988

§ 371 Date: Sep. 13, 2024

(51) Int. Cl. G02B 13/00; G02B 3/00; G02B 9/64; H04N 23/55

(52) U.S. Cl. CPC G02B 13/0045; G02B 9/64; G02B 13/0055; H04N 23/55; G02B 2003/0093

(57) ABSTRACT

The optical system disclosed in the embodiment includes first to eighth lenses disposed along an optical axis from an object side toward a sensor side, the first lens has positive (+) refractive power on the optical axis and has a shape in which an object-side surface is convex, and a number of meniscus-shaped lenses convex from the optical axis toward the object side among the first to eighth lenses is five or more, and each of an object-side surface and a sensor-side surface of the seventh lens has a critical point, each of an object-side surface and a sensor-side surface of the eighth lens has a critical point, the critical point of the object-side surface of the eighth lens is located closer to the optical axis than the critical points of the object-side surface and the sensor-side surface of the seventh lens.

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions. For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for this camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted. When the optical system includes a plurality of lenses, there is a problem in that it is difficult to derive excellent optical properties and aberration properties. In addition, when a plurality of lenses is included, the overall length, height, etc. may increase due to the thickness, interval, size, etc. of the plurality of lenses, thereby increasing the overall size of the module including the plurality of lenses.

In addition, the size of the image sensor is increasing to realize high-resolution and high-definition. However, when the size of the image sensor increases, TTL (Total Track Length) of the optical system including the plurality of lenses also increases, thereby increasing the thickness of the camera and the mobile terminal including the optical system. Therefore, a new optical system capable of solving the above problems is required.

### DISCLOSURE

### Technical Problem

An embodiment of the invention provides an optical system with improved optical properties. The embodiment provides an optical system having excellent optical performance at the center portion and periphery portion of a field of view. The embodiment provides an optical system capable of having a slim structure.

### Technical Solution

An optical system according to an embodiment of the invention includes first to eighth lenses disposed along an optical axis from an object side toward a sensor side, the first lens has positive (+) refractive power on the optical axis and has a shape in which an object-side surface is convex, and a number of meniscus-shaped lenses convex from the optical axis toward the object side among the first to eighth lenses is five or more, and each of an object-side surface and a sensor-side surface of the seventh lens has a critical point, each of an object-side surface and a sensor-side surface of the eighth lens has a critical point, the critical point of the object-side surface of the eighth lens is located closer to the optical axis than the critical points of the object-side surface and the sensor-side surface of the seventh lens, and the following equation satisfies: 1.5<ImgH/ΣCT/<2.2, and 1.6<ImgH/ΣCG/<2.3 (ImgH is ½ of a maximum diagonal length of an image sensor, and ΣCT is a sum of center thicknesses of the first to eight lenses, and ΣCG is a sum of center distances of the first to eighth lenses).

According to an embodiment of the invention, the critical point of the object-side surface of the eighth lens may be located closer to the optical axis than the critical point of the sensor-side surface of the eighth lens. Each of object-side and sensor-side surfaces of the fourth lens may have a critical point. Each of object-side and sensor-side surfaces of the fifth lens may have a critical point.

According to an embodiment of the invention, the optical system may satisfy the following equation: (TTL*n)>FOV (TTL is an optical axis distance from a center of the object-side surface of the first lens to an image surface of the image sensor, n is total number of lenses, and FOV is field of view).

According to an embodiment of the invention, the optical system may satisfy the following equations: ImgH<TTL, and 150<TTL*ImgH (ImgH is ½ of the maximum diagonal length of the image sensor, and TTL is an optical axis distance from a center of the object-side surface of the first lens to an image surface of the image sensor).

According to an embodiment of the invention, a refractive index of the first lens satisfies: 1.50<n1<1.6, a refractive index of the second lens satisfies: 1.60<n2, and n2 may be a largest among refractive indices of the lenses.

According to an embodiment of the invention, the first, second, fourth, fifth, and seventh lenses have a meniscus shape convex from the optical axis toward the object side, and the eighth lens may have a meniscus shape convex from the optical axis toward the object side.

According to an embodiment of the invention, a maximum effective diameter CA_Max of object-side surfaces and sensor-side surfaces of each of the first to eighth lenses may satisfy the following equation: 0.1<CA_Max/(2*ImgH)<1, and 0.5<TTL/CA_Max<2 (ImgH is ½ of the maximum diagonal length of the image sensor, and TTL is an optical axis distance from a center of the object-side surface of the first lens to an image surface of the image sensor).

According to an embodiment of the invention, the optical system may satisfy the following equation: (v2*n2)< (v1*n1) (v1 is an Abbe number of the first lens, v2 is an Abbe number of the second lens, and n1 is a refractive index of the first lens, and n2 is a refractive index of the second lens).

An optical system according to an embodiment of the invention includes a first lens having a meniscus shape convex toward an object side; a second lens disposed on a sensor side of the first lens; n-th lens closest to an image sensor; an n−1th lens disposed on an object side of the n-th lens; three or more lenses disposed between the second lens and the n−1th lens, wherein the second lens has a minimum effective diameter among the lenses of the optical system, and the n-th lens has a maximum effective diameter among the lenses of the optical system, and the first lens to the n-th lens are aligned with the optical axis (n is 10 or less), a number of lenses with positive refractive power among the n lenses is greater than a number of lenses with negative refractive power, an sensor-side surface of the n-th lens is a minimum among curvature radii of the object-side surfaces and the sensor-side surfaces of the lenses, a lens side surface with the maximum effective diameter among the lenses is CA_max, and ½ of a diagonal length of the image sensor is ImgH, and the following equation may satisfy: 0.5≤CA_max/(2*ImgH)<1.

According to an embodiment of the invention, a total effective focal length is F, the curvature radius of the object-side surface of the first lens is L1R1, the curvature radius of the sensor-side surface of the n-th lens is LnR2, and the following equation may satisfy: 1<F/L1R1<5, and 2<F/LnR2<4.5.

According to an embodiment of the invention, a sum of center thicknesses of the lenses is ECT, a sum of optical axis distances between two adjacent lenses is ΣCG, a maximum center thickness of the lenses is CT_Max, a maximum of the optical axis distances between the adjacent lenses is CG_Max, and may satisfy the equation: 0.5<ΣCT/ΣCG<1.2, and the equation: 15<(CT_Max+CG_Max)*n<45.

According to an embodiment of the invention, the object-side surface and the sensor-side surface of the n-th lens have a critical point, the object-side surface and the sensor-side surface of the n−1th lens have a critical point, the critical point of the sensor-side surface of the n-th lens may be disposed closer to the optical axis than the critical point of the object-side surface and the critical point of the sensor-side surface of the n−1th lens.

A camera module according to an embodiment of the invention includes an image sensor disposed on a sensor side of a plurality of lenses; and an optical filter disposed between the image sensor and a last lens, and the optical system may include an optical system disclosed above.

### Advantageous Effects

The optical system and the camera module according to the embodiment may have improved optical properties. In detail, the optical system may have improved aberration characteristics and resolution due to the surface shape, refractive power, thickness, and distances between adjacent lenses of the plurality of lenses. The optical system and the camera module according to the embodiment may have improved distortion and aberration characteristics, and may have good optical performance at the center portion and periphery portion of the field of view (FOV). The optical system according to the embodiment may have improved optical characteristics and a small total track length (TTL), so that the optical system and a camera module including the same may be provided in a slim and compact structure.

### DESCRIPTION OF DRAWINGS

FIG. 1 is a configuration diagram of an optical system and a camera module according to an embodiment of the invention.

FIG. 2 is an explanatory diagram showing the relationship between the image sensor, the n-th lens, and the n−1th lens of the optical system of FIG. 1.

FIG. 3 is a table showing lens data of the optical system of FIG. 1.

FIG. 4 is an example of the aspheric coefficient of the lenses of FIG. 1.

FIG. 5 is a table showing the thicknesses of the lenses and the distances between the lenses according to a direction perpendicular to the optical axis in the optical system of FIG. 1.

FIG. 6 is a table showing Sag values of the object-side and sensor-side surfaces of the seventh and eighth lenses in the optical system of FIG. 1.

FIG. 7 is a graph of the diffraction MTF of the optical system of FIG. 1.

FIG. 8 is a graph showing the aberration characteristics of the optical system of FIG. 1.

FIG. 9 is a graph showing Sag values for the object-side and sensor side surfaces of the nth and n−1th lenses in the optical system of FIG. 1.

FIG. 10 is a configuration diagram of an optical system and a camera module according to a second embodiment of the invention.

FIG. 11 is an explanatory diagram showing the relationship between the image sensor, the n-th lens, and the n−1th lens of the optical system of FIG. 10.

FIG. 12 is a table showing lens data according to the embodiment having the optical system of FIG. 10.

FIG. 13 is an example of the aspheric coefficient of the lenses of FIG. 10.

FIG. 14 is a table showing the thicknesses of the lenses and the distances between the lenses according to the direction perpendicular to the optical axis in the optical system of FIG. 10.

FIG. 15 is a table showing the Sag values of the object-side surface and the sensor-side surface of the n-th lens and the n−1th lens in the optical system of FIG. 10.

FIG. 16 is a table showing the inclination angles of the object-side surface and the sensor-side surface of the n-th lens and n−1th lens of FIG. 10.

FIG. 17 is a graph of the diffraction MTF of the optical system of FIG. 10.

FIG. 18 is a graph showing the aberration characteristics of the optical system of FIG. 10.

FIG. 19 is a graph showing Sag values for the object-side and sensor-side surfaces of the nth and n−1th lenses in the optical system of FIG. 10.

FIG. 20 is a diagram showing a camera module according to an embodiment applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing object side on the optical axis OA, and “sensor-side surface” may refer to a surface of the lens facing the imaging surface (image sensor) with respect to the optical axis. A convex surface of the lens may mean that the lens surface on the optical axis or paraxial region has a convex shape, and a concave surface of the lens may mean that the lens surface on the optical axis or paraxial region has a concave shape. The curvature radius, center thickness, and distance between lenses described in the table for lens data may mean values on the optical axis. The vertical direction may mean a direction perpendicular to the optical axis, and an end of the lens or the lens surface may mean the end or edge of the effective region of the lens through which the incident light passes. A size of the effective diameter of the lens surface may have a measurement error of up to ±0.4 mm depending on the measurement method. The paraxial region refers to a very narrow region near the optical axis, and is a region where the distance at which light rays fall from the optical axis OA is almost zero. Hereinafter, the concave or convex shape of the lens surface is described on the optical axis, and may also include the paraxial region.

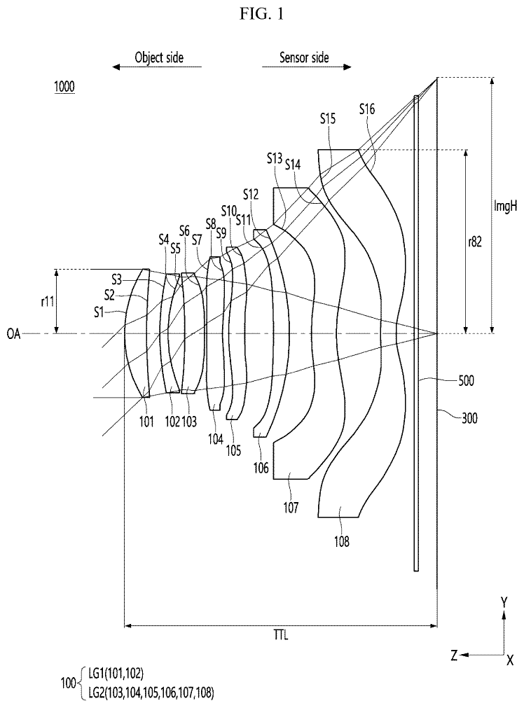

FIG. 1 is a diagram showing an optical system 1000 and a camera module having the same according to an embodiment of the invention. Referring to FIG. 1, the optical system 1000 or camera module may include a plurality of lens groups LG1 and LG2. Each of the plurality of lens groups LG1 and LG2 includes at least one lens, and a first lens group LG1 and a second lens group LG2 sequentially arranged along the optical axis OA from the object side toward the image sensor 300 may include. The number of lenses of the second lens group LG2 may be greater than the number of lenses of the first lens group LG1, for example, between two and four times the number of lenses of the first lens group LG1. The first lens group LG1 may include three or less lenses, for example, two lenses. The second lens group LG2 may include five or more lenses. The second lens group LG2 may include a larger number of lenses than the lenses of the first lens group LG1, for example, seven or less lenses. The number of lenses of the second lens group LG2 may be at least five or more than the number of lenses of the first lens group LG1, and may include, for example, six lenses.

In the optical system 1000, the total track length (TTL) may be less than 70% of the diagonal length of the image sensor 300, for example, in the range of 40% to 69% or 50% to 65%. The TTL is a distance in the optical axis OA from the object-side surface of the first lens 101 closest to an object to the image surface of the image sensor 300, and the diagonal length of the image sensor 300 is the maximum diagonal length of the image sensor 300 and may be twice the distance ImgH from the optical axis OA to the end of the diagonal. Accordingly, a slim optical system and a camera module having the same can be provided. The total number of lenses in the first and second lens groups LG1 and LG2 is seven to nine.

The first lens group LG1 may have positive (+) refractive power. The second lens group LG2 may have positive (+) refractive power. The first lens group LG1 and the second lens group LG2 have different focal lengths and the same refractive power, and thus may have good optical performance in the center and periphery portions of the field of view (FOV). The refractive power is a reciprocal of the focal length. The first lens group LG1 may include a stack of lenses having a meniscus shape convex toward the object. The second lens group LG2 may have a meniscus shape in which the lens closest to the object is convex toward the sensor side. The optical system 1000 may include ten or less lenses or nine or less lenses. The first lens group LG1 refracts the light incident through the object side to collect it, and the second lens group LG2 can refract light emitted through the first lens group LG1 so that it can spread to the periphery of the image sensor 300. Accordingly, the sensor-side surface of the first lens group LG1 may be concave on the optical axis, and the object-side surface of the second lens group LG2 may be convex on optical axis. The sensor-side surface of the first lens group LG1 and the object-side surface of the second lens group LG2 face each other.

When expressed as an absolute value, the focal length of the second lens group LG2 may be greater than the focal length of the first lens group LG1. For example, the absolute value of the focal length F_LG2 of the second lens group LG2 may be 1.1 times or more, for example, in a range of 1.1 to 2 times the absolute value of the focal length F_LG1 of the first lens group LG1. Accordingly, the optical system 1000 according to the embodiment can have improved aberration control characteristics such as chromatic aberration and distortion aberration by controlling the refractive power and focal length of each lens group, and may have good optical performance in the center and periphery portions of the FOV.

The optical axis distance between the first lens group LG1 and the second lens group LG2 in the optical axis OA is a separation distance on the optical axis OA, and may be the optical axis distance between a sensor-side surface of the lens closest to the sensor among the lenses in the first lens group LG1 and the object-side surface of the lens closest to the object among the lenses in the second lens group LG2. The optical axis distance between the first lens group LG1 and the second lens group LG2 is greater than the center thickness of the last lens of the first lens group LG1 and may be less than the center thickness of the nearest lens of the object in the second lens group LG2. The optical axis distance between the first lens group LG1 and the second lens group LG2 may be 27% or more of the optical axis distance of the first lens group LG1, for example, may be in a range of 27% to 47% or 32% to 42% of the optical axis distance of the first lens group LG1. Here, the optical axis distance of the first lens group LG1 is a distance in the optical axis distance between the object-side surface of the lens closest to the object and the sensor-side surface of the lens closest to the sensor within the first lens group LG1. The optical axis distance between the first lens group LG1 and the second lens group LG2 may be 10% or less of the optical axis distance of the second lens group LG2, for example, may be in a range of 2% to 10% or 4% to 4%. The optical axis distance of the second lens group LG2 is a distance in the optical axis between the object-side surface of the lens closest to the object of the second lens group LG2 and the sensor-side surface of the lens closest to the sensor.

The lens with the minimum effective diameter within the first lens group LG1 may be the lens closest to the second lens group LG2. The lens with the minimum effective diameter within the second lens group LG2 may be the lens closest to the first lens group LG1. Here, the size of the effective diameter is an average value of the effective diameter of the object-side surface and the effective diameter of the sensor-side surface of each lens. Accordingly, the optical system 1000 can have good optical performance not only in the center portion but also in the periphery portion of the FOV, and can improve chromatic aberration and distortion aberration. The size of the lens with the minimum effective diameter in the first lens group LG1 may be smaller than the size of the lens with the minimum effective diameter in the second lens group LG2. The effective diameter difference between the lenses having the minimum effective diameter within the first lens group LG1 and the second lens group LG2 may be less than 0.2 mm. Accordingly, the incident light can be refracted into the effective region between the first and second lens groups LG1 and LG2, and then refracted to the periphery portion of the image sensor 300.

The lens closest to the object among the lenses of the first lens group LG1 may have positive (+) refractive power, and the lens closest to the sensor among the lenses of the second lens group LG2 may have negative (−) refractive power. In the optical system 1000, the number of lenses with positive (+) refractive power may be equal to the number of lenses with negative (−) refractive power. In the second lens group LG2, the number of lenses with positive (+) refractive power may be greater than the number of lenses with negative (−) refractive power. Two lenses facing each other in a region between the first and second lens groups LG1 and LG2 may have different refractive powers. Each of the plurality of lenses 100 may include an effective region and a non-effective region. The effective region may be a region through which light incident on each of the lenses 100 passes. That is, the effective region may be an effective region or an effective diameter region in which the incident light is refracted to realize optical characteristics. The non-effective region may be arranged around the effective region. The non-effective region may be a region where effective light does not enter the plurality of lenses 100. That is, the non-effective region may be a region unrelated to the optical characteristics. Additionally, the end of the non-effective region may be a region fixed to a barrel (not shown) that accommodates the lens.

The optical system 1000 may include an image sensor 300. The image sensor 300 can detect light and convert it into an electrical signal. The image sensor 300 may detect light that sequentially passes through the plurality of lenses 100. The image sensor 300 may include an element capable of detecting incident light, such as a charge coupled device (CCD) or a complementary metal oxide semiconductor (CMOS). The diagonal length of the image sensor 300 may be greater than 15 mm, for example, greater than 15 mm and less than 30 mm. Preferably, ImgH of the image sensor 300 may be greater than TTL. The optical system 1000 may include an optical filter 500. The optical filter 500 may be disposed between the second lens group LG2 and the image sensor 300. The optical filter 500 may be disposed between the image sensor 300 and a lens closest to the sensor among the plurality of lenses 100. For example, when the optical system 1000 is an 8-element lens, the optical filter 500 may be disposed between the eighth lens 108 and the image sensor 300. The optical filter 500 may include an infrared filter. The optical filter 500 may pass light in a set wavelength band and filter light in a different wavelength band. When the optical filter 500 includes an infrared filter, radiant heat emitted from external light can be blocked from being transmitted to the image sensor 300. Additionally, the optical filter 500 can transmit visible light and reflect infrared rays. As another example, a cover glass may be further disposed between the optical filter 500 and the image sensor 300.

The optical system 1000 according to the embodiment may include an aperture stop ST. The aperture stop ST may be a stopper that adjusts the amount of light incident on the optical system 1000. The aperture stop ST may be disposed around at least one lens of the first lens group LG1. For example, the aperture stop ST may be disposed around the object-side surface or sensor-side surface of the second lens 102. The aperture stop ST may be disposed between two adjacent lenses 101 and 102 among the lenses in the first lens group LG1. Alternatively, at least one lens selected from among the plurality of lenses 100 may function as an aperture stop. In detail, the object-side surface or the sensor-side surface of one lens selected from among the lenses of the first lens group LG1 may function as an aperture stop to adjust the amount of light. The straight-distance from the aperture stop ST to the sensor-side surface of the n-th lens may be smaller than the optical axis distance from the object-side surface of the first lens 101 to the sensor-side surface of the n-th lens. when the optical axis distance from the aperture stop ST to the sensor-side surface of the n-th lens is SD, the following condition may satisfy: SD<ImgH. Additionally, the following condition may satisfy: SD<TTL. EFL is the effective focal length of the entire optical system and can be defined as F. The EFL and ImgH may be the same or different from each other and may have a difference of 2 mm or less. The FOV of the optical system 1000 may be less than 120 degrees, for example, more than 70 degrees and less than 100 degrees. The F number F # of the optical system 1000 may be greater than 1 and less than 10, for example, 1.1≤F #≤5. Additionally, the F # may be smaller than the entrance pupil diameter EPD. Accordingly, the optical system 1000 has a slim size, can control incident light, and can have improved optical characteristics within the field of view.

The effective diameter of the lenses gradually decreases from the object-side lens to a lens surface between the first and second lens groups LG1 and LG2, and may gradually increase from the lens surface between the first and second lens groups LG1 and LG2 to a lens surface of the last lens. The optical system 1000 according to the embodiment may further include a reflection member (not shown) for changing the path of light. The reflective member may be implemented as a prism that reflects incident light from the first lens group LG1 in the direction of the lenses. Hereinafter, the optical system according to the embodiment will be described in detail.

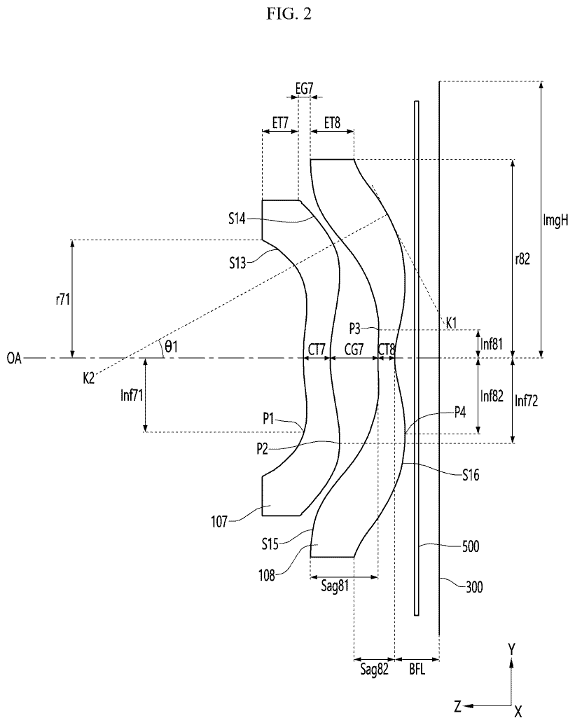

Referring to FIGS. 1 and 2, the optical system 1000 according to the first embodiment includes the lenses 100, wherein the lenses 100 may include a first lens 101 to a eighth lens 108 sequentially aligned along the optical axis OA. Light corresponding to object information may pass through the first to eighth lenses 101 to 108 and the optical filter 500 and be incident on the image sensor 300. The first lens group LG1 may include the first and second lenses 101 and 102, and the second lens group LG2 may include the third to eighth lenses 103-108. The optical axis distance between the second lens 102 and the third lens 103 may be a distance between the first and second lens groups LG1 and LG2 in the optical axis. Among the first to eighth lenses 101-108, the number of lenses having a meniscus shape convex from the optical axis toward the object may be 5 or more, and may satisfy, for example, n−2. The n is the total number of lenses, and may be, for example, 8.

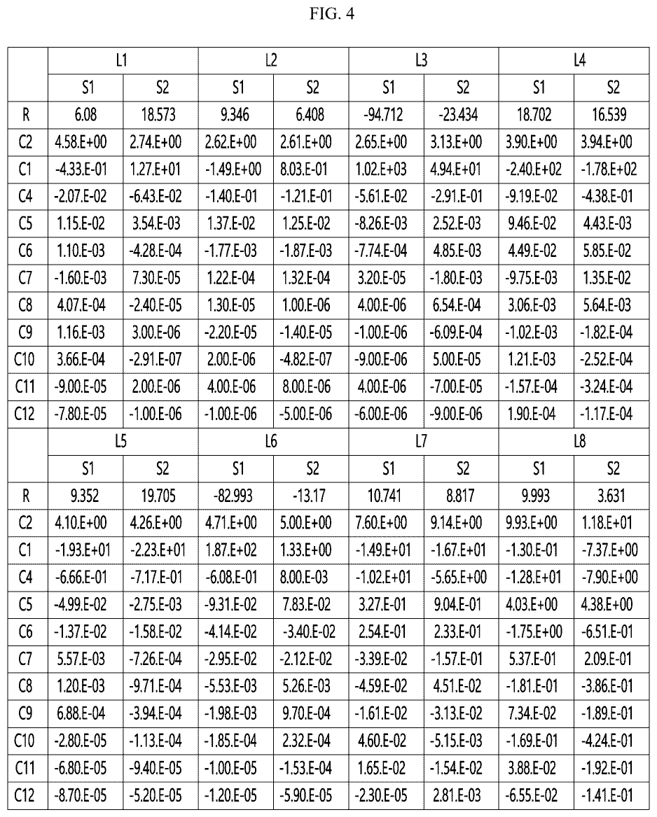

The first lens 101 may have negative (−) or positive (+) refractive power on the optical axis OA, and preferably may have positive (+) refractive power. The first lens 101 may include plastic or glass. For example, the first lens 101 may be made of plastic. The first lens 101 may include a first surface S1 on the object side and a second surface S2 on the sensor side. On the optical axis OA, the first surface S1 may have a convex shape, and the second surface S2 may have a concave shape. That is, the first lens 101 may have a meniscus shape that is convex on the optical axis OA toward the object. At least one of the first surface S1 and the second surface S2 may be an aspherical surface. The aspherical coefficients of the first and second surfaces S1 and S2 are provided as shown in FIG. 4, where L1 is the first lens 101, L1S1 is the first surface, and L1S2 is the second surface.

The second lens 102 may have positive (+) or negative (−) refractive power on the optical axis OA. The second lens 102 may have negative refractive power. The second lens 102 may include plastic or glass. For example, the second lens 102 may be made of plastic. The second lens 102 may include a third surface S3 on the object side and a fourth surface S4 on the sensor side. On the optical axis OA, the third surface S3 may have a convex shape, and the fourth surface S4 may have a concave shape. That is, the second lens 102 may have a meniscus shape that is convex on the optical axis OA toward the object. Differently, on the optical axis OA, the third surface S3 may have a convex shape, and the fourth surface S4 may have a convex shape. At least one of the third surface S3 and the fourth surface S4 may be an aspherical surface. The aspherical coefficients of the third and fourth surfaces S3 and S4 are provided as shown in FIG. 4, where L2 is the second lens 102, L2S1 is the third surface, and L2S2 is the fourth surface.

The third lens 103 may have positive (+) or negative (−) refractive power on the optical axis OA, and may preferably have positive (+) refractive power. The third lens 103 may include plastic or glass. For example, the third lens 103 may be made of plastic. The third lens 103 may include a fifth surface S5 on the object side and a sixth surface S6 on the sensor side. On the optical axis OA, the fifth surface S5 may have a concave shape, and the sixth surface S6 may have a convex shape. That is, the third lens 103 may have a meniscus shape that is convex on the optical axis OA toward the sensor. Differently, on the optical axis OA, the fifth surface S5 may have a concave shape, and the sixth surface S6 may have a concave shape. Alternatively, the third lens 103 may have a meniscus shape that is convex toward the object. At least one of the fifth surface S5 and the sixth surface S6 may be an aspherical surface. The aspheric coefficients of the fifth and sixth surfaces S5 and S6 are provided as shown in FIG. 4, where L3 is the third lens 103, L3S1 is the fifth surface, and L3S2 is the sixth surface.

The fourth lens 104 may have positive (+) or negative (−) refractive power on the optical axis OA. The fourth lens 104 may have negative refractive power. The fourth lens 104 may include plastic or glass. For example, the fourth lens 104 may be made of plastic. When expressing an absolute value, the focal length of the fourth lens 104 may be greater than the focal length of the seventh lens 107, and may, for example, satisfy the condition: 100<|F4|−|F7|<300. Here, the following condition may satisfy: 200<|F4|<400. The fourth lens 104 may have the largest focal length among the lenses. The fourth lens 104 may include a seventh surface S7 on the object side and an eighth surface S8 on the sensor side. On the optical axis OA, the seventh surface S7 may have a convex shape, and the eighth surface S8 may have a concave shape. That is, the fourth lens 104 may have a meniscus shape that is convex on the optical axis OA toward the object. Alternatively, the fourth lens 104 may have a shape in which both surfaces are concave on the optical axis. Alternatively, the fourth lens 104 may have a meniscus shape that is convex on the optical axis OA toward the sensor. At least one or both of the seventh and eighth surfaces S7 and S8 of the fourth lens 104 may have a critical point. At least one of the seventh surface S7 and the eighth surface S8 may be aspherical, and the aspherical coefficient is provided as shown in FIG. 4, where L4 is the fourth lens 104 and L4S1 is the seventh surface, and L4S2 is the eighth surface.

The fifth lens 105 may have positive (+) or negative (−) refractive power on the optical axis OA. The fifth lens 105 may have positive (+) refractive power. The fifth lens 105 may include plastic or glass. For example, the fifth lens 105 may be made of plastic. The fifth lens 105 may include a ninth surface S9 on the object side and a tenth surface S10 on the sensor side. On the optical axis OA, the ninth surface S9 may have a convex shape, and the tenth surface S10 may have a concave shape. That is, the fifth lens 105 may have a meniscus shape that is convex on the optical axis OA toward the object. Alternatively, the fifth lens 105 may have a shape in which both surfaces are concave on the optical axis. Alternatively, the fifth lens 105 may have a meniscus shape that is convex on the optical axis OA toward the sensor. At least one or both of the ninth and tenth surfaces S9 and S10 of the fifth lens 105 may have a critical point. At least one of the ninth surface S9 and the tenth surface S10 may be aspherical, and the aspherical coefficients of the ninth and tenth surfaces S9 and S10 are provided as shown in FIG. 4, and L5 is the fifth lens 105, L5S1 is the ninth surface, and L5S2 is the tenth surface.

The sixth lens 106 may have positive (+) or negative (−) refractive power on the optical axis OA. The sixth lens 106 may have negative (−) refractive power. The sixth lens 106 may include plastic or glass. For example, the sixth lens 106 may be made of plastic. The sixth lens 106 may include an eleventh surface S11 on the object side and a twelfth surface S12 on the sensor side. On the optical axis OA, the eleventh surface S11 may have a concave shape, and the twelfth surface S12 may have a convex shape. That is, the sixth lens 106 may have a meniscus shape that is convex on the optical axis OA toward the sensor. Alternatively, the sixth lens 106 may have a meniscus shape that is convex toward the object. Alternatively, the sixth lens 106 may have a shape where both sides are concave or both sides are convex. At least one or both of the eleventh and twelfth surfaces S11 and S12 of the sixth lens 106 may be provided without a critical point. At least one of the eleventh surface S11 and the twelfth surface S12 may be aspherical, and the aspheric coefficients of the eleventh and twelfth surfaces S11 and S12 are provided as shown in FIG. 4, and L6 is the sixth lenses 106, L6S1 is the eleventh surface, and L6S2 is the twelfth surface.

The seventh lens 107 may have positive (+) or negative (−) refractive power on the optical axis OA. The seventh lens 107 may have positive (+) refractive power. The seventh lens 107 may include plastic or glass. For example, the seventh lens 107 may be made of plastic. The seventh lens 107 may include a thirteenth surface S13 on the object side and a sensor-side fourteenth surface S14. The thirteenth surface S13 may have a convex shape on the optical axis OA, and the fourteenth surface S14 may have a concave shape on the optical axis OA. That is, the seventh lens 107 may have a meniscus shape convex on the optical axis OA toward the object. Alternatively, the seventh lens 107 may have a meniscus shape that is convex toward the sensor. Alternatively, the seventh lens 107 may have a shape with both sides concave or both sides convex on the optical axis OA. At least one or both of the thirteenth and fourteenth surfaces S13 and S14 of the seventh lens 107 may have a critical point. At least one of the thirteenth surface S13 and the fourteenth surface S14 may be an aspherical surface. For example, the thirteenth surface S13 and the fourteenth surface S14 may both be aspherical, and the aspherical coefficient is provided as shown in FIG. 4, L7 is the seventh lens 107, and L7S1 is the thirteenth surface, and L7S2 is the fourteenth surface.

The eighth lens 108 may have negative refractive power on the optical axis OA. The eighth lens 108 may include plastic or glass. For example, the eighth lens 108 may be made of plastic. The eighth lens 108 may be the lens closest to the sensor or the last n-th lens in the optical system 1000. The eighth lens 108 may include a fifteenth surface S15 on the object side and a sensor-side sixteenth surface S16. On the optical axis OA, the fifteenth surface S15 may have a convex shape, and the sixteenth surface S16 may have a concave shape. That is, the eighth lens 108 may have a meniscus shape that is convex on the optical axis OA toward the object. Alternatively, the eighth lens 108 may have a meniscus shape that is convex from the optical axis toward the sensor or a shape that is concave on both sides. At least one or both of the fifteenth and sixteenth surfaces S15 and S16 of the eighth lens 108 may have a critical point. The fifteenth and sixteenth surfaces S15 and S16 may be aspherical, and the aspheric coefficient is provided as shown in FIG. 4, L8 is the eighth lens 108, L8S1 is the fifteenth surface, and L8S2 is the sixteenth surface.

As shown in FIG. 2, each of the thirteenth surface S13 and the fourteenth surface S14 of the seventh lens 107 may have at least one critical point P1 and P2 from the optical axis OA to the end of the effective region. Each of the fifteenth surface S15 and the sixteenth surface S16 of the eighth lens 108 may have at least one critical point P3 and P4 from the optical axis OA to the end of the effective region. The critical point is a point at which the sign of the inclination value with respect to the optical axis OA and the direction perpendicular to the optical axis OA changes from positive (+) to negative (−) or from negative (−) to positive (+), and may mean a point at which the slope value is 0. Additionally, the critical point may be a point where the slope value decreases as it increases, or a point where it decreases and then increases.

The distance to the critical points of the thirteenth, fourteenth, fifteenth, and sixteenth surfaces S13, S14, S15, and S16 may be defined as follows.
Inf71: Straight distance from the optical axis of the thirteenth surface S13 to the first critical point P1
Inf72: Straight distance from the optical axis of the fourteenth surface S14 to the second critical point P2
Inf81: Straight distance from the optical axis of the fifteenth surface S15 to the third critical point P3
Inf82: Straight distance from the optical axis of the sixteenth surface S16 to the fourth critical point P4

The distance from the optical axis to each critical point may satisfy the following conditions. Inf71<Inf72 and Inf81<Inf82<Inf71

The effective radii of the thirteenth, fourteenth, fifteenth, and sixteenth surfaces S13, S14, S15, and S16 may be defined as r71, r72, r81, and r82, respectively, and the distances Inf71, inf72, inf81, and inf82 to the critical points P1, P2, P3, and P4 may satisfy at least one of the following conditions from the optical axis.

$$0.42 < Inf 71 / r 71 < 0.5 , 0.48 < Inf 72 / r 72 < 0.56 , \\ 0.1 < Inf 81 / r 81 < 0.22 , and 0.32 < Inf 82 / r 82 < 0.44$$

The positions of the first, second, and fourth critical points P1, P2, and P4 may be located 2 mm or more from the optical axis OA, for example, within a range of 2 mm to 4.2 mm, and the position of the third critical point P3 may be located less than 2 mm from the optical axis OA, for example, within a range of 0.5 mm to 1.9 mm. The position of the third critical point P3 may be located closer to the optical axis OA than the second critical point P2, and the position of the third critical point P3 may be located closer to the optical axis OA than the fourth critical point P4 and the first critical point P1. Accordingly, the seventh lens 107 can refract the incident light to the periphery portion, and the eighth lens 108 can refract the incident light to the periphery portion of the image sensor 300.

It is preferable that the positions of the critical points of the seventh and eighth lenses 107 and 108 are positioned to satisfy the above-mentioned range in consideration of the optical characteristics of the optical system 1000. In detail, it is desirable that the position of the critical point satisfies the above-mentioned range for controlling optical characteristics such as chromatic aberration, distortion characteristics, aberration characteristics, and resolution of the optical system 1000. Accordingly, the path of light emitted to the image sensor 300 through the lens can be effectively controlled. Accordingly, the optical system 1000 according to the first embodiment can have improved optical characteristics even in the center and periphery portions of the FOV.

In addition, the normal line K2, which is a straight line perpendicular to the tangent line K1 passing through an arbitrary point of the sensor-side sixteenth surface S16 of the eighth lens 108, may have a maximum first angle θ1 with respect to the optical axis OA, and the first angle θ1 may be greater than 5 degrees and less than 65 degrees, for example, in the range of 20 degrees to 50 degrees or 20 degrees to 40 degrees. Accordingly, a Sag value can be small based on the straight line perpendicular to the optical axis of the sixteenth surface S16, thereby providing a slim optical system. Here, a normal line perpendicular to the tangent passing through the fifteenth surface S15 of the eighth lens 108 may have a maximum second angle θ2 with the optical axis, and a normal line perpendicular to the tangent line passing through the fourteenth surface S14 of the seventh lens 107 may have a maximum third angle θ3 with the optical axis, and the normal line perpendicular to the tangent line passing through the thirteenth surface S13 of the seventh lens 107 may have a maximum fourth angle θ4 with the optical axis. It can have the following relationship.

The condition: θ1<θ2 is satisfied, and θ1 and θ2 may be 50 degrees or less, for example, in the range of 20 to 50 degrees. The condition: θ2<θ3<θ4 is satisfied, and θ3 and θ4 may be 35 degrees or more, for example, in the range of 35 to 70 degrees.

On the optical axis, the curvature radii of the first and second surfaces S1 and S2 of the first lens 101 are L1R1 and L1R2, the curvature radii of the fifth and sixth surfaces S5 and S6 of the third lens 103 are L3R1 and L3R2, the curvature radii of the seventh and eighth surfaces S7 and S8 of the fourth lens 104 are L4R1 and L4R2, the curvature radii of the ninth and tenth surfaces S9 and S10 of the fifth lens 105 are L5R1 and L5R2, the curvature radii of the eleventh and twelfth surfaces S11 and S12 of the sixth lens 106 are L6R1, L6R2, the curvature radii of the thirteenth and fourteenth surfaces S13 and S14 of the seventh lens 107 are L7R1 and L7R2, and the curvature radii of the fifteenth and sixteenth surfaces S15 and S16 of the eighth lens 108 may be defined as L8R1 and L8R2. The curvature radii may satisfy at least one of the following equations to improve the aberration characteristics of the optical system.

$$L 2 R 1 * L 2 R 2 < \vert L 3 R 1 \vert , \qquad ( Equation 1 )$$

$$L 1 R 1 < L 2 R 2 , \qquad ( Equation 2 )$$

$$L 8 R 2 < L 8 R 1 , \qquad ( Equation 3 )$$

$$L 8 R 1 * L 8 R 2 < \vert L 6 R 1 \vert , \qquad ( Equation 4 )$$

$$L 8 R 1 + L 8 R 2 < L 4 R 2 , \qquad ( Equation 5 )$$

$$L 7 R 1 + L 7 R 2 < \vert L 3 R 2 \vert , \qquad ( Equation 6 )$$

$$L 8 R 1 + L 8 R 2 < L 7 R 1 + L 7 R 2 , \qquad ( Equation 7 )$$

$$\vert L 6 R 1 * L 6 R 2 \vert < \vert L 3 R 1 * L 3 R 2 \vert , and \qquad ( Equation 8 )$$

$$L 5 R 1 + L 5 R 2 < L 4 R 1 + L 4 R 2 \qquad ( Equation 8 ) 9 )$$

On the optical system, the curvature radius of the eighteenth surface S18 of the eighth lens 108 may be minimum, and the curvature radius (absolute value) of the fifth surface S5 of the third lens 103 may be maximum. By setting this curvature radius, good optical performance can be provided at the focal length of each lens.

The effective diameter of the eighth lens 108 may have a maximum effective diameter of 15 mm or more. The effective diameter of the eighth lens 108 is the average of the effective diameters of the object-side and the sensor-side surface. The effective diameter of the eighth lens 106 may be more than twice the curvature radius (absolute value) of the twelfth surface S12. The effective diameters of the first and second surfaces S1 and S2 of the first lens 101 are CA_L1S1 and CA_L1S2, the effective diameters of the third and fourth surfaces S3 and S4 of the second lens 102 are CA_L2S1 and CA_L2S2, the effective diameters of the fifth and sixth surfaces S5 and S6 of the third lens 103 are CA_L3S1 and CA_L3S2, the effective diameters of the seventh and eighth surfaces S7 and S8 of the fourth lens 104 are CA_L4S1 and CA_L4S2, the effective diameters of the ninth and tenth surfaces S9 and S10 of the fifth lens 105 are CA_L5S1 and CA_L5S2, the effective diameters of the eleventh and twelfth surfaces S11 and S12 of the sixth lens 106 are CA_L6S1 and CA_L6S2, the effective diameters of the thirteenth and fourteenth surfaces S13 and S14 of the seventh lens 107 are CA_L7S1 and CA_L7S2, and the effective diameters of the fifteenth and sixteenth surfaces S15 and S16 of the eighth lens 108 may be defined as CA_L8S1 and CA_L8S2. These effective diameters are factors that affect the aberration characteristics of the optical system, and may satisfy at least one of the following equations.

$$CA\_L2S2 < CA\_L2S1 < CA\_L1S1 \qquad ( Equation 1 )$$

$$CA\_L5S1 < CA\_L5S2 < CA\_L6S1 < CA\_L6S2 \qquad ( Equation 2 )$$

$$CA\_L6S2 < CA\_L7S1 < CA\_L7S2 < CA\_L8S1 < CA\_L8S2 \qquad ( Equation 3 )$$

$$CA\_L2S1 - CA\_L3S1 < CA\_L1S1 - CA\_L1S2 \qquad ( Equation 3 )$$

$$CA\_L5S1 + CA\_L5S2 < CA\_L8S2 \qquad ( Equation 4 )$$

$$L 8 R 1 + L 8 R 2 < CA\_L8S2 \qquad ( Equation 5 )$$

Among the first to eighth lenses 101-108, the average effective diameter of the lenses may be the smallest for the second lens 102 and the largest for the eighth lens 108. The effective diameter of the fourth surface S4 or the fifth surface S5 may be the minimum, and the effective diameter of the sixteenth surface S16 may be the largest. The effective diameter of the eighth lens 108 is the largest, so that it can effectively refract incident light toward the image sensor 300. Accordingly, the optical system 1000 can have improved chromatic aberration control characteristics, and the vignetting characteristics of the optical system 1000 can be improved by controlling incident light.

In the optical system, the number of lenses with a refractive index exceeding 1.6 may be 2 or less, and may be smaller than the number of lenses with a refractive index of less than 1.6. The average refractive index of the first to eighth lenses 101-108 may be less than 1.6. In the optical system, the number of lenses with an Abbe number greater than 45 may be greater than the number of lenses with an Abbe number of less than 45. The average Abbe number of the first to eighth lenses 101-108 may be greater than 45.

Back focal length BFL is an optical axis distance from the image sensor 300 to the last lens. That is, BFL is the optical axis distance between the image sensor 300 and the sixteenth sensor-side surface S16 of the eighth lens 108. CT7 is a center thickness or optical axis thickness of the seventh lens 107, and L7_ET is the end or edge thickness of the effective region of the seventh lens 107. CT8 is the center thickness or optical axis thickness of the eighth lens 108. CG7 is the optical axis distance (i.e., center distance) from the center of the sensor-side surface of the seventh lens 107 to the center of the object-side surface of the eighth lens 108. That is, the optical axis distance CG7 from the center of the sensor-side surface of the seventh lens 107 to the center of the object-side surface of the eighth lens 108 is a distance between the fourteenth surface S14 and the fifteenth surface S15 in the optical axis OA. CG7 may be greater than the optical axis distance between the third and fourth lenses 103 and 104. CG7 may be smaller than the sum of the center thicknesses of the seventh and eighth lenses 107 and 108.

Among the first to eighth lenses 101-108, the lens with the maximum center thickness is the seventh lens 107. The center thickness CT7 of the seventh lens 107 may be greater than the optical axis distance between the sixth and seventh lenses 106 and 107 and smaller than the optical axis distance CG7 between the seventh and eighth lenses 107 and 108. The lens with the minimum center thickness may be the second lens 102. Accordingly, the optical system 1000 can control incident light and have improved aberration characteristics and resolution. The center distance CG7 between the seventh lens 107 and the eighth lens 108 is the maximum among the distances between lenses, and the optical axis distance between the third and fourth lenses 103 and 104 is the minimum among the distances between the lenses. Among the lenses 101-108, the maximum center thickness may be 2.5 times or more, for example, 2.5 to 5 times the minimum center thickness. Among the lenses, the number of lenses with a center thickness of less than 0.5 mm may be smaller than the number of lenses with a center thickness of 0.5 mm or more, and may be 2 or less. The average center thickness of the lenses may be more than 0.6 mm. The optical system 1000 having an image sensor 300 with a size of around 1 inch can be provided in a structure with a slim thickness.

When defining the focal length of each lens 101-108 as F1-F8, the following conditions may satisfy: F2<F4 and F1<F3. Additionally, the following condition may satisfy: F8<F7<F4. By adjusting this focal length, resolution can be affected. when the focal length is described as an absolute value, the focal length of the fourth lens 104 may be the largest among the lenses, the focal length of the eighth lens 108 may be the minimum, and the difference between the focal lengths of the first and eighth lenses 101 and 108 may be 10 mm or less. The maximum focal length may be 20 times or more than the minimum focal length. when the refractive index of each lens 101-108 is n1-n8 and the Abbe number of each lens 101-108 is v1-v8, the refractive index may satisfy the condition: n1<n2, and n1, n3, n4, n5, n6, n7, and n8 are less than 1.6 and may have a difference of less than 0.3 from each other, and n2 is more than 1.60 and may be the largest among the refractive indices of lenses. Abbe number may satisfy the condition: v2<v1, and v1, v3, v4, v5, v6, v7, and v8 may be 45 or more and have a difference of 10 or less from each other, and v2 may be less than 45, for example, 30 or less. Accordingly, the optical system 1000 may have improved chromatic aberration control characteristics.

The optical system 1000 according to the first embodiment disclosed above may satisfy at least one or two of the equations described below. Accordingly, the optical system 1000 according to the first embodiment may have improved optical characteristics. For example, when the optical system 1000 satisfies at least one equation, the optical system 1000 can effectively control aberration characteristics such as chromatic aberration and distortion aberration, and may have good optical performance not only in the center portion but also in the periphery portion of the FOV. The optical system 1000 may have improved resolution and may have a slimmer and more compact structure. Hereinafter, the center thickness of the first to eighth lenses 101-108 may be defined as CT1-CT8, the edge thickness may be defined as ET1-ET8, and the optical axis distances between two adjacent lenses may be defined as CG1 to CG8 from the distance between the first and second lenses to the distance between the seventh and eighth lenses, and the edge distances between two adjacent lenses may be defined as EG1 to EG8 from the distance between the first and second lenses to the distance between the seventh and eighth lenses. The unit of the thickness and distance is mm.

$$1 < CT 1 / CT 2 < 4 \qquad [ Equation 1 ]$$

In Equation 1, when the thickness CT1 in the optical axis OA of the first lens 101 and the thickness CT2 in the optical axis OA of the second lens 102 are satisfied, the optical system 1000 can improve aberration characteristics. Preferably, Equation 1 may satisfy: 2≤CT1/CT2<3.

$$1 < CT 3 / ET 3 < 3 \qquad [ Equation 2 ]$$

In Equation 2, when the thickness CT3 in the optical axis of the third lens 103 and the thickness ET3 at the edge of the effective region of the third lens 103 are satisfied, the optical system 1000 may have improved chromatic aberration control characteristics. Preferably, Equation 2 may satisfy: 1.5<CT3/ET3≤2.5.

$$2 < CT 1 / ET 1 < 3.5 \qquad [ Equation 2 - 1 ]$$

$$0 < CT 2 / ET 2 < 1 \qquad [ Equation 2 - 2 ]$$

$$( CT 2 + CT 3 ) > CT 1 \qquad [ Equation 2 - 3 ]$$

$$1 < CT 4 / ET 4 < 3 \qquad [ Equation 2 - 4 ]$$

$$1 < CT 5 / ET 5 < 3 \qquad [ Equation 2 - 5 ]$$

$$1 < CT 6 / ET 6 < 2.5 \qquad [ Equation 2 - 6 ]$$

$$0 < CT 7 / ET 7 < 1.2 \qquad [ Equation 2 - 7 ]$$

$$0 < CT 8 / ET 8 < 1 \qquad [ Equation 2 - 8 ]$$

$$0.5 < SD / TD < 1 \qquad [ Equation 2 - 9 ]$$

When the ratio between the center thickness and the edge thickness of the second to eighth lenses 102-108 is satisfied in Equations 2-1 to 2-8, the optical system 1000 may have improved chromatic aberration control characteristics. SD is the optical axis distance from the aperture stop to the sensor-side sixteenth surface S16 of the eighth lens 108, and TD is the optical axis distance from the object-side first surface S1 of the first lens 101 to the sensor-side sixteenth surface S16 of the eighth lens 108. The aperture stop may be disposed around the object-side surface of the second lens 102. When the optical system 1000 according to the first embodiment satisfies Equation 2-9, the chromatic aberration of the optical system 1000 can be improved.

$$1 < F\_LG2 / F\_LG1 < 3 \qquad [ Equation 2 - 10 ]$$

F_LG1 is a focal length of the first lens group LG1, and F_LG2 is a focal length of the second lens group LG2. When the optical system 1000 according to the first embodiment satisfies Equation 2-10, the chromatic aberration of the optical system 1000 can be improved. That is, as the value of Equation 2-10 approaches 1, the distortion aberration can be reduced. The value of Equation 2-10 may satisfy: 1<F_LG2/F_LG1<2.

$$1 < ET 8 / CT 8 < 3 \qquad [ Equation 3 ]$$

In Equation 3, when the thickness CT8 in the optical axis and the thickness (ET8) at the edge of the eighth lens 108 are satisfied, the optical system 1000 can have improved chromatic aberration control characteristics. Equation 3 may satisfy: 2≤ET8/CT8<3. Additionally, the condition CT6+CT8<ET8 can be satisfied.

$$1.6 < n 2 \qquad [ Equation 4 ]$$

In Equation 4, n2 means the refractive index at the d-line of the second lens 102. When the optical system 1000 according to the first embodiment satisfies Equation 4, the optical system 1000 can improve chromatic aberration characteristics.

$$1.5 < n 1 < 1.6 , 1.5 < n 8 < 1.6 \qquad [ Equation 4 - 1 ]$$

In Equation 4-1, n1 is the refractive index at the d-line of the first lens 101, and n8 is the refractive index at the d-line of the eighth lens 108. When the optical system 1000 according to the first embodiment satisfies Equation 4-1, the influence on the TTL of the optical system 1000 can be suppressed.

$$1.5 < n 4 < 1.6 \qquad [ Equation 4 - 2 ]$$

$$1.5 < n 6 < 1.6$$

In Equation 4-2, n4 means the refractive index at the d-line of the fourth lens 104, and n6 means the refractive index at the d-line of the sixth lens 106. When the optical system 1000 according to the first embodiment satisfies Equation 4-2, the optical system 1000 can improve chromatic aberration characteristics.

$$1 < L8S2\_Max \_Sag to Sensor < 2 \qquad [ Equation 5 ]$$

In Equation 5, L8S2_Max_Sag to Sensor means a distance in the optical axis direction from the maximum Sag value of the sensor-side sixteenth surface S16 of the eighth lens 108 to the image sensor 300. For example, L8S2_Max_Sag to Sensor means the distance in the optical axis direction from the critical point P2 on the sensor-side surface of the eighth lens 108 to the image sensor 300. When the optical system 1000 according to the first embodiment satisfies Equation 5, the optical system 1000 secures a space where the optical filter 500 can be placed between the lens unit 100 and the image sensor 300, thereby having improved assembly properties. Additionally, when the optical system 1000 satisfies Equation 5, the optical system 1000 can secure a distance for module manufacturing. Preferably, the value of Equation 5 may satisfy: 1.3<L8S2_Max_Sag to Sensor<1.8.

In the lens data for the first embodiment, the position of the filter 500, the detailed distance between the last lens and the filter 500, and the distance between the image sensor 300 and the filter 500 are a position set for convenience of design of the optical system 1000, and the filter 500 may be freely arranged within a range that does not contact the last lens and the image sensor 300. Accordingly, the value of L8S2_Max_Sag to Sensor in the lens data may be smaller than the BFL (Back focal length) of the optical system 1000, and the position of the filter 500 may be moved within a range that does not contact the last lens and the image sensor 300, respectively, so that good optical performance may be achieved. That is, on the sixteenth surface S16 of the eighth lens 108, the distance between the critical point P2 and the image sensor 300 is minimum, and may gradually increase toward the end of the effective region.

$$1 < BFL / L8S2\_Max \_Sag to Sensor < 2 \qquad [ Equation 6 ]$$

In Equation 6, the back focal length (BFL) means the distance (mm) in the optical axis OA from the center of the sensor-side sixteenth surface S16 of the eighth lens 108 closest to the image sensor 300 to the image surface of the image sensor 300. When the optical system 1000 according to the first embodiment satisfies Equation 6, the optical system 1000 can improve distortion aberration characteristics and have good optical performance in the periphery region of the FOV. Here, the maximum Sag value may be the critical point position. Equation 6 may satisfy: 1≤BFL/L8S2 Max_Sag to Sensor<1.5.

$$5 < \vert L8S2\_Max slope \vert < 65 \qquad [ Equation 7 ]$$

In Equation 7, L8S2_Max slope means the maximum value (Degree) of the tangential angle measured on the sensor-side sixteenth surface S16 of the eighth lens 108. In detail, L8S2_Max slope in the sixteenth surface S16 means the angle value (Degree) of the point having the largest tangent angle with respect to an imaginary line extending in a direction perpendicular to the optical axis OA. When the optical system 1000 according to the first embodiment satisfies Equation 7, the optical system 1000 can control the occurrence of lens flare. Preferably, Equation 7 may satisfy: 20≤|L8S2_Max slope|≤50.

$$1 < Inf 81 < 1.5 \qquad [ Equation 8 ]$$

In Equation 8, Inf81 may mean the distance from the optical axis OA to the critical point (or inflection point) of the object-side fifteenth surface S15 of the eighth lens 108. The Inf81 may be located within 1.2 mm+0.2 mm from the optical axis OA. When the optical system 1000 according to the first embodiment satisfies Equation 8, influence on the slim rate of the optical system 1000 can be suppressed.

$$1 < CG 7 / G7\_Min < 15 \qquad [ Equation 9 ]$$

Equation 9 means the minimum distance (mm) between the seventh lens 107 and the eighth lens 108 and the distance CG7 between the seventh lens 107 and the eighth lens 108 based on the optical axis OA. When the optical system 1000 according to the first embodiment satisfies Equation 9, the optical system 1000 can improve distortion aberration characteristics and have good optical performance in the periphery portion of the FOV. Equation 9 may satisfy: 3<CG7/G7_Min<12 or 3<CG7/G7_Min≤8.

$$1 < CG 7 / EG 7 < 5 \qquad [ Equation 10 ]$$

In Equation 10, when the optical axis distance CG7 between the seventh and eighth lenses 107 and 108 and the optical axis distance EG8 at the ends of the effective regions between the seventh and eighth lenses 107 and 108 are satisfied, good optical performance may also be obtained on the center and periphery portions of the FOV. Additionally, the optical system 1000 can reduce distortion and have improved optical performance. Preferably, Equation 10 may satisfy: 3<CG7/EG7<4.

$$0.01 < CG 1 / CG 6 < 1 \qquad [ Equation 11 ]$$

In Equation 11, when the optical axis distance CG1 between the first lens 101 and the second lens 102 and the optical axis distance CG6 between the sixth and seventh lenses 106 and 107 are satisfied, the optical system 1000 may improve aberration characteristics and control the size of the optical system 1000, for example, reducing TTL. Preferably, Equation 11 may satisfy: 0.4<CG1/CG6<0.9.

$$3 < CA\_L8S2 / CG 7 < 20 \qquad [ Equation 11 - 1 ]$$

In Equation 11-1, CA_L8S2 is the effective diameter of the largest lens surface and is the effective diameter of the sensor-side sixteenth surface S16 of the eighth lens 108. When the optical system 1000 according to the first embodiment satisfies Equation 11-1, the optical system 1000 can improve aberration characteristics and control TTL reduction. Preferably, Equation 11-1 may satisfy: 5<CA_L8S2/CG7<10.

$$3 < CA\_L7S2 / CG 7 < 15 \qquad [ Equation 11 - 2 ]$$

Equation 11-2 can set the effective diameter CA_L7S2 of the sensor-side fourteenth surface S14 of the seventh lens 107 and the optical axis distance between the seventh and eighth lenses 107 and 108. When the optical system 1000 according to the first embodiment satisfies Equation 11-2, the optical system 1000 can improve aberration characteristics and control TTL reduction. Preferably, Equation 11-2 may satisfy: 5<CA_L7S2/CG7<9.

$$0 < CT 1 / CT 7 < 2 \qquad [ Equation 12 ]$$

In Equation 12, when the thickness CT1 in the optical axis OA of the first lens 101 and the thickness CT7 in the optical axis OA of the seventh lens 107 are satisfied, the optical system 1000 may have improved aberration characteristics. Additionally, the optical system 1000 has good optical performance at a set FOV and can control TTL. Preferably, Equation 12 may satisfy: 0.5<CT1/CT7<1.

$$0 < CT 6 / CT 7 < 3 \qquad [ Equation 13 ]$$

In Equation 13, when the thickness CT6 in the optical axis OA of the sixth lens 106 and the thickness CT7 in the optical axis of the seventh lens 107 are satisfied, the optical system 1000 may alleviate manufacturing precision of the seventh and eighth lenses 107 and 108, and may improve optical performance of the central and periphery portions of the FOV. Preferably, Equation 13 may satisfy: 0<CT6/CT7<1. The center thickness of the fifth, sixth, and seventh lenses may satisfy the following condition: CT7< (CT5+CT6)<CT7*2. Additionally, the center thickness of the first, sixth, seventh, and eighth lenses may satisfy the condition: CT6<CT1<CT7.

$$0 < L 7 R 2 / L 8 R 1 < 2 \qquad [ Equation 14 ]$$

In Equation 14, L7R2 means the curvature radius (mm) on the optical axis of the fourteenth surface S14 of the seventh lens 107, and L8R1 means the curvature radius (mm) on the optical axis of the fifteenth surface S15 of the eighth lens 108. When the optical system 1000 according to the first embodiment satisfies Equation 14, the aberration characteristics of the optical system 1000 can be improved. Preferably, Equation 14 may satisfy: 0.5<L7R2/L8R1<1.

$$0 < ( CG 6 - EG 6 ) / ( CG 6 ) < 2 \qquad [ Equation 15 ]$$

If Equation 15 satisfies the center distance CG6 and edge distance CG7 between the sixth and seventh lenses 106 and 107, the optical system 1000 can reduce the occurrence of distortion and have improved optical performance. When the optical system 1000 according to the first embodiment satisfies Equation 15, optical performance in the center and periphery portions of the FOV can be improved. Equation 15 may preferably satisfy: 0.5< (CG6−EG6)/(CG6)<1. Here, when comparing the center distances CG between the fourth, fifth, sixth, seventh, and eighth lenses, CG4<CG6<CG5<CG7 can be satisfied.

$$1 < CA\_L1S1 / CA\_L2S2 < 2 \qquad [ Equation 16 ]$$

In Equation 16, CA_L1S1 means the effective diameter (Clear aperture, CA) of the first surface S1 of the first lens 101, and CA_L2S2 means the effective diameter (CA) of the fourth surface S4 of the second lens 102. When the optical system 1000 according to the first embodiment satisfies Equation 16, the optical system 1000 can control light incident on the first lens group LG1 and have improved aberration control characteristics. Equation 16 may preferably satisfy: 1<CA_L1S1/CA_L2S2<1.5.

$$1 < CA\_L7S2 / CA\_L3S1 < 5 \qquad [ Equation 17 ]$$

In Equation 17, CA_L3S1 means the effective diameter of the fifth surface S5 of the third lens 103, and CA_L7S2 means the effective diameter of the fourteenth surface S14 of the seventh lens 107. When the optical system 1000 according to the first embodiment satisfies Equation 17, the optical system 1000 can control light incident on the second lens group LG2 and improve aberration characteristics. Preferably, Equation 17 may satisfy: 2<CA_L7S2/CA_L3S1<3.

$$0.5 < CA\_L2S2 / CA\_L3S1 < 1.5 \qquad [ Equation 18 ]$$

In Equation 18, when the effective diameter CA_L2S2 of the fourth surface S4 of the second lens 102 and the effective diameter CA_L3S1 of the fifth surface S5 of the third lens 103 are satisfied, the optical system 1000 can improve chromatic aberration and control vignetting for optical performance. Preferably, Equation 18 may satisfy: 0.7<CA_L2S2/CA_L3S1<1.

$$0.1 < CA\_L5S2 / CA\_L7S2 < 1 \qquad [ Equation 19 ]$$

In Equation 19, when the effective diameter CA_L5S2 of the tenth surface S10 of the fifth lens 105 and the effective diameter CA_L7S2 of the fourteenth surface S14 of the seventh lens 107 are satisfied, the optical system 1000 can improve chromatic aberration. Preferably, Equation 19 may satisfy: 0.4≤CA_L5S2/CA_L7S2≤0.7.

$$1 < CA\_L8S2 / CA\_L1S1 < 5 \qquad [ Equation 20 ]$$

In Equation 20, when the effective diameter CA_L8S1 of the sixteenth surface S16 of the eighth lens 109 and the effective diameter CA_L1S1 of the first surface S1 of the first lens 101 are satisfied, the optical system 1000 can set the field of view and optical system size. Preferably, Equation 20 may satisfy: 2<CA_L8S2/CA_L1S1<3.5.

$$0.8 < CG 3 / EG 3 < 5 \qquad [ Equation 21 ]$$

In Equation 21, when the distance CG3 between the third and fourth lenses 103 and 104 and the edge distance EG3 between the third and fourth lenses 103 and 104 on the optical axis OA are satisfied, the optical system 1000 may reduce chromatic aberration, improve aberration characteristics, and control vignetting for optical performance. Preferably, Equation 21 may satisfy: 1<CG3/EG3<2.

$$1 < CG 6 / EG 6 < 5 \qquad [ Equation 22 ]$$

In Equation 22, when the center distance CG7 and edge distance EG7 between the seventh lens 107 and the eighth lens 108 are satisfied, the optical system provides good optical performance even in the center and periphery portions of the FOV. and can suppress the occurrence of distortion.

At least one of Equations 21 and 22 may further include at least one of Equations 22-1 to 22-6.

$$0 < CG 1 / EG 1 < 1 \qquad [ Equation 22 - 1 ]$$

$$5 < CG 2 / EG 2 < 10 \qquad [ Equation 22 - 2 ]$$

$$0 < CG 4 / EG 4 < 1.2 \qquad [ Equation 22 - 3 ]$$

$$1 < CG 5 / EG 5 < 10 \qquad [ Equation 22 - 4 ]$$

$$15 < ( CG 6 / EG 6 ) * n < 25 where n is the total number of lenses . \qquad [ Equation 22 - 5 ]$$

$$1 < CG 8 / EG 8 < 6 \qquad [ Equation 22 - 6 ]$$

$$0 < G7\_Max / CG 7 < 2 \qquad [ Equation 23 ]$$

In Equation 23, G7_Max means the maximum distance (mm) between the seventh and eighth lenses 107 and 108. When the optical system 1000 according to the first embodiment satisfies Equation 23, optical performance can be improved in the periphery portion of the FOV, and distortion of aberration characteristics can be suppressed. Preferably, Equation 23 may satisfy: 0.5<G7_Max/CG7<1.5.

$$0 < CT 6 / CG 6 < 2 \qquad [ Equation 24 ]$$

In Equation 24, the thickness CT6 of the sixth lens 106 in the optical axis OA and the distance CG6 between the sixth lens 106 and the seventh lens 107 in the optical axis OA are satisfied. In this case, the optical system 1000 can reduce the effective diameter size of the sixth and seventh lenses and the center distance between adjacent lenses, and improve optical performance in the periphery portion of the FOV. Preferably, Equation 24 may satisfy: 0<CT6/CG6<1.

$$1 < CT 6 / CG 5 < 3 \qquad [ Equation 25 ]$$

In Equation 25, when the thickness CT6 in the optical axis OA of the sixth lens 106 and the distance CG5 between the fifth and sixth lenses 105 and 106 are satisfied, the optical system 1000 may reduce the size of the effective diameters of the fifth and sixth lenses and the distance, and may improve optical performance of the periphery portion of the FOV. Preferably, Equation 25 may satisfy: 1<CT6/CG5<2.3.

$$0.1 < CT 7 / CG 5 < 1 \qquad [ Equation 26 ]$$

When Equation 26 satisfies the thickness CT7 in the optical axis OA of the seventh lens 107 and the distance CG5 between the fifth and sixth lenses 105 and 106, the optical system 1000 may reduce the effective diameter size of the seventh lens and the center distance between the fifth and sixth lenses, and may improve optical performance of the periphery portion of the FOV. Preferably, Equation 26 may satisfy: 0.3<CT7/CG5<0.8.

$$1 < \vert L 5 R 2 / CT 5 \vert < 50 \qquad [ Equation 27 ]$$

When Equation 27 satisfies the curvature radius L5R2 of the tenth surface S10 of the fifth lens 105 and the thickness CT5 in the optical axis of the fifth lens 105, the optical system 1000 may control the refractive power of the fifth lens 105 and improve optical performance of light incident on the second lens group LG2. Preferably, Equation 27 may satisfy: 100<|L5R2/CT5| <200. Preferably, the condition may satisfy: L5R2>0.

$$0 < L 5 R 1 / L 7 R 1 < 5 \qquad [ Equation 28 ]$$

If Equation 28 satisfies the curvature radius L5R1 of the ninth surface S9 of the fifth lens 105 and the curvature radius L7R1 of the thirteenth surface S13 of the seventh lens 107, it is possible to control the shape and refractive power of the fifth and seventh lenses, improve optical performance, and improve optical performance of the second lens group LG2. Preferably, Equation 28 may satisfy: 0<L5R1/L7R1<1.

$$0 < L 1 R 1 / L 1 R 2 < 1 \qquad [ Equation 29 ]$$

Equation 29 can set the curvature radii L1R1 and L1R2 of the object-side first surface S1 and second surface S2 of the first lens 101, and when these are satisfied, the lens size and resolution can be determined. Preferably, Equation 29 may satisfy: 0<L1R1/L1R2<0.5. Preferably, L1R1>0 and L1R2>0 may be satisfied.

$$0 < L 2 R 2 / L 2 R 1 < 1 \qquad [ Equation 30 ]$$

Equation 30 can set the curvature radii L2R1 and L2R2 of the object-side third surface S3 and fourth surface S4 of the second lens 102, and when these are satisfied, the resolution of the lens can be determined. Preferably, Equation 30 may satisfy: 0<L2R2/L2R1≤0.8. Preferably, L2R1>0 and L2R2>0 may be satisfied.

At least one of Equations 28, 29, and 30 may include at least one of Equations 30-1 to 30-6 below, and can determine the resolution of each lens.

$$2 < L 3 R 1 / L 3 R 2 < 6 \qquad [ Equation 30 - 1 ]$$

$$1 < L 4 R 1 / L 4 R 2 < 3 \qquad [ Equation 30 - 2 ]$$

$$0 < L 5 R 1 / L 5 R 2 < 1 \qquad [ Equation 30 - 3 ]$$

$$3 \leq L 6 R 1 / L 6 R 2 < 10 \qquad [ Equation 30 - 4 ]$$

$$0 < L 7 R 1 / L 7 R 2 < 1.5 \qquad [ Equation 30 - 5 ]$$

$$1 < L 8 R 2 / L 8 R 1 < 4 \qquad [ Equation 30 - 6 ]$$

Preferably, the conditions may satisfy: L3R1<0, L3R2<0, L6R1<0, and L6R2<0.

$$0 < CT\_Max / CG\_Max < 2 \qquad [ Equation 31 ]$$

In Equation 31, when the thickest thickness CT_Max in the optical axis OA of each of the lenses and the maximum value CG_Max of the air gaps or distances in the optical axis between the plurality of lenses is satisfied, the optical system 1000 has good optical performance at a set FOV and focal length, and the size of the optical system 1000 can be reduced, for example, the TTL can be reduced. Preferably, Equation 31 may satisfy: 0<CT_Max/CG_Max<1.

$$0.5 < \sum CT / \sum CG < 2 \qquad [ Equation 32 ]$$

In Equation 32, ECT means the sum of the thicknesses (mm) in the optical axis OA of each of the plurality of lenses, and ΣCG means the sum of the distances (mm) in the optical axis OA between two adjacent lenses in the plurality of lenses. When the optical system 1000 according to the first embodiment satisfies Equation 32, the optical system 1000 has good optical performance at the set FOV and focal length, and the size of the optical system 1000 can be reduced, for example, TTL can be reduced. Preferably, Equation 32 may satisfy: 1<ΣCT/ΣCG<1.8.

$$10 < \sum Index < 30 \qquad [ Equation 33 ]$$

In Equation 33, ¿Index means the sum of the refractive indices at the d-line of each of the plurality of lenses. When the optical system 1000 according to the first embodiment satisfies Equation 33, TTL of the optical system 1000 can be controlled and improved resolution can be achieved. Here, the average refractive index of the first to eighth lenses 101-108 may be 1.50 or more. Preferably, Equation 33 may satisfy: 10<ΣIndex<20.

$$10 < \sum Abb / \sum Index < 50 \qquad [ Equation 34 ]$$

In Equation 34, ΣAbbe means the sum of Abbe numbers of each of the plurality of lenses. When the optical system 1000 according to the first embodiment satisfies Equation 34, the optical system 1000 may have improved aberration characteristics and resolution. The average Abbe number of the first to eighth lenses 101-108 may be 45 or more. Preferably, Equation 34 may satisfy: 20<ΣAbb/ΣIndex<40.

$$0 < \vert Max\_distortion \vert < 5 \qquad [ Equation 35 ]$$

In Equation 35, Max_distortion means the maximum value of distortion in the region from the center (0.0 F) to the diagonal end (1.0 F) based on the optical characteristics detected by the image sensor 300. When the optical system 1000 according to the embodiment satisfies Equation 35, the optical system 1000 may improve distortion characteristics. Preferably, Equation 35 may satisfy: 1<|Max_distortion|<3.

$$0 < EG\_Max / CT\_Max < 2 \qquad [ Equation 36 ]$$

In Equation 36, CT_Max means the thickest thickness (mm) among the thicknesses in the optical axis OA of each of the plurality of lenses, and EG_Max is an edge-side maximum distance between two adjacent lenses. When the optical system 1000 according to the first embodiment satisfies Equation 36, the optical system 1000 has a set FOV and focal length, and can have good optical performance in the periphery portion of the FOV. Preferably, Equation 36 may satisfy: 0<EG_Max/CT_Max<1.

$$0.5 < CA\_L1S1 / CA\_Min < 2 \qquad [ Equation 37 ]$$

In Equation 37, when the effective diameter CA_L1S1 of the first surface S1 of the first lens 101 and the minimum effective diameter CA_Min among the effective diameters of the first to sixteenth surfaces S1-S16 are satisfied, light incident through the first lens 101 may be controlled and a slim optical system may be provided while maintaining optical performance. Preferably, Equation 37 may satisfy: 1<CA_L1S1/CA_Min<1.5.

$$1 < CA\_Max / CA\_Min < 5 \qquad [ Equation 38 ]$$

In Equation 38, CA_Max means the maximum effective diameter among the object-side surfaces and the sensor-side surfaces of the plurality of lenses, and means the maximum effective diameter among the effective diameters (mm) of the first to sixteenth surfaces S1-S16. When the optical system 1000 according to the first embodiment satisfies Equation 38, the optical system 1000 can provide a slim and compact optical system while maintaining optical performance. Preferably, Equation 38 may satisfy: 2<CA_Max/CA_Min<4.

$$1 < CA\_Max / CA\_Aver < 3 \qquad [ Equation 39 ]$$

In Equation 39, the maximum effective diameter CA_Max and the average effective diameter CA Aver are set among the object-side surfaces and the sensor-side surfaces of the plurality of lenses, and when these are satisfied, a slim and compact optical system can be provided. Preferably, Equation 39 may satisfy: 1.5<CA_Max/CA_AVR<2.5.

$$0.1 < CA\_Min / CA\_Aver < 1 \qquad [ Equation 40 ]$$

In Equation 40, the minimum effective diameter CA_Min and average effective diameter CA Aver can be set among the object-side surfaces and the sensor-side surfaces of the plurality of lenses, and when these are satisfied, a slim and compact optical system can be provided. Preferably, Equation 40 may satisfy: 0.1<CA_Min/CA_AVR≤0.8.

$$0.1 < CA\_Max / ( 2 \times ImgH ) < 1 \qquad [ Equation 41 ]$$

In Equation 41, the maximum effective diameter CA_Max among the object-side surfaces and the sensor-side surfaces of the plurality of lenses and the distance ImgH from the center (0.0 F) of the image sensor 300 to the diagonal end (1.0 F) may be set, when this is satisfied, the optical system 1000 has good optical performance in the center and periphery portions of the FOV and can provide a slim and compact optical system. Here, ImgH may range from 4 mm to 15 mm. Preferably, Equation 41 may satisfy: 0.5≤CA_Max/(2*ImgH)<1.

$$0.1 < TD / CA\_Max < 1.5 \qquad [ Equation 42 ]$$

In Equation 42, TD is the maximum optical axis distance (mm) from the object side of the first lens group LG1 to the sensor side of the second lens group LG2. For example, it is the distance from the first surface S1 of the first lens 101 to the sixteenth surface S16 of the eighth lens 108 in the optical axis OA. When the optical system 1000 according to the first embodiment satisfies Equation 42, a slim and compact optical system can be provided. Preferably, Equation 42 may satisfy: 0.5<TD/CA_Max<1.

$$0 < F / L 7 R 2 < 5 \qquad [ Equation 43 ]$$

In Equation 43, the total effective focal length F of the optical system 1000 and the curvature radius L7R2 of the fourteenth surface S14 of the seventh lens 107 can be set, when these are satisfied, the optical system 1000 can reduce the size of the optical system 1000, for example, reduce the TTL. Preferably, Equation 43 may satisfy: 1<F/L7R2<3. Equation 43 may further include Equation 43-1 below.

$$2 < F / F \# < 8 \qquad [ Equation 43 - 1 ]$$

F # may mean the F number. Preferably, Equation 43-1 may satisfy: 5<F/F #<7.5.

$$1 < F / L 8 R 2 < 5 \qquad [ Equation 43 - 2 ]$$

Equation 43-2 can set the total effective focal length F of the optical system 1000 and the curvature radius L8R2 of the sixteenth surface S16 of the eighth lens 108. Preferably, Equation 43-2 may satisfy: 2<F/L8R2<4.

$$1 < F / L 1 R 1 < 10 \qquad [ Equation 44 ]$$

In Equation 44, the curvature radius L1R1 of the first surface S1 of the first lens 101 and the total effective focal length F can be set, and when these are satisfied, the optical system 1000 1000 can be reduced in size, for example, reducing TTL. Preferably, Equation 44 may satisfy: 1<F/L1R1<5.

$$0 < EPD / L 8 R 2 < 5 \qquad [ Equation 45 ]$$

In Equation 45, EPD means the size (mm) of the entrance pupil diameter of the optical system 1000, and L8R2 means the curvature radius (mm) of the sixteenth surface S16 of the eighth lens 108. When the optical system 1000 according to the first embodiment satisfies Equation 45, the optical system 1000 can control the overall brightness and have good optical performance in the center and periphery portions of the FOV. Preferably, Equation 45 may satisfy: 0<EPD/L8R2<1.

Equation 45 may further include Equation 45-1 below.

$$1 < EPD / F \# < 3 \qquad [ Equation 45 - 1 ]$$

$$0.5 < EPD / L 1 R 1 < 8 \qquad [ Equation 46 ]$$

Equation 46 represents the relationship between the size of the entrance pupil diameter of the optical system and the curvature radius of the first surface S1 of the first lens 101, and can control incident light. Preferably, Equation 46 may satisfy: 1<EPD/L1R1<2.

$$- 5 < \vert F 1 / F 2 \vert < 0 \qquad [ Equation 47 ]$$

In Equation 47, the focal lengths F1 and F2 of the first and second lenses 101 and 102 can be set. Accordingly, resolution can be improved by adjusting the refractive power of the incident light of the first and second lenses 101 and 102, and TTL can be controlled. Preferably, Equation 47 may satisfy: −1<F1/F2<0, and the conditions may satisfy: F1>0 and F2<0.

$$1 < F 12 / F < 5 \qquad [ Equation 48 ]$$

By setting the composite focal length F12 of the first and second lenses and the total focal length F in Equation 48, the optical system 1000 can improve resolution by adjusting the refractive power of the incident light, and the optical system 1000 can control the TTL. Preferably, Equation 48 may satisfy: 1<F12/F<3.

$$1 < \vert F 48 / F 13 \vert < 4 \qquad [ Equation 49 ]$$

In Equation 49, the composite focal length of the first-third lens F13, that is, the focal length (mm) of the first lens group, and the composite focal length F48 of the fourth-eighth lens, that is, the focal length of the second lens group may be set, and when this is satisfied, the refractive power of the first lens group and the refractive power of the second lens group can be controlled to improve resolution, and the optical system can be provided in a slim and compact size. Additionally, when Equation 49 is satisfied, the optical system 1000 can improve aberration characteristics such as chromatic aberration and distortion aberration. Equation 49 may preferably satisfy: 1<|F38/F12|<2. Here, the conditions may satisfy: F12>0, F38>0, and F38>F12.

$$0 < F 1 / F < 3 \qquad [ Equation 50 ]$$

In Equation 50, the total focal length F and the refractive power of the first lens 101 can be set, and resolution can be improved. Equation 50 may satisfy: 0<F1/F<2.

$$0 < \vert F 2 / F \vert < 5 ( where F > 0 , F 2 < 0 ) \qquad [ Equation 50 - 1 ]$$

$$1 < \vert F 3 / F 2 \vert < 5 ( where F 3 > 0 ) \qquad [ Equation 50 - 2 ]$$

$$0 < \vert F 4 / F \vert < 0.5 ( where F 4 < 0 ) \qquad [ Equation 50 - 3 ]$$

$$0 < \vert F 5 / F \vert < 1 ( where F 5 > 0 ) \qquad [ Equation 50 - 4 ]$$

$$0 < \vert F 6 / F \vert < 1 ( where F 6 > 0 ) \qquad [ Equation 50 - 5 ]$$

$$0 < \vert F 7 / F \vert < 0.5 ( where F 7 < 0 ) \qquad [ Equation 50 - 6 ]$$

$$0 < \vert F 8 / F \vert < 5 ( where F 8 < 0 ) \qquad [ Equation 50 - 7 ]$$

In equations 50-1 to 50-7, F3, F4, F5, F6, F7, and F8 mean the focal length (mm) of the third, fourth, fifth, sixth, seventh, and eighth lenses 103, 104, 105, 106, 107, and 108, and when this is satisfied, resolution can be improved by controlling the refractive power of each lens, and the optical system can be provided in a slim and compact size.

$$0 < F 1 / F 12 < 2 \qquad [ Equation 51 ]$$

In Equation 51, the resolution of the first lens group can be adjusted by setting the focal length F1 of the first lens and the composite focal length F12 of the first and second lenses. Preferably, Equation 51 may satisfy: 0<F1/F12<1.5.

$$0 < F 1 / \vert F 38 \vert < 2 \qquad [ Equation 52 ]$$

By setting the focal length F1 of the first lens and the composite focal length F38 of the third to eighth lenses in Equation 52, the size and resolution of the optical system can be adjusted. Preferably, Equation 52 may satisfy: 0<F1/|F38|<1. Here, when the aperture stop is disposed on the sensor-side peripheral surface of the second lens, the composite focal length of the first to third lenses based on the position of the aperture stop is F13, and the composite focal length of the fourth to eighth lenses is F48, F12>F13 can be satisfied, and F38>F48 can be satisfied. Also, the following conditions may satisfy: F48<0 and |F48|> (F38*3).

$$0 < \vert F 1 / F 4 \vert < 1 \qquad [ Equation 53 ]$$

By setting the focal length F1 of the first lens and the focal length F4 of the fourth lens in Equation 53, the refractive power of light incident on the first and second lens groups can be controlled, and the size and resolution of the optical system can be adjusted. Preferably, Equation 53 may satisfy: 0<|F1/F4|<0.5.

$$2 mm < TTL < 20 mm \qquad [ Equation 54 ]$$

In Equation 54, TTL means the distance (mm) from a vertex of the first surface S1 of the first lens 101 to the image surface of the image sensor 300 in the optical axis OA. Preferably, Equation 54 may satisfy: 10<TTL<20, and thus a slim and compact optical system can be provided.

$$2 mm < ImgH \qquad [ Equation 55 ]$$

Equation 55 sets the diagonal size (2*ImgH) of the image sensor 300 to exceed 4 mm, thereby providing an optical system with high resolution. Equation 55 may preferably satisfy: 4≤ImgH≤15 or 8<ImgH≤15. Equation 55 may include at least one of the following Equations 55-1 to 55-4.

$$1.5 < ImgH / \sum CT / < 2.2 \qquad [ Equation 55 - 1 ]$$

$$1.6 < ImgH / \sum CG / < 2.3 \qquad [ Equation 55 - 2 ]$$

$$0.8 < ImgH / \sum Index / < 1.5 \qquad [ Equation 55 - 3 ]$$

$$0 < ImgH / \sum Abbe / < 0.1 \qquad [ Equation 55 - 4 ]$$

Equations 55-1 to 55-4 can establish the relationship between ImgH and the sum of the center thicknesses of all lenses, the sum of center distances between lenses, the sum of refractive indices of all lenses, and the sum of Abbe numbers of all lenses. Accordingly, the resolution and size of the optical system with an ImgH of 4 mm or 8 mm or more can be adjusted.

BFL<2.5 mm [Equation 56]

Equation 56 sets the BFL (Back focal length) to less than 2.5 mm, so that the installation space for the filter 500 can be secured, and may improve assemblability of components and improve coupling reliability through a distance between the image sensor 300 and the last lens. Equation 56 may preferably satisfy: 0.8<BFL<2.5.

$$2 < F < 20 \qquad [ Equation 57 ]$$

In Equation 57, the total focal length F can be set to suit the optical system, and preferably, may satisfy: 5<F<15.

$$FOV < 120 degrees \qquad [ Equation 58 ]$$

In Equation 58, FOV (Field of view) means the angle (Degree) of view of the optical system 1000, and can provide an optical system of less than 120 degrees. FOV may be 70 degrees or more, for example, in the range of 70 degrees to 100 degrees.

$$0.5 < TTL / CA\_Max < 2 \qquad [ Equation 59 ]$$

By setting the maximum effective diameter CA_Max among the object-side and sensor-side surfaces of the plurality of lenses and TTL in Equation 59, a slim and compact optical system can be provided. Preferably, Equation 59 may satisfy: 0.5<TTL/CA_Max<1.

$$0.5 < TTL / ImgH < 3 \qquad [ Equation 60 ]$$

Equation 60 can set the total optical axis length TTL of the optical system and the diagonal length (ImgH) from the optical axis of the image sensor 300. When the optical system 1000 according to the first embodiment satisfies Equation 60, the optical system 1000 may secure a relatively large image sensor 300, for example, BFL for application of the large image sensor 300 of around 1 inch or so, and may have a smaller TTL, thereby implementing high-definition image quality and a slim structure. Preferably, Equation 60 may satisfy: 0.8<TTL/ImgH<2. Preferably, the conditions may satisfy: ImgH<TTL and 150<TTL*ImgH.

$$0.01 < BFL / ImgH < 0.5 \qquad [ Equation 61 ]$$

Equation 61 can set the optical axis distance between the image sensor 300 and the last lens and the diagonal length from the optical axis of the image sensor 300. When the optical system 1000 according to the first embodiment satisfies Equation 61, the optical system 1000 may secure a relatively large image sensor 300, for example, BFL for application of the large image sensor 300 of around 1 inch in size, and the distance between the last lens and the image sensor 300 may be minimized, so that good optical properties may be obtained on the center and periphery portions of FOV. Preferably, Equation 61 may satisfy: 0.1≤BFL/ImgH≤0.3.

$$4 < TTL / BFL < 10 \qquad [ Equation 62 ]$$

Equation 62 can set (unit, mm) the total optical axis length TTL of the optical system and the optical axis distance BFL between the image sensor 300 and the last lens. When the optical system 1000 according to the first embodiment satisfies Equation 62, the optical system 1000 secures BFL and can be provided in a slim and compact manner. Equation 62 may satisfy: 6<TTL/BFL<10.

$$0.5 < F / TTL < 1.5 \qquad [ Equation 63 ]$$

Equation 63 can set the total focal length F and total optical axis length TTL of the optical system 1000. Accordingly, a slim and compact optical system can be provided. Equation 63 may preferably satisfy: 0.5<F/TTL<1.2.

$$0 < F \# / TTL < 0.5 \qquad [ Equation 63 - 1 ]$$

Equation 63-1 can set the F number F # and total optical axis length TTL of the optical system 1000. Accordingly, a slim and compact optical system can be provided.

$$3 < F / BFL < 10 \qquad [ Equation 64 ]$$

Equation 64 can set (unit, mm) the total focal length F of the optical system 1000 and the optical axis distance BFL between the image sensor 300 and the last lens. When the optical system 1000 according to the first embodiment satisfies Equation 64, the optical system 1000 can have a set FOV and an appropriate focal length, and a slim and compact optical system can be provided. Additionally, the optical system 1000 can minimize the distance between the last lens and the image sensor 300 and thus have good optical characteristics at the periphery portion of the FOV. Preferably, Equation 64 may satisfy: 5<F/BFL<10.

$$0.1 < F / ImgH < 3 \qquad [ Equation 65 ]$$

Equation 65 can set the total focal length F (mm) of the optical system 1000 and the diagonal length ImgH from the optical axis of the image sensor 300. This optical system 1000 uses a relatively large image sensor 300, for example, around 1 inch, and may have improved aberration characteristics. Preferably, Equation 65 may satisfy: 0.8≤F/ImgH<2.

$$1 < F / EPD < 5 \qquad [ Equation 66 ]$$

Equation 66 can set the total focal length F (mm) and entrance pupil diameter of the optical system 1000. Accordingly, the overall brightness of the optical system can be controlled. Preferably, Equation 66 may satisfy: 1.5≤F/EPD<4.

$$0 < BFL / TD < 0.3 \qquad [ Equation 67 ]$$

In Equation 67, the optical axis distance BFL between the image sensor 300 and the last lens and the optical axis distance TD of the lenses are set, when this is satisfied, the optical system 1000 can provide a slim and compact optical system. Preferably, Equation 67 may satisfy: 0<BFL/TD≤0.2. When BFL/TD exceeds 0.3, BFL is designed to be large compared to TD, so the size of the entire optical system becomes large, making miniaturization of the optical system difficult, and the distance between the eighth lens and the image sensor becomes long, so the amount of unnecessary light can be increased through the eighth lens and the image sensor, resulting in a decrease in resolution, such as deteriorating aberration characteristics.

$$0 < EPD / ImgH / FOV < 0.2 \qquad [ Equation 68 ]$$

In Equation 68, the relationship between the entrance pupil diameter EPD, the length (ImgH) of half the maximum diagonal length of the image sensor, and the field of view (FOV) can be established. Accordingly, the overall size and brightness of the optical system can be controlled. Equation 68 may preferably satisfy: 0<EPD/ImgH/FOV<0.1.

$$10 < FOV / F \# < 55 \qquad [ Equation 69 ]$$

Equation 69 can establish the relationship between the field of view of the optical system and the F number. Equation 69 may preferably satisfy: 30<FOV/F #<50.

$$0 < n 1 / n 2 < 1.5 \qquad [ Equation 70 ]$$

When the refractive indices n1 and n2 at the d-line of the first and second lenses 101 and 102 of Equation 70 satisfy the above range, the optical system can improve the resolution of incident light. Preferably, 0<n1/n2<1 may be satisfied.

$$0 < n 3 / n 4 < 1.5 \qquad [ Equation 71 ]$$

If the refractive indices n3 and n4 at the d-line of the third and fourth lenses 103 and 104 of Equation 71 satisfy the above range, the optical system can improve the resolution of the incident light of the second lens group LG2. Preferably, Equation 71 may satisfy: 0<n3/n4<1.

$$0 < Inf 71 / Inf 72 < 1 \qquad [ Equation 72 ]$$

In Equation 72, the distance Inf71 from the optical axis OA to the critical point of the object-side surface S13 of the seventh lens 107 and the distance Inf72 from the optical axis OA to the critical point of the sensor-side surface S14 can be set, when this is satisfied, the satisfactory aberration of the seventh lens can be controlled. Equation 72 may satisfy: 0.5<Inf71/Inf72<1.

$$0 < Inf 81 / Inf 82 < 1 \qquad [ Equation 73 ]$$

In Equation 73, the distance Inf81 from the optical axis OA to the critical point of the object-side surface S15 of the eighth lens 108 and the distance Inf82 from the optical axis OA to the critical point of the sensor-side surface S16 of the eighth lens 108 can be set, and when this is satisfied, the satisfactory aberration of the eighth lens can be controlled. Equation 73 may satisfy: 0.1<Inf61/Inf72<0.5.

$$1 < Inf 72 / Inf 81 < 5 \qquad [ Equation 74 ]$$

In Equation 74, the distance Inf72 from the optical axis OA to the critical point of the sensor-side surface S14 of the seventh lens 107 and the distance Inf 81 from the optical axis OA to the critical point of the object-side surface S15 of the eighth lens 108 can be set, and when this is satisfied, the satisfactory aberration of the seventh and eighth lenses can be controlled. Equation 74 may satisfy: 2<Inf72/Inf81<4.

$$0.3 < Inf 71 / r 71 < 0.7 \qquad [ Equation 75 ]$$

In Equation 75, the distance Inf71 from the optical axis OA to the critical point of the object-side surface S13 of the seventh lens 107 and the effective radius r71 of the object-side surface of the seventh lens 107 can be set, and when this is satisfied, the satisfactory aberration of the object-side surface of the seventh lens can be controlled. Equation 75 may satisfy: 0.2<Inf71/r71<0.6.

$$0.3 < Inf 72 / r 72 < 0.75 \qquad [ Equation 76 ]$$

In Equation 76, the distance Inf72 from the optical axis OA to the critical point of the sensor-side surface S14 of the seventh lens 107 and the effective radius r72 of the sensor-side surface of the seventh lens 107 can be set, and when this is satisfied, the satisfactory aberration of the sensor-side surface of the seventh lens can be controlled. Equation 76 may satisfy: 0.4<Inf72/r72<0.65.

$$0 < Inf 82 / r 82 < 0.5 \qquad [ Equation 77 ]$$

In Equation 77, the distance Inf82 from the optical axis OA to the critical point of the sensor-side surface S16 of the eighth lens 108 and the effective radius r82 of the sensor-side surface S16 of the eighth lens 108 can be set, and when this is satisfied, the satisfactory aberration of the object-side surface of the eighth lens can be controlled. Equation 77 may satisfy: 0.2<Inf82/r82<0.5.

$$1 < ( Inf 72 / r 72 ) / ( Inf 82 / r 82 ) < 2 \qquad [ Equation 78 ]$$

In Equation 78, the ratio of the distance Inf72 to the critical point of the sensor-side surface S14 and the effective radius r72 of the sensor-side surface S14 of the seventh lens 107, and the distance Inf82 to the critical point of the sensor-side surface S16 and the effective radius r82 of the sensor-side surface S16 of the eighth lens 108 can be set, and when this is satisfied, the satisfactory aberration of the sensor-side surface of the seventh and eighth lenses can be controlled. Equation 78 may satisfy: 1< (Inf72/r72)/(Inf82/r82)<1.55.

$$5 < ( TTL / ImgH ) * n < 15 \qquad [ Equation 79 ]$$

Preferably, Equation 79 may satisfy: 8< (TTL/ImgH)*n<12.

$$4 < ( F / ImgH ) * n < 14 \qquad [ Equation 80 ]$$

Preferably, Equation 80 may satisfy: 6< (F/ImgH)*n<11.

$$25 < ( TD\_LG 2 / TD\_LG 1 ) * n < 55 \qquad [ Equation 81 ]$$

$$20 < ( CT\_Max + CG\_Max ) * n < 30 \qquad [ Equation 82 ]$$

$$100 < ( FOV * TTL ) / n < 200 \qquad [ Equation 83 ]$$

$$( TTL * n ) > FOV \qquad [ Equation 84 ]$$

$$( v 2 * n 2 ) < ( v 1 * n 1 ) \qquad [ Equation 85 ]$$

In equations 79 to 85, n is the total number of lenses, and according to the total number of lenses, the optical axis distance TD_LG1 of the first lens group LG1, the optical axis distance TD_LG2 of the second lens group LG2, the maximum center thickness CT_Max, the maximum center distance CG_Max, FOV, TTL, and the like may be set. Accordingly, it is possible to control the chromatic aberration, resolution, size, etc. of an optical system with 9 or less lenses.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + ⋯ \qquad [ Equation 86 ]$$

In Equation 86, Z is Sag and can mean the distance in the optical axis direction from any position on the aspherical surface to the vertex of the aspherical surface. The Y may refer to the distance from any location on the aspherical surface to the optical axis in a direction perpendicular to the optical axis. The c may refer to the curvature of the lens, and K may refer to the Conic constant. Additionally, A, B, C, D, E, and F may mean aspheric constants.

The optical system 1000 according to the first embodiment may satisfy at least one or two of Equations 1 to 85. In this case, the optical system 1000 has improved optical characteristics and improved resolution, and can improve aberration and distortion characteristics. In addition, the optical system 1000 may secure a BFL for applying the large-sized image sensor 300 and minimize the distance between the last lens and the image sensor 300, thereby having good optical performance on the center and periphery portions of FOV. In addition, when the optical system 1000 satisfies at least one of Equations 1 to 85, the optical system 1000 includes the image sensor 300 having a relatively large size and may have a relatively small TTL value, and may provide a slimmer compact optical system and a camera module having the same. In the optical system 1000 according to the first embodiment, the distance between the plurality of lenses 100 may have a value set according to the region.

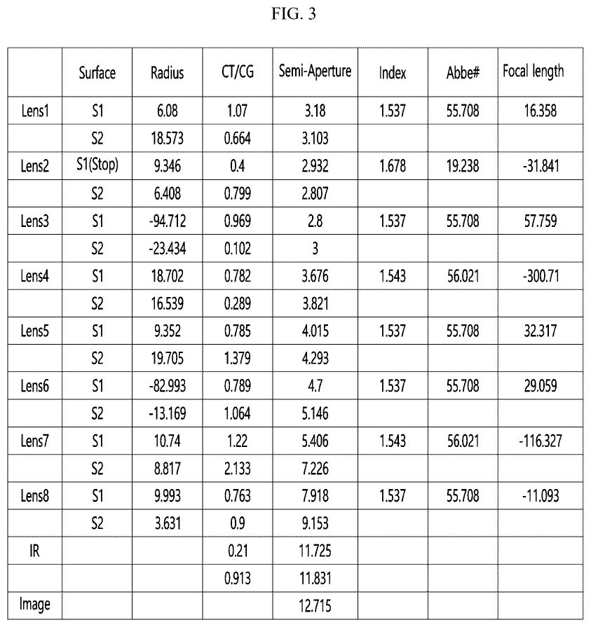

FIG. 3 is an example of lens data according to the first embodiment having the optical system of FIG. 1.

As shown in FIG. 3, the optical system according to the embodiment represents the curvature radius on the optical axis OA of the first to eighth lenses 101-108, the center thickness CT of the lens, and the center distance CG between the lenses, refractive index at d-line (588 nm), Abbe Number and effective radius (Semi-Aperture), and focal length. The sum of the refractive indices of the plurality of lenses 100 is greater than 10, the sum of the Abbe numbers is 300 or more, and the sum of the center thicknesses of all lenses is 5 mm or more, for example, in the range of 5 mm to 8 mm. The sum of the center distance between the first to eighth lenses in the optical axis may be 5 mm or more, for example, in the range of 5 mm to 8 mm, and may be smaller than the sum of the center thicknesses of the lenses. Additionally, the average value of the effective diameter of each lens surface of the plurality of lenses 100 is 8 mm or more, for example, in the range of 8 mm to 10 mm. The average of the center thicknesses of each lens may be 1 mm or less, for example, in the range of 0.5 mm to 1 mm. The sum of the effective diameters of each lens surface of the plurality of lenses 100 is a sum of the effective diameters of the first surface S1 to the sixteenth surface S16, and may be 120 mm or more, for example, in the range of 120 mm to 180 mm. In the absolute value of the focal length, the focal length of the fourth lens 104 is the maximum, and any one of the focal lengths of the first and eighth lenses 101 and 108 is the minimum. For example, the focal length of the eighth lens 108 may be the minimum.

As shown in FIG. 4, the lens surface of at least one or all of the plurality of lenses in the first and second embodiments may include an aspheric surface with a 30th order aspherical coefficient. For example, the first to eighth lenses 101, 102, 103, 104, 105, 106, 107, and 108 may include lens surfaces having a 30th order aspheric coefficient from the first surface S1 to the sixteenth surface S16. As described above, an aspheric surface with a 30th order aspheric coefficient (a value other than “0”) can particularly significantly change the aspheric shape of the periphery portion, so the optical performance of the periphery portion of the FOV can be well corrected.

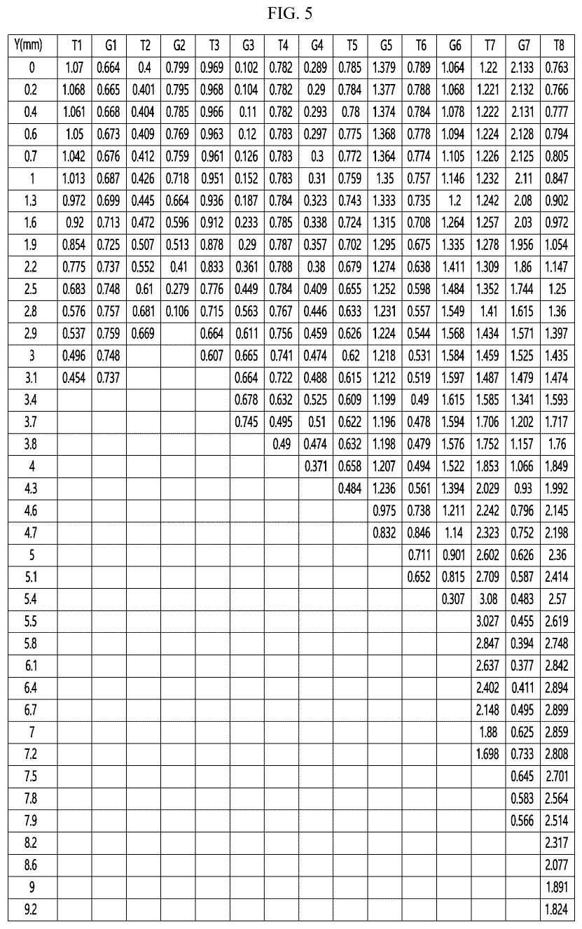

As shown in FIG. 5, the first to eighth thicknesses T1-T8 of the first to eighth lenses 101-108 can be expressed at distances of 0.1 mm or more in the direction Y from the center of each lens toward the edge, the distances between adjacent lenses may be represented by an distance of 0.1 mm or more in the direction from the center to the edge with respect to the first distance G1 between the first and second lenses, the second distance G2 between the second and third lenses, the third distance G3 between the third and fourth lenses, the fourth distance G4 between the fourth and fifth lenses, the fifth distance G5 between the fifth and sixth lenses, the fifth distance G6 between the sixth and seventh lenses, and the seventh distance G7 between the seventh and eighth lenses. In the first thickness T1, the maximum thickness may be more than twice the minimum thickness, for example, in the range of 2 to 4 times. The maximum distance of the first distance G1 may be 1 or more times the difference between the minimum distance, for example, in the range of 1 to 1.5 times. The maximum thickness of the second thickness T2 may be 1.1 times or more, for example, 1.1 to 2.1 times the minimum thickness. The maximum distance of the second distance G2 may be 5 times or more, for example, 5 to 10 times the minimum distance. In the third thickness T3, the maximum thickness may be 1.1 times or more, for example, 1.1 to 2.1 times the minimum thickness. The maximum distance of the third distance G3 may be 5 times or more, for example, 5 to 10 times the difference between the minimum distance. The maximum thickness of the fourth thickness T4 may be 1.1 times the minimum thickness, for example, in the range of 1.1 to 2.2 times. The maximum distance of the fourth distance G4 may be 1.2 times or more, for example, 1.2 to 2.5 times the minimum distance. In the fifth thickness T5, the maximum thickness may be 1.1 times or more, for example, 1 to 3 times the minimum thickness. The maximum distance of the fifth distance G5 may be 1.1 times or more than the minimum distance, for example, in the range of 1.1 to 2.5 times. The maximum thickness of the sixth thickness T6 may be 1.1 times or more, for example, 1.1 to 3.1 times the minimum thickness. The maximum distance of the sixth distance G6 may be at least twice the minimum distance, for example, in the range of 2 to 10 times. In the seventh thickness T7, the maximum thickness may be 1.5 times or more, for example, 1.5 to 4 times the minimum thickness. The maximum distance of the seventh distance G7 may be more than twice the minimum distance, for example, in the range of 2 to 10 times. The maximum thickness of the eighth thickness T8 may be two times or more, for example, 2 to 5 times the minimum thickness. The optical system can be provided in a slim and compact size by using the above-described first to eighth thicknesses T1-T8 and first to seventh distances G1-G7.

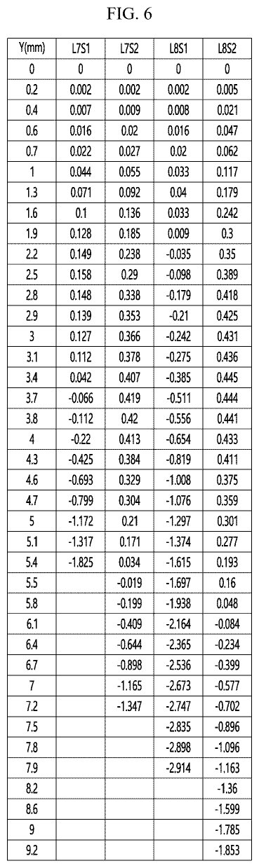

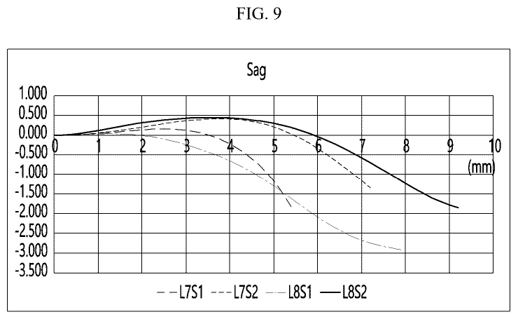

FIG. 6 illustrates a height (Sag value) from a straight line in the Y-axis direction orthogonal to the center of the object-side surface L7S1 and the sensor-side surface L7S2 of the seventh lens 107, and the object-side surface L8S1 and the sensor-side surface L8S2 of the eighth lens 108 in the optical system of FIG. 1, to a lens surface at distances of 0.1 mm or more, and FIG. 9 illustrates a graph of FIG. 5. As shown in FIGS. 6 and 9, it can be seen that the critical points of the object-side surface L7S1 and the sensor-side surface L7S2 of the seventh lens 107 occur at 4.5 mm or less from the optical axis, and that the critical point P1 (See FIG. 2) of the object-side surface appears closer to the optical axis than the critical point P2 of the sensor-side surface, and that the Sag value of L7S2 in the sensor-side direction appears larger than the Sag value of L7S1. In addition, the Sag value of L8S2, which is the sensor-side surface of the eighth lens 108 in the sensor-side direction, may be greater than the Sag value of L8S1 on the object side, and as shown in FIGS. 2 and 9, the critical point P2 on the object-side surface of the eighth lens 108 is placed closer to the optical axis than the other critical points P1, P2, and P4.

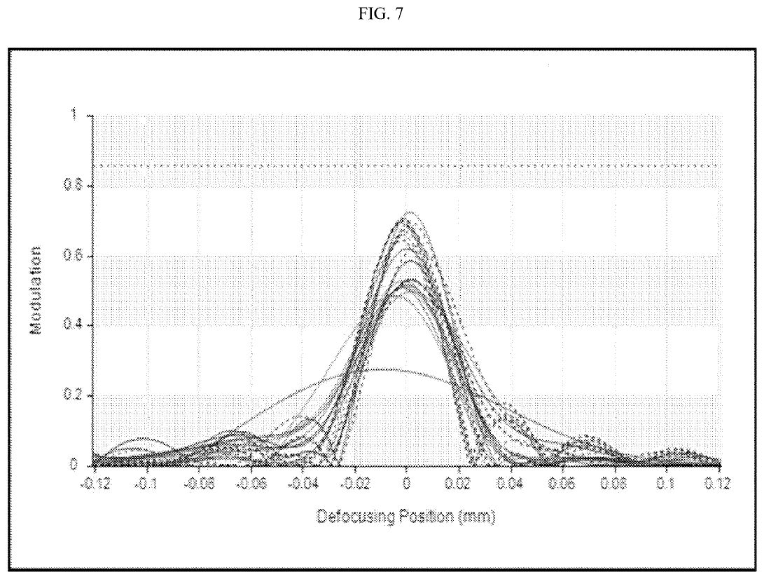

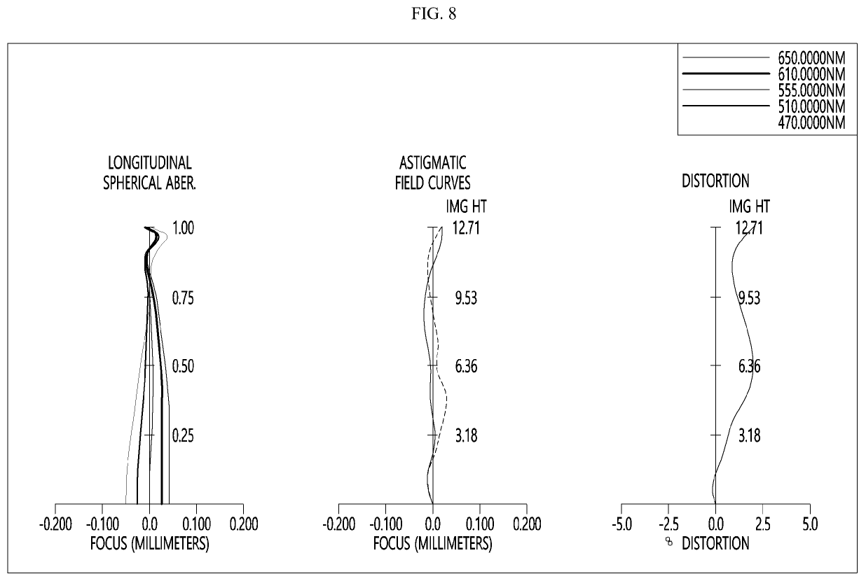

FIG. 7 is a graph showing the diffraction MTF characteristics of an optical system according to an embodiment of the invention, and FIG. 8 is a graph showing aberration characteristics of an optical system according to an embodiment of the invention. As shown in FIGS. 7 and 8, the aberration graph of the optical system according to the embodiment is a graph measuring spherical aberration, astigmatic field curves, and distortion from left to right. X-axis may represent focal length (mm) and distortion (%), and Y-axis may represent the height of the image. Additionally, the graph for spherical aberration is a graph for light in the approximately 470 nm, approximately 510 nm, approximately 555 nm, approximately 610 nm, and approximately 660 nm wavelength bands, and the graph for astigmatism and distortion aberration is a graph for light in the approximately 555 nm wavelength band. In the aberration diagram of FIG. 8, it may be interpreted that the closer each curve is to the Y-axis, the better the aberration correction function. Referring to FIG. 8, it may be seen that measurement values of the optical system 1000 according to an embodiment are adjacent to the Y-axis in most regions. That is, the optical system 1000 according to an embodiment may have improved resolution and may have good optical performance not only at the center but also at the periphery portions of the FOV. As confirmed in the first embodiment, the lens system of the first embodiment according to the invention is compact and lightweight with a lens configuration of 9 or less elements, for example, 8 elements, and at the same time has good spherical aberration, astigmatism, distortion aberration, chromatic aberration, and coma aberration. Since it is calibrated and can be implemented at high resolution, it can be used as a built-in camera optical device.

Table 1 shows the items of the above-described equations in the optical system 1000 according to the embodiment, and in detail, shows TTL, BFL, F value, ImgH, F1, F2, F3, F4, F5, F6, F7, and F8, edge thickness, edge distance, composite focal length, etc of the optical system 1000.

TABLE 1

| Items | First embodiment | Items | First embodiment |
|---|---|---|---|
| F | 12.610 | ET1 | 0.664 |
| F1 | 16.358 | ET2 | 0.799 |
| F2 | -31.841 | ET3 | 0.102 |
| F3 | 57.759 | ET4 | 0.289 |
| F4 | -300.710 | ET5 | 1.379 |
| F5 | 32.317 | ET6 | 1.064 |
| F6 | 29.059 | ET7 | 2.133 |
| F7 | -116.327 | ET8 | 0.664 |
| F8 | -11.093 | EG1 | 0.741 |
| F12 | 8.544 | EG2 | 0.104 |
| F3 | 29.010 | EG3 | 0.737 |
| F12 | 36.384 | EG4 | 0.361 |
| F38 | -401.010 | EG5 | 0.845 |
| Inf71 | 2.531 | EG6 | 0.325 |
| Inf72 | 3.755 | EG7 | 0.588 |
| Inf81 | 1.288 | ΣIndex | 12.447 |
| Inf82 | 3.511 | ΣAbbe | 409.821 |
| FOV | 89.322 | ΣCT | 0.847 |
| EPD | 6.360 | ΣCG | 6.429 |
| BFL | 2.023 | CT_Max | 1.220 |
| TD | 14.107 | CA_Max | 18.306 |
| ImgH | 12.715 | CA_Min | 5.600 |
| SD | 12.374 | CA_Aver | 9.147 |
| F# | 1.983 | TD_LG1 | 0.194 |
| TTL | 15.230 | TD_LG2 | 1.016 |

Table 2 shows the result values for Equations 1 to 40 described above in the optical system 1000 of FIG. 1. Referring to Table 2, it can be seen that the optical system 1000 satisfies at least one, two, or three of Equations 1 to 40. Accordingly, the optical system 1000 can improve optical performance and optical characteristics in the center and periphery portions of the FOV.

TABLE 2

| Equations | | First embodiment |
|---|---|---|
| 1 | 1 < CT1 / CT2 < 4 | 2.675 |
| 2 | 1 < CT3 / ET3 < 3 | 1.942 |
| 3 | 1 < ET8 / CT8 < 4 | 2.413 |
| 4 | 1.60 < n2 | 1.678 |
| 5 | 0.5 < L8S2_Max_Sag to Sensor < 1.5 | 1.577 |
| 6 | 1 < BFL / L8S2_Max_Sag to Sensor < 2 | 1.282 |
| 7 | 5 < \|L8S2_Max slope\| < 65 | 33.789 |
| 8 | 1 < Inf81 < 1.5 | 1.288 |
| 9 | 1 < CG7 / G7 Min < 15 | 5.655 |
| 10 | 1 < CG7 / EG7 < 5 | 3.630 |
| 11 | 0.01 < CG1 / CG6 < 1 | 0.624 |
| 12 | 0 < CT1 / CT7 < 2 | 0.877 |
| 13 | 0 < CT6 / CT7 < 3 | 0.647 |
| 14 | 0 < \|L7R2 / L8R1\| < 2 | 0.882 |
| 15 | 0 < (CG6 - EG6) / (CG6) < 2 | 0.694 |
| 16 | 1 < CA_LIS1 / CA_L2S2 < 2 | 1.133 |
| 17 | 1 < CA_L7S2 / CA_L3S1 < 5 | 2.581 |
| 18 | 0.5 < CA_L2S2 / CA_L3S1 < 1.5 | 1.002 |
| 19 | 0.1 < CA_L5S2 / CA_L7S2 < 1 | 0.594 |
| 20 | 1 < CA_L8S2 / CA_L1S1 < 5 | 2.878 |
| 21 | 0.8 < CG3 / EG3 < 5 | 1.315 |
| 22 | 1 < CG6 / EG6 < 5 | 2.427 |
| 23 | 0 < G7_Max / CG7 < 2 | 1.000 |
| 24 | 0 < CT6 / CG6 < 2 | 0.742 |
| 25 | 1 < CT6 / CG5 < 3 | 1.746 |
| 26 | 0.1 < CT7 / CG5 < 1 | 0.573 |
| 27 | 10 < \|L5R2 / CT5\| < 50 | 25.105 |
| 28 | 0 < L5R1 / L7R1 < 5 | 0.871 |
| 29 | 0 < LIR1 / L1R2 < 1 | 0.327 |
| 30 | 0 < L2R2 / L2R1 < 1 | 0.686 |
| 31 | 0 < CT Max / CG Max < 2 | 0.572 |
| 32 | 0.5 < ΣCT / ΣCG < 2 | 0.132 |
| 33 | 10 < ΣIndex < 30 | 12.447 |
| 34 | 10 < ΣAbb / ΣIndex < 50 | 32.925 |
| 35 | 0 < \|Max_distoriton\| < 5 | 2.000 |
| 36 | 0 < EG_Max / CT_Max < 2 | 0.693 |
| 37 | 0.5 < CA_LIS1 / CA_Min < 2 | 1.136 |
| 38 | 1 < CA_Max / CA_Min < 5 | 3.269 |
| 39 | 1 < CA_Max / CA_AVR < 3 | 2.001 |
| 40 | 0.1 < CA_Min / CA_AVR < 1 | 0.612 |
| 41 | 0.1 < CA_Max / (2*ImgH) < 1 | 0.720 |
| 42 | 0.1 < TD / CA_Max < 1.5 | 0.771 |

Table 3 shows the result values for Equations 43 to 85 described above in the optical system 1000 of FIG. 1. Referring to Table 3, the optical system 1000 may satisfy at least one or two of Equations 1 to 42 and at least one, two, or three of Equations 43 to 85. Accordingly, the optical system 1000 can improve optical performance and optical characteristics in the center and periphery portions of the FOV.

TABLE 3

| Equations | | First embodiment |
|---|---|---|
| 43 | 0 < F / L7R2 < 5 | 1.430 |
| 44 | 1 < F / L1R1 < 10 | 2.074 |
| 45 | 0 < EPD / L8R2 < 5 | 1.752 |
| 46 | 0.5 < EPD / L1R1 < 8 | 1.046 |
| 47 | -5 < F1 / F2 < 0 | -0.514 |
| 48 | 1 < F12 / F < 5 | 1.634 |
| 49 | 1 < \|F38 / F12\| < 4 | 1.254 |
| 50 | 0 < F1 / F < 3 | 1.297 |
| 51 | 0 < F1 / F12 < 2 | 0.564 |
| 52 | 0 < \|F1 / F38 \| < 2 | 0.347 |
| 53 | 0 < \|F1 / F4\| < 1 | 0.054 |
| 54 | 2 < TTL < 20 | 15.230 |
| 55 | 2 < ImgH | 12.715 |
| 56 | BFL < 2.5 | 2.023 |
| 57 | 2 < F < 20 | 12.610 |
| 58 | FOV < 120 | 89.322 |
| 59 | 0.5 < TTL / CA_Max < 2 | 0.832 |
| 60 | 0.5 < TTL / ImgH < 3 | 1.198 |
| 61 | 0.01 < BFL / ImgH < 0.5 | 0.159 |
| 62 | 4 < TTL / BFL < 10 | 7.530 |
| 63 | 0.5 < F / TTL < 1.5 | 0.828 |
| 64 | 3 < F / BFL < 10 | 6.234 |
| 65 | 0 < F / ImgH < 3 | 0.992 |
| 66 | 1 < F / EPD < 5 | 1.983 |
| 67 | 0 < BFL / TD < 0.3 | 0.143 |
| 68 | 0 < EPD / ImgH / FOV < 0.2 | 0.006 |
| 69 | 10 < FOV / F# < 55 | 45.051 |
| 70 | 0 < n1 / n2 < 1.5 | 0.916 |
| 71 | 0 < n3 / n4 < 1.5 | 0.996 |
| 72 | 0 < Inf71 / Inf72 < 1 | 0.674 |
| 73 | 0 < Inf81 / Inf82 < 1 | 0.367 |
| 74 | 1 < Inf72 / Inf81 < 5 | 2.915 |
| 75 | 0.3 < Inf71 / r71 < 0.7 | 0.468 |
| 76 | 0.3 < Inf72 / r72 < 0.7 | 0.520 |
| 77 | 0.3 < Inf82 / r82 < 0.7 | 0.384 |
| 78 | 1 < (Inf72 / r72) / (Inf82 / r82) < 2 | 1.355 |
| 79 | 5 < (TTL / ImgH)*n < 15 | 9.582 |
| 80 | 4 < (F / ImgH)*n < 14 | 7.934 |
| 81 | 25 < (TD_LG2 / TD_LG1)*n <55 | 41.902 |
| 82 | 20 < (CT_Max + CG_Max)*n < 30 | 26.825 |
| 83 | 100 < (FOV*TTL) / n<200 | 170.047 |
| 84 | (TTL*n) > FOV | Satisfaction |
| 85 | (v2*n2) < (v1*n1) | Satisfaction |

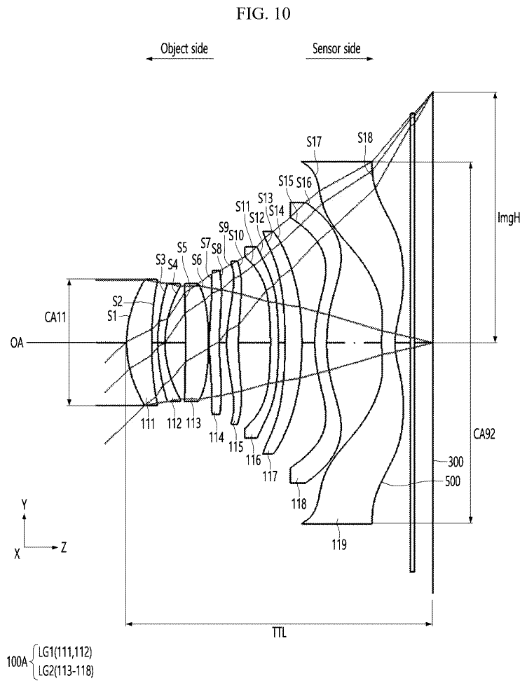

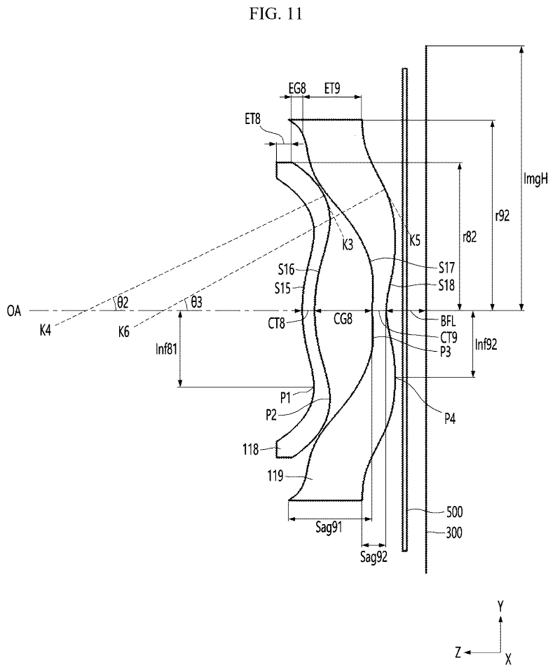

The second embodiment will be described with reference to FIGS. 10 to 19. For the same configuration as the first embodiment, refer to the description of the first embodiment, and redundant description will be omitted. Referring to FIGS. 10 and 11, the lenses 100A includes first and second lens groups LG1 and LG2, and each of the first and second lens groups LG1 and LG2 includes at least two lenses. The number of lenses of the second lens group LG2 may be 2.5 to 4 times the number of lenses of the first lens group LG1. The first lens group LG1 may include three or less lenses, for example, two lenses. The second lens group LG2 may include 5 or more lenses and 8 or less lenses. The number of lenses of the second lens group LG2 may be 5 or more than the number of lenses of the first lens group LG1. The second lens group LG2 may include, for example, 7 lenses.

In the optical system 1000, the TTL may be less than 70% of the diagonal length of the image sensor 300, for example, in the range of 40% to 69% or 50% to 65%. Accordingly, a slim optical system and a camera module having the same can be provided. The total number of lenses in the first and second lens groups LG1 and LG2 is 8 to 10.

The first and second lens groups LG1 and LG2 may have positive (+) refractive power. The first lens group LG1 may include a stack of lenses having a meniscus shape convex toward the object. In the second lens group LG2, the number of lenses having a critical point on at least one of the object-side surfaces and the sensor-side surfaces may be equal to or greater than the number of lenses without a critical point. Accordingly, the TTL can be reduced and the size of the image sensor 300 can be increased by the lens surfaces having the critical point of the second lens group LG2. The sensor-side surface of the first lens group LG1 may be concave, and the object-side surface of the second lens group LG2 may be concave. Additionally, two lenses facing each other in the first and second lens groups LG1 and LG2 may have opposite refractive powers.

Two lenses adjacent to the area between the first and second lens groups LG1 and LG2 may satisfy the following conditions.
Condition 1: Refractive index of a lens with positive refractive power<Refractive index of a lens with negative refractive power
Condition 2: Dispersion value of a lens with positive refractive power>Dispersion value of a lens with negative refractive power.

Accordingly, chromatic aberrations generated between the lenses can be mutually corrected.

The difference between the focal length of the second lens group LG2 and the focal length of the first lens group LG1 may be 10 or less, for example, 5 or less. Accordingly, the optical system 1000 according to the second embodiment can have improved aberration control characteristics such as chromatic aberration and distortion aberration by controlling the refractive power and focal length of each lens group LG1 and LG2, and may have good optical performance in the center and periphery of the FOV.

The optical axis distance between the first lens group LG1 and the second lens group LG2 may be greater than the center thickness of the lens (e.g., 112) closest to the sensor within the first lens group LG1, and may be smaller than the center thickness of the lens (e.g., 113) closest to the object within the second lens group LG2. The optical axis distance between the first lens group LG1 and the second lens group LG2 may be 43% or more of the optical axis distance of the first lens group LG1, and for example, may be in the range of 43% to 63% or 48% to 58% of the optical axis distance of the first lens group LG1. The optical axis distance between the first lens group LG1 and the second lens group LG2 may be 19% or less of the optical axis distance of the second lens group LG2, for example, in the range of 5% to 19% or 5% to 14%.

The lens with the minimum effective diameter within the first lens group LG1 may be the lens closest to the second lens group LG2. The lens with the minimum effective diameter within the second lens group LG2 may be the lens closest to the first lens group LG1. Accordingly, the optical system 1000 can have good optical performance even in the center and periphery portions of the FOV, and can improve chromatic aberration and distortion aberration. The effective diameters gradually become smaller from the object-side lens surface of the first lens group LG1 to the lens surface adjacent to the second lens group LG2, and may gradually increase from the object-side lens surface of the second lens group LG2 to the lens adjacent to the image sensor. The lens surface may include an object-side surface and a sensor-side surface of each lens. That is, the effective diameter of the lenses gradually decreases from the adjacent lens closest to the object to the lens surface adjacent between the first and second lens groups LG1 and LG2, and may gradually increase from a lens surface adjacent between the first and second lens groups LG1 and LG2 to a lens surface of the last lens. Accordingly, light can be guided to the periphery portion of the image sensor 300 around 1 inch (25.4 mm) due to the lens groups LG1 and LG2 having different refractive powers and the difference in effective diameter of the lens surfaces. The effective diameter difference between the lenses having the minimum effective diameter within the first lens group LG1 and the second lens group LG2 may be 0.25 mm or less. Accordingly, the incident light can be refracted into the effective region between the first and second lens groups LG1 and LG2, and then refracted to the periphery portion of the image sensor 300.

Among the lenses of the first lens group LG1, the lens closest to the object may have positive (+) refractive power, and among the lenses of the second lens group LG2, the lens closest to the sensor may have negative (−) refractive power. In the optical system 1000, the number of lenses with positive (+) refractive power may be greater than the number of lenses with negative (−) refractive power. In the second lens group LG2, the number of lenses with positive (+) refractive power may be greater than the number of lenses with negative (−) refractive power. Accordingly, chromatic aberration between the lenses of the second lens group LG2 can be corrected. Additionally, the ratio of the number of lenses with positive refractive power to the number of lenses with negative refractive power within the optical system 1000 can be selected from 1.5:1 to 2:1, and chromatic aberration between the lenses can be corrected. Within the optical system 1000, the sum of focal lengths of lenses with positive refractive power may be greater than the absolute value of the sum of focal lengths of lenses with negative refractive power. Accordingly, chromatic aberration and resolution can be improved by adjusting the refractive power and positive and negative focal lengths of each lens.

The optical filter 500 may be disposed between the image sensor 300 and a lens closest to the sensor among the plurality of lenses. For example, when the optical system 1000 has 9 lenses, the optical filter 500 may be disposed between the image sensor 300 and the ninth lens 119, which is the last lens. The aperture stop may be disposed around any one of the lenses of the first lens group LG1. For example, the aperture stop may be disposed around the object-side surface or sensor-side surface of the second or third lens on the object. Alternatively, at least one lens selected from among the plurality of lenses may function as an aperture stop. The aperture stop may satisfy the following condition: SD<EFL or SD<ImgH. Additionally, the condition may satisfy: SD<TTL. Additionally, the following condition may satisfy: F<TTL. The difference between F and ImgH may be 2 mm or less, for example, 0.01 mm to 2 mm or 0.01 mm to 1 mm. The FOV of the optical system 1000 may be less than 120 degrees, for example, more than 70 degrees and less than 100 degrees. F number F # of the optical system 1000 may be greater than 1 but less than 10, for example, 1.1≤F #<5. when it is 3 or less, a bright image can be provided. Additionally, the F # may be smaller than EPD. Accordingly, the optical system 1000 has a slim size, can control incident light, and can have improved optical characteristics within the FOV. The optical system 1000 according to the second embodiment may further include a reflection member (not shown) for changing the path of light. The reflective member may be implemented as a prism that reflects incident light from the first lens group LG1 in the direction of the lenses.

The lenses 100A may include first to ninth lenses 111 to 119. The first lens group LG1 may include the first to second lenses 111 and 112, and the second lens group LG2 may include the third to ninth lenses 113-119. The optical axis distance between the second lens 112 and the third lens 113 may be an optical axis distance between the first and second lens groups LG1 and LG2, and may be provided to be 0.50 mm or more to suppress an increase in the effective diameter of the fourth and fourth lenses 113 and 114. Among the first to ninth lenses 111 to 119, the number of lenses having a meniscus shape convex from the optical axis toward the object may be 4 or more or 5 or more. In the entire lens, the ratio of the meniscus-shaped lens convex toward the object side and the meniscus-shaped lens convex toward the sensor may be any of 6:3, 5:4, or 4:5.

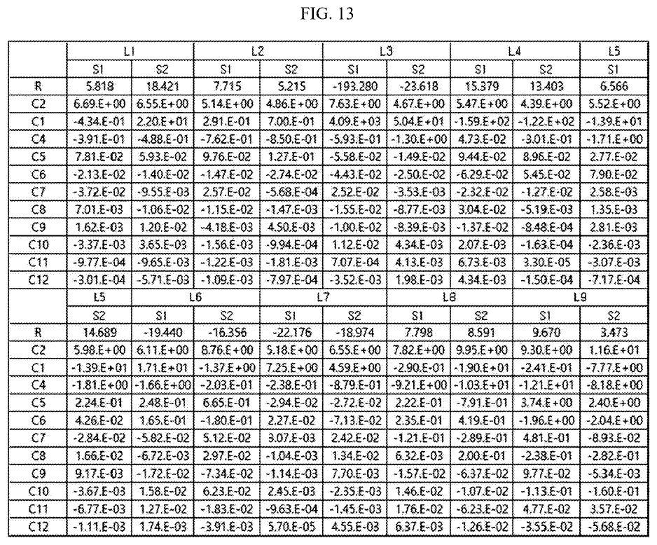

The first lens 111 may have positive (+) refractive power. The first lens 111 may be made of plastic material. The first surface S1 of the first lens 111 may have a convex shape, and the second surface S2 may have a concave shape. Since the first lens 111 has a meniscus shape that is convex toward the object, the amount of incident light can be improved. Alternatively, the first lens 111 may have a lens shape in which both sides are convex. Alternatively, the first surface S1 may have a concave shape. At least one of the first surface S1 and the second surface S2 may be aspherical, and the aspherical coefficients of the first and second surfaces S1 and S2 are provided as shown in FIG. 13, and L1 is the first lens 111, L1S1 is the first surface, and L1S2 is the second surface.

The second lens 112 may have negative (−) refractive power. The second lens 112 may be made of plastic material. The first and second lenses 111 and 112 have positive and negative refractive powers and can correct chromatic aberration. Additionally, an aperture stop may be disposed around the fourth surface S4 on the sensor side of the second lens 112. The third surface S3 of the second lens 112 may have a convex shape, and the fourth surface S4 may have a concave shape. That is, the second lens 112 may have a meniscus shape that is convex on the optical axis OA toward the object. Alternatively, the third surface S3 may have a convex shape, and the fourth surface S4 may have a convex shape. At least one of the third surface S3 and the fourth surface S4 may be aspherical, and the aspherical coefficients of the third and fourth surfaces S3 and S4 are provided as shown in FIG. 13, and L2 is the second lens 112, L2S1 is the third surface, and L2S2 is the fourth surface.

The third lens 113 may have positive (+) refractive power. The third lens 113 may be made of plastic material. The second and third lenses 112 and 113 have negative and positive refractive powers, so chromatic aberration occurring in lenses made of the same material can be corrected. Since the third lens 113 is located on the sensor side of the second lens 112 where the aperture stop is placed and has positive refractive power, and the light is refracted in the optical axis direction by the aperture stop, the sensor-side lenses with respect to the aperture stop may prevent the effective diameter from increasing. The fifth surface S5 of the third lens 113 may have a concave shape, and the sixth surface S6 may have a convex shape. The third lens 113 may have a meniscus shape that is convex on the optical axis OA toward the sensor. Differently, on the optical axis OA, the fifth surface S5 may have a concave shape, and the sixth surface S6 may have a concave shape. Alternatively, the third lens 113 may have a meniscus shape that is convex toward the object. The third surface S3 and the fourth surface S4 of the third lens 113 may be provided without a critical point from the optical axis OA to the end of the effective region. At least one of the fifth surface S5 and the sixth surface S6 may be aspherical, and the aspheric coefficients of the fifth and sixth surfaces S5 and S6 are provided as shown in FIG. 13, and L3 is the third lens 113, L3S1 is the fifth surface, and L3S2 is the sixth surface.

The fourth lens 114 may have negative (−) refractive power. The fourth lens 114 may be made of plastic material. Since the third and fourth lenses 114 are arranged with positive and negative refractive powers, chromatic aberration occurring in lenses made of the same material can be corrected. The seventh surface S7 of the fourth lens 114 may have a convex shape, and the eighth surface S8 may have a concave shape. At least one or both of the seventh and eighth surfaces S7 and S8 of the fourth lens 114 may be provided without a critical point. At least one or both of the seventh surface S7 and the eighth surface S8 may be aspherical, and the aspherical coefficient is provided as shown in FIG. 13, L4 is the fourth lens 114, and L4S1 is the seventh surface, and L4S2 is the eighth surface. The fifth lens 115 may have positive refractive power. The fifth lens 115 may be made of plastic material. The ninth surface S9 of the fifth lens 115 may have a convex shape, and the tenth surface S10 may have a concave shape. At least one or both of the ninth surface S9 and the tenth surface S10 may be aspherical, and the aspheric coefficients of the ninth surface S9 and the tenth surface S10 are provided as shown in FIG. 13, L5 is the fifth lens 115, L5S1 is the ninth surface, and L5S2 is the tenth surface.

The sixth lens 116 may have positive refractive power. The sixth lens 116 may be made of plastic material. On the optical axis OA, the eleventh surface S11 of the sixth lens 116 may have a concave shape, and the twelfth surface S12 may have a convex shape. At least one or both of the eleventh surface S11 and the twelfth surface S12 of the sixth lens 116 may be provided without a critical point from the optical axis OA to the end of the effective region. At least one or both of the eleventh surface S11 and the twelfth surface S12 may be aspherical, and the aspherical coefficient is provided as shown in FIG. 13, L6 is the sixth lens 116, and L6S1 is the eleventh surface, and L6S2 is the twelfth surface. The seventh lens 117 is an n−2th lens and may have positive refractive power. The seventh lens 117 may be made of plastic material. The focal length (absolute value) of the seventh lens 117 may be the largest within the lenses 100A. Accordingly, the focal length difference between the seventh lens 117 and adjacent lenses may be 30 mm or more. For example, when the absolute value of the focal length of the seventh lens 117 is F7, the focal length of the sixth lens 116 is F6, the focal length of the eighth lens 118 is F8, and the following condition may satisfy: F8<F6<F7. Additionally, since the fifth to eighth lenses 115, 116, 117, and 118 have positive refractive power, and the ninth lens 119 has negative refractive power, chromatic aberration occurring in lenses made of the same material can be corrected. The thirteenth surface S13 of the seventh lens 117 may have a concave shape, and the fourteenth surface S14 may have a convex shape. At least one or both of the thirteenth surface S13 and the fourteenth surface S14 may be aspherical, and the aspherical coefficient is provided as shown in FIG. 13, L7 is the seventh lens 117, and L7S1 is the thirteenth surface, and L7S2 is the fourteenth surface.

The eighth lens 118 is an n−1th lens and may have positive refractive power. The eighth lens 118 may be made of plastic material. The fifteenth surface S15 of the eighth lens 118 may have a convex shape, and the sixteenth surface S16 may have a concave shape. Alternatively, the eighth lens 118 may have a meniscus shape that is convex from the optical axis toward the sensor or a shape that is concave on both sides. At least one or both of the fifteenth and sixteenth surfaces S15 and S16 of the eighth lens 118 may have a critical point. The fifteenth and sixteenth surfaces S15 and S16 may be aspherical, and the aspheric coefficient is provided as shown in FIG. 13, L8 is the eighth lens 118, L8S1 is the fifteenth surface, and L8S2 is the sixteenth surface.

As shown in FIG. 11, the first critical point P1 of the fifteenth surface S15 of the eighth lens 118 may be located at a position greater than 48% of the effective radius from the optical axis OA, for example, in the range of 48% to 68%, or in the range of 53% to 63%. The second critical point P2 of the sixteenth surface S16 may be located at a position greater than 50% of the effective radius r82 from the optical axis OA, for example, in the range of 50% to 70%, or in the range of 55% to 65%. The second critical point P2 may be located at the same position as the first critical point P1 or closer to the edge, and the separation distance between the first and second critical points P1 and P2 may be 1 mm or less. Accordingly, the sixteenth surface S16 can refract the light incident on the fifteenth surface S15 further in the edge direction, thereby reducing the TTL.

The ninth lens 119 is an n-th lens and may have negative refractive power on the optical axis OA. The ninth lens 119 may be made of plastic material. The ninth lens 119 may be the closest lens or the last lens in the optical system 1000 to the sensor. In the ninth lens 119, the object-side seventeenth surface S17 may have a convex shape, and the sensor-side eighteenth surface S18 may have a concave shape. At least one or both of the seventeenth and eighteenth surfaces S17 and S18 of the ninth lens 119 may have a critical point. The seventeenth and eighteenth surfaces S17 and S18 may be aspherical, and the aspheric coefficient is provided as shown in FIG. 13, L9 is the ninth lens 119, L9S1 is the seventeenth surface, and L9S2 is the eighteenth surface.

As shown in FIG. 11, the third critical point P3 of the seventeenth surface S17 of the ninth lens 119 may be located at a distance of 25% or less of the effective radius from the optical axis OA, for example, in the range of 5% to 25%, or in the range of 10% to 20%. The fourth critical point P4 of the eighteenth surface S18 may be located in a range of 26% or more, for example, 26% to 46%, or 31% to 41% of the effective radius r92 based on the optical axis OA. The third critical point P3 may be located closer to the optical axis OA than the first, second, and fourth critical points P1, P2, and P4, and the separation distance between the third and fourth critical points P3 and P4 may be greater than 1 mm. Accordingly, the seventeenth surface S17 refracts light toward the center of the image sensor 300, and the eighteenth surface S18 refracts light toward the periphery portion of the image sensor 300. Accordingly, TTL of the optical system 1000 can be reduced.

The positions of the critical points of the eighth and ninth lenses 118 and 119 are preferably arranged at positions that satisfy the above-mentioned range in consideration of the optical characteristics of the optical system 1000. In detail, it is desirable that the position of the critical point satisfies the above-mentioned range for controlling optical characteristics such as chromatic aberration, distortion characteristics, aberration characteristics, and resolution of the optical system 1000. Accordingly, the path of light emitted to the image sensor 300 through the lens can be effectively controlled. Accordingly, the optical system 1000 according to the second embodiment can have improved optical characteristics even in the center and periphery portions of the FOV.

As shown in FIG. 11, the distance from the optical axis OA to the ends of the effective regions of each of the fifteenth surface S15 and the sixteenth surface S16 of the eighth lens 118 is the effective radius, which is defined as r81 and r82. The distance from the optical axis OA to the ends of the effective regions of each of the seventeenth surface S17 and the eighteenth surface S18 of the ninth lens 119 is the effective radius, which is defined as r91 and r92. The distance from the optical axis OA to the critical points P1, P2, P3, and P4 of the fifteenth, sixteenth, seventeenth, and eighteenth surfaces S15, S16, S17, and S18 can be defined as follows.
Inf81: Straight distance from the center of the fifteenth surface S15 to the first critical point P1
Inf82: Straight distance from the center of the sixteenth surface S16 to the second critical point P2
Inf91: Straight distance from the center of the seventeenth surface S17 to the third critical point P3
Inf92: Straight distance from the center of the eighteenth surface S18 to the fourth critical point P4

The distance from the center of each lens surface to the critical point may have the following relationship.

$$Inf 81 < Inf 82 , \qquad Condition 1$$

$$Inf 91 < Inf 92 , \qquad Condition 2$$

$$Inf 91 < Inf 92 < Inf 82 , \qquad Condition 3$$

$$( inf 82 - Inf 81 ) < ( Inf 92 - Inf 91 ) \qquad Condition 4$$

The positions of the first and second critical points P1 and P2 may be located 2 mm or more from the optical axis OA, for example, within a range of 2 mm to 5 mm, and the third critical point P3 may be located at less than 2 mm from the optical axis OA, for example in the range of 0.5 mm to 1.5 mm. The fourth critical point P4 may be located at a position of 2.3 mm or more from the optical axis, for example, within a range of 2.3 mm to 4.3 mm. Accordingly, the eighth and ninth lenses 118 and 119 can refract the incident light toward the center and periphery portions.

The inclination angle between the optical axis OA and the normal line K6, which is a straight line perpendicular to the tangent K5 passing through an arbitrary point of the sensor-side eighteenth surface S18 of the ninth lens 119, may be a first angle θ3, and when the first angle θ3 is maximum, it may be greater than 5 degrees and less than 65 degrees, for example, in the range of 44 degrees to 64 degrees or 49 degrees to 59 degrees. Accordingly, TTL can be reduced and the size of the image sensor 300 can be increased by the inclination angle of the eighteenth surface S18. The inclination angle between the normal line K4 perpendicular to the tangent line K3 passing through the sixteenth surface S16 of the eighth lens 118 and the optical axis may be a second angle θ2, and when the second angle θ2 is maximum, it may be greater than 5 degrees and less than 65 degrees, for example in the range of 17 degrees to 37 degrees or in the range of 22 degrees to 32 degrees. Accordingly, the maximum inclination angle θ2 of the sixteenth surface S16 may be smaller than the maximum inclination angle of the eighteenth surface S18. Accordingly, the light traveling through the eighth lens 118 can be guided to the entire region of the ninth lens 119. The maximum inclination angle between the optical axis and the normal line perpendicular to the tangent line passing through the seventeenth surface S17 of the ninth lens 119 is θ4, and the tangent line passing through the fifteenth surface S15 of the eighth lens 118 is defined as θ4, when the maximum inclination angle between the vertical normal and the optical axis is defined as θ5, and θ2 and θ3 are the maximum inclination angles, at least one of the following conditions can be satisfied.

$$θ2 < θ3 , \qquad Condition 1$$

$$θ4 < θ4 , \qquad Condition 2$$

$$θ4 < θ3 \qquad Condition 3$$

$$0 < θ3 - θ4 < 10 , \qquad Condition 4$$

$$10 < θ3 - θ2 < 40 \qquad Condition 5$$

$$5 < θ5 - θ2 < 20 \qquad Condition 6$$

Accordingly, by increasing the inclination angle between the object-side surface and the sensor-side surface of the eighth lens 118, the inclination angle of the outer portion of the ninth lens 119 may not be increased. Accordingly, the TTL can be reduced and the size of the image sensor 300 can be increased.

The curvature radii of the seventeenth and eighteenth surfaces S17 and S18 of the ninth lens 119 on the optical axis can be defined as L9R1 and L9R2. The curvature radii may satisfy at least one of the following conditions 1-9 to improve the aberration characteristics of the optical system.

$$( L 2 R 1 + L 2 R 2 ) < L 1 R 2 \qquad Condition 1$$

$$( L 2 R 1 + L 2 R 2 ) < L 1 R 2 - L 1 R 1 \qquad Condition 2$$

$$( \vert L 3 R 2 \vert * 2 ) < \vert L 3 R 1 \vert , \qquad Condition 3$$

$$( L 4 R 1 * L 4 R 2 ) < \vert L 3 R 1 + L 3 R 2 \vert \qquad Condition 4$$

$$( L 5 R 1 * L 5 R 2 ) < \vert L 3 R 1 \vert , \qquad Condition 5$$

$$\vert L 6 R 1 + L 6 R 2 \vert < \vert L 3 R 1 \vert ( where L 6 R 1 , L 6 R 2 < 0 ) \qquad Condition 6$$

$$\vert L 7 R 1 + L 7 R 2 \vert < \vert L 3 R 1 \vert ( where L 7 R 1 , L 7 R 2 < 0 ) \qquad Condition 7$$

On the optical axis OA, the average curvature radius of any one of the second and ninth lenses 112 and 119 may be the minimum in the optical system, and the fourth surface S4 of the second and ninth lenses 112 and 119 may have the smallest average curvature radius in the optical system. The difference in the curvature radius of the eighteenth surface S18 may be 4 mm or less. The average of the curvature radii (absolute value) of the fifth and sixth surfaces S5 and S6 of the third lens 113 may be the maximum within the optical system 1000. By setting the curvature radius of each lens, good optical performance can be provided at the focal length of each lens.

The effective diameters of the first to ninth lenses 111-119 can be defined as CA1-CA9. The effective diameter CA9 of the ninth lens 118 may have a maximum effective diameter and may be 10 mm or more. The effective diameter CA9 of the ninth lens 119 is the average of the effective diameters of the object-side surface and the sensor-side surface. The effective diameter CA9 of the ninth lens 119 may be more than twice the curvature radius of the object-side surface S1 of the first lens 111.

The effective diameters of the seventeenth and eighteenth surfaces S17 and S18 of the ninth lens 119 on the optical axis can be defined as CA91 and CA92. These effective diameters are factors that affect the aberration characteristics of the optical system, and may satisfy at least one of the following conditions.

$$CA 22 < CA 12 < CA 11 , \qquad Condition 1$$

$$CA 22 < CA 32 < CA 51 < CA 52 < CA 61 < CA 62 , \qquad Condition 2$$

$$CA 62 < CA 72 < CA 81 < CA 82 < CA 91 < CA 92 , \qquad Condition 3$$

$$CA 31 - CA 22 < CA 41 - CA 32 , \qquad Condition 4$$

$$CA 41 + CA 42 < CA 92 , \qquad Condition 5$$

$$L 9 R 1 + L 9 R 2 < CA 92 \qquad Condition 6$$

The effective diameter of the lenses may be the smallest for the second lens 112 and the largest for the ninth lens 119. The effective diameter of the fourth surface S4 or the fifth surface S5 may be the minimum, and the effective diameter of the eighteenth surface S18 may be the largest. The size of the effective diameter of the ninth lens 119 is the largest, so that it can effectively refract incident light toward the image sensor 300. Accordingly, the optical system 1000 can have improved chromatic aberration control characteristics, and the vignetting characteristics of the optical system 1000 can be improved by controlling incident light.

In the optical system, the number of lenses with a refractive index exceeding 1.60 may be 4 or less, and may be smaller than the number of lenses with a refractive index of 1.60 or less. In the optical system, the number of lenses of 1.60 or less may be 4 or more or 5 or more. The average refractive index of the first to ninth lenses 111-119 may be 1.50 or more. In the optical system, the number of lenses with an Abbe number greater than 45 may be greater than the number of lenses with an Abbe number of less than 45, for example, 5 or more. The average of Abbe numbers of the first to ninth lenses 111-119 may be 40 or more. By setting the refractive index and Abbe number of each lens, the effect of chromatic aberration can be controlled.

BFL is an optical axis distance between the surface of the image sensor 300 and the sensor-side eighteenth surface S18 of the ninth lens 119. CT8 is the center thickness of the eighth lens 118, and ET8 is the edge thickness at the end of the effective region of the eighth lens 118. CT9 is the center thickness of the ninth lens 119. CG8 is an optical axis distance between the eighth lens 118 and the ninth lens 119. That is, the optical axis distance CG8 between the eighth lens 118 and the ninth lens 119 is the distance between the sixteenth surface S16 and the seventeenth surface S17 in the optical axis OA. In this way, the center thickness of the first to ninth lenses 119 can be defined as CT1 to CT9, and the optical axis distance between the first to ninth lenses can be defined as CG1 to CG8. Additionally, the edge thickness of each lens can be defined as ET1 to ET9, and the edge distance between adjacent lenses can be defined as EG1 to EG8. Here, the edge thickness and edge distance may be the distance in the optical axis direction between effective regions of each lens. The CG8 may be larger than the optical axis distance CG2 between the second and third lenses 112 and 113. The CG8 may be greater than the sum of the center thicknesses CT6 and CT8 of the sixth and eighth lenses 116 and 118. The CG8 may be the largest among the optical axis distances between two adjacent lenses. The CG8 may be 23% or less of the optical axis distance from the first surface S1 of the first lens 111 to the eighteenth surface S18 of the ninth lens 119, for example, in the range of 10% to 23%. Among the first to ninth lenses 111-119, the first lens 111 has the maximum center thickness. The center thickness CT1 of the first lens 111 may be greater than the center thickness of the eighth and ninth lenses 118 and 119, and may satisfy the conditions: CT1<CG8 and CT1<CG5. A slim optical system with improved optical performance can be provided by the center thickness CT1 of the first lens 111 and the optical axis distance CG8 between the eighth and ninth lenses 118 and 119.

Equation may satisfy: CG1<CT2<CT3. Accordingly, by making the center distance CG1 between the first and second lenses 111 and 112 smaller than the center thickness CT2 of the second lens 112, the difference between the effective diameters CA1, CA2, and CA3 can be reduced and the center distance between lenses can be reduced. Equation may satisfy: CA3-CA2<CA1-CA2.

The center distance CG8 between the eighth lens 118 and the ninth lens 119 is the largest among the center distances between lenses, and the optical axis distance CG3 between the third and fourth lenses 113 and 114 is the minimum among the center distances between lenses. The lens having the minimum center thickness may be any one of the second, fourth, fifth, and sixth lenses 112, 114, 115, and 116, for example, the second lens 112.

Among the lenses 111-119, the maximum center thickness may be 4 times or less, for example, 1.5 to 4 times, or 3 to 4 times the minimum center thickness. Among the above lenses, the number of lenses with a center thickness of 0.60 mm or less may be greater than the number of lenses with a center thickness of more than 0.6 mm, and is 5 or more. The average center thickness of the lenses may be less than 0.8 mm, for example in the range of 0.6 mm to 0.79 mm. The optical system 1000 having an image sensor 300 with a size of around 1 inch can be provided in a structure with a slim thickness.

The sum of the center thicknesses CT of the first to ninth lenses 111-119 is ECT, the sum of the center distances between the first to ninth lenses 111-119 is ΣCG, and the average of the center thicknesses CT of the ninth lens 111-119 is CT_AVER, and any one of the following conditions may be satisfied.

$$Σ CT < Σ CG , \qquad Condition 1$$

$$0.5 < Σ CG - ΣCT , \qquad Condition 2$$

$$0.3 < CT\_AVER < 0.9 \qquad Condition 3$$

By setting the sum ΣCT of the center thicknesses of the first to ninth lenses 111-119 and the sum ΣCG of the center distances between the first to ninth lenses 111-119, the optical system 1000 can control incident light and have improved aberration characteristics and resolution.

When defining the focal length of each lens 111-119 as F1-F9, at least one of the following conditions can be satisfied.

$$F 1 < F 3 , \qquad Condition 1$$

$$F 5 < F 3 < \vert F 4 \vert \qquad Condition 2$$

$$F 3 < F 8 < F 7 , \qquad Condition 3$$

$$F 8 < ( \vert F 4 \vert ) < F 7 \qquad Condition 4$$

By adjusting the focal lengths, resolution can be affected. when the focal length is described as an absolute value, the focal length F7 of the seventh lens 117 may be the largest among the lenses, the focal length of the ninth lens 119 may be the minimum, and a difference between the focal lengths of the eighth and ninth lenses 118 and 119 may be 50 mm or more in absolute value. The maximum focal length may be 50 times or more than the minimum focal length. The refractive power of the first to ninth lenses 111-119 may be distributed to minimize chromatic aberration.

If the refractive index of each lens 111-119 is n1-n9 and the Abbe number of each lens 111-119 is v1-v9, the refractive index may satisfy the condition: n1<n2, and n1, n3, n5, n7, n8, and n9 are 1.6 or less and can have a difference of 0.2 or less from each other, and n2, n4, and n6 are more than 1.60. Abbe number may satisfy the condition: v2<v1, and v1, v3, v5, v7, v8, and v9 can be 45 or more and have a difference of less than 5 from each other, and v2, v4, v6 can be less than 45, for example, 30 or less. Accordingly, the optical system 1000 may have improved chromatic aberration control characteristics. Preferably, the following condition may satisfy: v2*n2<v1*n1. To minimize chromatic aberration, the refractive index of the second lens 112 can be set to be relatively high, and the refractive index of the third lens 113 can be set to be relatively low. Additionally, in order to minimize chromatic aberration, the Abbe number v2 of the second lens 112 may be set relatively low and the Abbe number v3 of the third lens 113 may be set relatively high.

In addition, the first to ninth lenses 111-119 are made of plastic material and all have an aspherical surface, so that spherical aberration and chromatic aberration can be corrected, and lenses with a high Abbe number and lenses with a low refractive index are alternately used. By arranging them, it is possible to provide a high-resolution small lens optical system by compensating for chromatic aberration and improving performance between lenses.

The optical system 1000 according to the second embodiment may satisfy at least one or two of the equations described below. Accordingly, the optical system 1000 according to the second embodiment has improved optical characteristics. Aberration characteristics such as chromatic aberration and distortion aberration can be effectively controlled, and good optical performance can be achieved even in the center and periphery portions of the FOV. The optical system 1000 may have improved resolution and may have a slimmer and more compact structure.

$$1 < CT 1 / CT 2 < 5 \qquad [ Equation l ]$$

In Equation 1, when the center thickness CT1 of the first lens 111 and the center thickness CT2 of the second lens 112 are satisfied, the optical system 1000 can improve aberration characteristics. Preferably, Equation 1 may satisfy: 2.5<CT1/CT2<4.5.

$$1 < CT 3 / E T 3 < 5 \qquad [ Equation 2 ]$$

In Equation 2, when the center thickness CT3 of the third lens 113 and the edge thickness ET3 of the third lens 113 are satisfied, the optical system 1000 may have improved chromatic aberration control characteristics. Preferably, Equation 2 may satisfy: 1.2<CT3/ET3<2.5.

$$1 < CT 1 / ET 1 < 4 \qquad [ Equation 2 - l ]$$

$$0 < CT 2 / ET 2 < 1 \qquad [ Equation 2 - 2 ]$$

$$1 < CT 3 / ET 3 < 4 \qquad [ Equation 2 - 3 ]$$

$$0.8 < CT 4 / ET 4 < 1.8 \qquad [ Equation 2 - 4 ]$$

$$1 < CT 5 / ET 5 < 4 \qquad [ Equation 2 - 5 ]$$

$$0.5 < CT 6 / ET 6 < 1.5 \qquad [ Equation 2 - 6 ]$$

$$1 < CT 7 / ET 7 < 5 \qquad [ Equation 2 - 7 ]$$

$$0.5 < CT 8 / ET 8 < 1.5 \qquad [ Equation 2 - 8 ]$$

$$0 < CT 9 / ET 9 < 1 \qquad [ Equation 2 - 9 ]$$

$$0.5 < SD / TD < 1 \qquad [ Equation 2 - 10 ]$$

If the ratio of the center thickness CT2-CT9 and the edge thickness ET2-ET9 of the second to ninth lenses 112-119 is satisfied in Equations 2-1 to 2-8, the optical system 1000 may have improved chromatic aberration control characteristics. In other words, by setting the range of the center thickness with respect to the edge thickness of each lens 111 to 119, the difference between the outermost thickness and the center thickness of each lens is set to the range, distortion aberration may be corrected and a wide-angle image may be obtained. In addition, the difference between the edge thickness and the center thickness of the first lens 111 is set to be larger than the difference between the outermost thickness and the center thickness of the last lens 119 to correct the distortion aberration of the light traveling to the image sensor 300.

SD is the optical axis distance from the aperture stop to the sensor-side eighteenth surface S18 of the ninth lens 119, and TD is the optical axis distance from the object-side first surface S1 of the first lens 111 to the sensor-side eighteenth surface S18 of the ninth lens 119. The aperture stop may be disposed around the perimeter of the sensor-side surface of the second lens 112. When the optical system 1000 according to the second embodiment satisfies Equation 2-9, the optical system 1000 can correct chromatic aberration.

$$0.5 < \vert F \_ LG 1 / F \_ LG 2 \vert < 1.5 \qquad [ Equation 2 - 10 ]$$

F_LG1 is the focal length of the first lens group LG1, and F_LG2 is the focal length of the second lens group LG2. When the optical system 1000 according to the second embodiment satisfies Equation 2-10, the optical system 1000 can correct chromatic aberration. That is, as the value of Equation 2-10 approaches 1, the distortion aberration can be reduced. Preferably, the condition 0<|F_LG1−F_LG2|<5 may be satisfied.

$$18 < TTL / CT\_AVR < 28 \qquad [ Equation 3 ]$$

In Equation 3, CT_AVER is the average of the center thicknesses of the first to ninth lenses 111-119, and when the center thickness and TTL of the lenses satisfy the above range, a slim optical system can be provided. Preferably, 18<TTL/CT_AVER<25 may be satisfied.

$$2 < TTL / CT \_ AVER / n < 3 \qquad [ Equation 3 - 1 ]$$

In Equation 3-1, n is the total number of lenses, and when the center thickness and TTL of the lenses satisfy the above range compared to the number of lenses, a slim optical system can be provided.

$$CG 5 < CG 8 \qquad [ Equation 3 - 2 ]$$

In Equation 3-2, when the optical axis distance CG5 between the fifth and sixth lenses 115 and 116 and the optical axis distance CG8 between the seventh and eighth lenses satisfy the above range, the optical system 1000 has improved chromatic aberration control characteristics.

$$CT 1 + CT 2 + CT 3 + CT 4 < CG 5 + CG 8 \qquad [ Equation 3 - 3 ]$$

In Equation 3-3, when the sum of the center thicknesses CT1, CT2, CT3, and CT4 of the first to fourth lenses 111, 112, 113, and 114 is smaller than a sum of the optical axis distance CG5 between the fifth and sixth lenses 115 and 116 and the optical axis distance CG8 between the eighth and ninth lenses 118 and 119, the optical system 1000 may have improved chromatic aberration control characteristics. Additionally, by reducing the thickness of each lens, a slim optical system can be provided. In addition, by reducing the thickness of each lens and the distance between adjacent lenses in Equations 3 to 3-3, a slim optical system can be provided.

$$1. 60 < n 2 \qquad [ Equation 4 ]$$

In Equation 4, n2 means the refractive index at the d-line of the second lens 112. When the optical system 1000 according to the second embodiment satisfies Equation 4, the optical system 1000 can improve chromatic aberration characteristics.

$$1.5 < n 1 < 1.6 , 1.5 < n 3 < 1.6 , 1.6 < n 4 < 1.7 , 1.5 < n 5 < 1.6 \qquad [ Equation 4 - 1 ]$$

In Equation 4-1, n1, n3, n4, and n5 are the refractive indices at the d-line of the first, third, fourth, and fifth lenses 111, 113, 114, and 115. When the optical system 1000 according to the second embodiment satisfies Equation 4-1, the influence on the TTL of the optical system 1000 can be suppressed.

$$0 \leq \vert n 7 - n 8 \vert \leq 0.05 , 0 \leq \vert n 8 - n 9 \vert \leq 0.05 \qquad [ Equation 4 - 2 ]$$

In Equation 4-2, n7, n8, and n9 are the refractive indices at the d-line of the seventh, eighth, and ninth lenses 117, 118, and 119. When the optical system 1000 according to the second embodiment satisfies Equation 4-2, the optical system 1000 can improve chromatic aberration characteristics.

$$0.8 < Max\_ Sag 92 to Sensor < 1.8 \qquad [ Equation 5 ]$$

In Equation 5, Max_Sag92 to Sensor means a distance in the optical axis direction from the maximum Sag value of the sensor-side eighteenth surface S18 of the ninth lens 119 to the image sensor 300. Max_Sag92 is the maximum separation distance from the straight line extending perpendicular to the optical axis from the center of the sensor-side eighteenth surface S18 of the ninth lens 119 to the eighteenth surface S18, and when it is positioned on the sensor side than the straight line, it may have a positive value, and when it is positioned on the object side than the straight line, it may have a negative value. For example, Max_Sag92 to Sensor means the distance in the optical axis direction from the fourth critical point P4 on the sensor-side surface of the ninth lens 119 to the image sensor 300. When the optical system 1000 according to the second embodiment satisfies Equation 5, the optical system 1000 secures a space where the optical filter 500 can be placed between the lenses 100A and the image sensor 300, thereby having improved assembly properties. Additionally, when the optical system 1000 satisfies Equation 5, the optical system 1000 can secure a distance for module manufacturing. Preferably, the value of Equation 5 may satisfy: 1.2<Max_Sag92 to Sensor<1.6. In the lens data for the second embodiment, the position of the optical filter 500, the distance between the last lens and the filter 500 in detail, and the distance between the image sensor 300 and the optical filter 500 are set positions for convenience of design of the optical system 1000, and the optical filter 500 may be freely disposed within a range that does not contact the last lens and the image sensor 300. Accordingly, the value of Max_Sag92 to Sensor in the lens data may be smaller than the BFL of the optical system 1000, and the position of the filter 500 may be moved within a range that is not in contact with the last lens and the image sensor 300, respectively, to have good optical performance.

$$0.8 < BFL / Max\_ Sag 92 to Sensor < 2 \qquad [ Equation 6 ]$$

In Equation 6, back focal length (BFL) means the distance (mm) in the optical axis OA from the center of the eighteenth surface S18 of the ninth lens 119 to the image surface of the image sensor 300. When the optical system 1000 according to the second embodiment satisfies Equation 6, the optical system 1000 can improve distortion aberration characteristics and have good optical performance in the periphery portion of the FOV. Equation 6 may satisfy the following condition: BFL>Max_Sag92 to Sensor.

$$5 < \vert L 9 S 2 \_ Max slope \vert < 65 \qquad [ Equation 7 ]$$

In Equation 7, L9S2_Max slope means the maximum value (Degree) of the tangential angle measured on the sensor-side eighteenth surface S18 of the ninth lens 119. In detail, on the eighteenth surface S18, L9S2_Max slope means a value in which the angle θ2 between the optical axis OA and the normal line K2 (See FIG. 11) perpendicular to a tangent line passing through an arbitrary point of the eighteenth surface S18 is the maximum value. When the optical system 1000 according to the second embodiment satisfies Equation 7, the optical system 1000 can control the occurrence of lens flare. Preferably, Equation 7 may satisfy: 21≤|L9S2_Max slope|≤40.

$$CT 1 < \vert Max\_ Sag 91 \vert \qquad [ Equation 8 ]$$

In Equation 8, Max_Sag91 is the maximum distance value from the straight line extending in the directions X and Y perpendicular to the center of the object-side surface of the ninth lens 119 to the seventeenth surface S17 in the optical axis direction, CT1 is the center thickness of the first lens. When Equation 8 is satisfied, the optical system 1000 may increase the height at the outer portion of the effective region of the object-side surface of the ninth lens 119 compared to the center thickness of the first lens 111, which has the maximum center thickness. Accordingly, the ninth lens 119 has the maximum effective diameter and can refract the incident light toward the image sensor 300. When the optical system 1000 according to the second embodiment satisfies Equation 8, the size of the image sensor 300 can be increased compared to the TTL of the optical system 1000, and a slim optical system can be provided. Preferably, the following condition may satisfy: 2<|Max_Sag91|<3.5. The outer portion of the effective region of the object-side or sensor-side surface of each lens may include an edge.

$$CG 7 < \vert Max\_Sag92 \vert \qquad [ Equation 8 ‐ 1 ]$$

In Equation 8-1, Max_Sag92 is the maximum distance value from the straight line extending in the directions X and Y perpendicular to the center of the sensor-side surface of the ninth lens 119 to the edge of the eighteenth surface S18 in the optical axis direction. when Equation 8-1 is satisfied, the optical system 1000 may set the maximum height of the outer effective region of the sensor-side surface of the ninth lens 119 to be greater than the center distance CG7 between the seventh and eighth lenses 117 and 118. Accordingly, the sensor-side surface of the ninth lens 119 can guide the light refracted outside the second critical point P2 of the eighth lens 118. Accordingly, the ninth lens 119 has the maximum effective diameter and can refract the incident light toward the image sensor 300. When the optical system 1000 according to the second embodiment satisfies Equation 8-1, the size of the image sensor 300 can be increased compared to the TTL of the optical system 1000, and a slim optical system can be provided. Preferably, the following condition may satisfy: |Max_Sag92|<|Max_Sag91|.

$$CG 2 < \vert Max\_Sag81 \vert < CG 5 \qquad [ Equation 9 ]$$

In Equation 9, Max_Sag81 is the maximum distance value from the straight line extending in the directions X and Y perpendicular to the center of the object-side surface of the eighth lens 118 to the edge of the sixteenth surface S16 in the perpendicular direction, CG2 is the optical axis distance between the second and third lenses, and CG5 is the optical axis distance between the fifth and sixth lenses. when Equation 9 is satisfied, the optical system 1000 may be arranged so that the outer portion of the effective region of the object-side surface of the eighth lens 118 is further outside than the edges of the sixth and seventh lenses 116 and 117. Accordingly, the eighth lens 118 can refract light incident from the outside of the seventh lens 117 toward the ninth lens 119. When the optical system 1000 according to the second embodiment satisfies Equation 9, the size of the image sensor 300 can be increased compared to the TTL of the optical system 1000, thereby providing a slim optical system. When the optical system 1000 satisfies Equations 8 and 9, the optical system 1000 can improve distortion aberration characteristics and have good optical performance in the periphery portion of the FOV. Preferably, the following condition may satisfy: Max_Sag82|<|Max_Sag91|. Also, the following condition may satisfy: (CT1+CT2)<Max_Sag91|< (CT1*3).

$$CT 2 < CG 2 \qquad [ Equation 9 ‐ 1 ]$$

$$\vert CT 1 - CG 2 \vert < 0.5 \qquad [ Equation 9 ‐ 2 ]$$

In Equations 9-1 and 9-2, CT3 is the center thickness of the third lens, CG2 is the center distance between the second and third lenses, and when this is satisfied, the sizes of the lenses may be controlled with respect to the boundary between the first and second lens groups LG1 and LG2, and factors affecting distortion aberration may be controlled.

$$1 < CG 8 / EG 8 < 10 \qquad [ Equation 10 ]$$

In Equation 10, when the optical axis distance CG8 between the eighth and ninth lenses 118 and 119 and the optical axis distance EG8 at the ends of the effective region between the eighth and ninth lenses 118 and 119 are satisfied, it may have good optical performance even in the center and peripheral portion of the FOV. Additionally, the optical system 1000 can reduce distortion and have improved optical performance. Preferably, Equation 10 may satisfy: 2<CG8/EG8<5.

$$0 < CG 8 / CG 5 < 3 \qquad [ Equation 11 ]$$

In Equation 11, when the optical axis distance CG5 between the fifth lens 115 and the sixth lens 116 and the optical axis distance CG8 between the eighth and ninth lenses 118 and 119 are satisfied, the optical system 1000 can improve aberration characteristics and control the size of the optical system 1000, for example, reducing the TTL. Preferably, Equation 11 may satisfy: 1.3<CG8/CG5<2.

$$0 < CT 1 / CT 8 < 3 \qquad [ Equation 12 ]$$

In Equation 12, when the center thickness CT1 of the first lens 111 and the center thickness CT8 of the eighth lens 118 are satisfied, the optical system 1000 may have improved aberration characteristics. Additionally, the optical system 1000 has good optical performance at a set FOV and can control TTL. Preferably, Equation 12 may satisfy: 1.5<CT1/CT8<2.5.

$$0 < CT 7 / CT 8 < 3 \qquad [ Equation 13 ]$$

In Equation 13, when the center thickness CT7 of the seventh lens 117 and the center thickness CT8 of the eighth lens 118 are satisfied, the optical system 1000 includes the seventh lens 117 and the eighth lens 117. The manufacturing precision of the lens 118 can be relaxed, and the optical performance of the center and periphery portions of the FOV can be improved. Preferably, Equation 13 may satisfy: 1<CT7/CT8<2.

$$0 < L 8 R 2 / L 9 R 1 < 20 \qquad [ Equation 14 ]$$

In Equation 14, L8R2 means the curvature radius (mm) of the sixteenth surface S16 of the eighth lens 118 on the optical axis, and L9R1 means the curvature radius (mm) of the seventeenth surface S17 of the ninth lens 119 on the optical axis. When the optical system 1000 according to the second embodiment satisfies Equation 14, the aberration characteristics of the optical system 1000 can be improved. Preferably, Equation 14 may satisfy: 0<L8R2/L9R1<1.5.

$$0 < ( CG 8 - EG 8 ) / CG 8 < 1 \qquad [ Equation 15 ]$$

If Equation 15 satisfies the center distance CG8 and edge distance EG8 between the eighth and ninth lenses 118 and 119, the optical system 1000 can reduce the occurrence of distortion and have improved optical performance. Additionally, by reducing the edge distance between the eighth and ninth lenses 118 and 119 compared to the center distance, the height of the outer portion of the ninth lens 119 can be increased. When the optical system 1000 according to the second embodiment satisfies Equation 15, optical performance in the center and periphery portions of the FOV can be improved. Equation 15 may preferably satisfy the condition: 0.5< (CG8-EG8)/(CG8)<1.

$$0 < CA 11 / CA 22 < 2 \qquad [ Equation 16 ]$$

In Equation 16, CA11 means the effective diameter (clear aperture, CA) of the first surface S1 of the first lens 111, and CA22 means the effective diameter of the fourth surface S4 of the second lens 112. When the optical system 1000 according to the second embodiment satisfies Equation 16, the optical system 1000 can control the optical paths incident and emitted from the first lens group LG1 and have improved aberration control characteristics. Equation 16 may preferably satisfy: 1<CA11/CA22<1.5.

$$1 < CA 82 / CA 31 < 5 \qquad [ Equation 17 ]$$

In Equation 17, CA31 means the effective diameter of the fifth surface S5 of the third lens 113, and CA82 means the effective diameter of the sixteenth surface S16 of the eighth lens 118. When the optical system 1000 according to the second embodiment satisfies Equation 17, the optical system 1000 can control the path of light incident on the second lens group LG2 and improve aberration characteristics. Preferably, Equation 17 may satisfy: 2<CA82/CA31<3.

$$0.5 < CA 22 / CA 31 < 1.5 \qquad [ Equation 18 ]$$

In Equation 18, when the effective diameter CA22 of the fourth surface S4 of the second lens 112 and the effective diameter CA31 of the fifth surface S5 of the third lens 113 are satisfied, the difference in effective diameter between the first and second lens groups LG1 and LG2 can be reduced and light loss can be suppressed. Additionally, the optical system 1000 can improve chromatic aberration and control vignetting for optical performance. Preferably, Equation 18 may satisfy: 0.7<CA22/CA31<1.2.

$$0.1 < CA 52 / CA 82 < 1 \qquad [ Equation 19 ]$$

In Equation 19, when the effective diameter CA52 of the tenth surface S10 of the fifth lens 115 and the effective diameter CA82 of the sixteenth surface S16 of the eighth lens 118 are satisfied, the optical path to the second lens group LG2 can be set. Additionally, the optical system 1000 can improve chromatic aberration. Preferably, Equation 19 may satisfy: 0.4<CA52/CA82≤0.9.

$$1 < CA 92 / CA 11 < 5 \qquad [ Equation 20 ]$$

In Equation 20, when the effective diameter CA91 of the eighteenth surface S18 of the ninth lens 119 and the effective diameter CA11 of the first surface S1 of the first lens 111 are satisfied, the effective diameter and optical path between the incident-side lens and the last lens may be set. Accordingly, the optical system 1000 can set the FOV and the size of the optical system. Preferably, Equation 20 may satisfy: 2<CA92/CA11<3.5.

$$3 < CA 92 / CG 8 < 15 \qquad [ Equation 20 ‐ 1 ]$$

In Equation 20-1, CA92 is the effective diameter of the largest lens surface and is the effective diameter of the eighteenth surface S18 of the ninth lens 119. When the optical system 1000 according to the second embodiment satisfies Equation 20-1, the optical system 1000 can improve aberration characteristics and control TTL reduction. Preferably, Equation 20-1 may satisfy: 3<CA92/CG8<10.

$$3 < CA 82 / CG 8 < 15 \qquad [ Equation 20 ‐ 2 ]$$

Equation 20-2 can set the effective diameter CA82 of the sixteenth surface S16 of the eighth lens 118 and the optical axis distance CG8 between the eighth and ninth lenses 118 and 119. When the optical system 1000 according to the second embodiment satisfies Equation 20-2, the optical system 1000 can improve aberration characteristics and control TTL reduction. Preferably, Equation 20-2 may satisfy: 2<CA82/CG8<7.

$$1 < CG 2 / EG 2 < 10 \qquad [ Equation 21 ]$$

In Equation 21, when the optical axis distance CG2 and the edge distance EG3 between the second and third lenses 112 and 113 are satisfied, the optical system 1000 can reduce chromatic aberration and improve aberration characteristics, and can control vignetting for optical performance. Additionally, by designing the edge distance between the second and third lenses 112 and 113 to be smaller than the center distance, distortion aberration can be corrected. Preferably, Equation 21 may satisfy: 3<CG2/EG2<8. Additionally, the condition may satisfy: 35< (CG2/EG2)*n<60, where n is the total number of lenses.

$$0 < CG 7 / EG 7 < 2 \qquad [ Equation 22 ]$$

In Equation 22, when the optical axis distance CG7 and the edge distance EG7 between the seventh and eighth lenses 117 and 118 are satisfied, the optical system can have good optical performance even in the center and periphery portions of the FOV. Additionally, by designing the edge distance between the seventh and eighth lenses 117 and 118 to be smaller than the center distance, distortion aberration can be compensated. Preferably, the condition may satisfy: 0<CG7/EG7<1. At least one of Equations 21 and 22 may further include at least one of Equations 22-1 to 22-7.

$$0.2 < CG 1 / EG 1 < 1 \qquad [ Equation 22 ‐ 1 ]$$

$$0 < CG 3 / EG 3 < 0.5 \qquad [ Equation 22 ‐ 2 ]$$

$$0 < CG 4 / EG 4 < 1 \qquad [ Equation 22 ‐ 3 ]$$

$$3 < CG 5 / EG 5 < 8 \qquad [ Equation 22 ‐ 4 ]$$

$$0.5 < CG 6 / EG 6 < 2 \qquad [ Equation 22 ‐ 5 ]$$

$$1 < CG 8 / EG 8 < 5 \qquad [ Equation 22 ‐ 6 ]$$

$$18 < ( CG 8 / EG 8 ) * n < 40 , \qquad [ Equation 22 ‐ 7 ]$$

$$where n is the total number of lenses .$$

By setting the effective diameter of each lens and the center distance and edge distance between adjacent lenses using Equations 16 to 22, the optical path in the center and the outer portion of the optical system 1000 can be adjusted. Accordingly, the optical system can have good optical performance even in the center and periphery portions of the FOV, and the occurrence of distortion can be suppressed.

$$0 < G8\_Max / CG 8 < 2 \qquad [ Equation 23 ]$$

In Equation 23, G8_Max means the maximum distance (mm) between the eighth and ninth lenses 118 and 119. When the optical system 1000 according to the second embodiment satisfies Equation 23, optical performance can be improved in the periphery portion of the FOV, and distortion of aberration characteristics can be suppressed. Preferably, G8_Max and CG8 in Equation 23 may be the same.

$$0 < CT 7 / CG 8 < 1 \qquad [ Equation 24 ]$$

In Equation 24, when the center thickness CT7 of the seventh lens 117 and the optical axis distance CG8 between the eighth and ninth lenses 118 and 119 are satisfied, the optical system 1000 is positioned between the eighth and ninth lenses. The optical axis distance CG8 and the center thickness of the seventh lens 117 can be set, and the optical performance of the periphery portion of the FOV can be improved. Preferably, Equation 24 may satisfy: 0<CT7/CG8<0.5.

$$1 < CG 8 / CT 8 < 7 \qquad [ Equation 25 ]$$

In Equation 25, when the center thickness CT8 of the eighth lens 118 and the optical axis distance CG8 between the eighth and ninth lenses 118 and 119 are satisfied, the optical system 1000 is configured to use the eighth and ninth lenses. The effective diameter size and distance can be reduced, and optical performance in the periphery portion of the FOV can be improved. Preferably, Equation 25 may satisfy: 3<CG8/CT8<6.

$$2 < CG 8 / CT 9 < 6 \qquad [ Equation 26 ]$$

In Equation 26, when the center thickness CT9 of the ninth lens 119 and the optical axis distance CG8 between the eighth and ninth lenses 118 and 119 are satisfied, the optical system 1000 has an effective diameter of the ninth lens. The size and optical axis distance between the eighth and ninth lenses can be reduced, and optical performance in the periphery portion of the FOV can be improved. Preferably, Equation 26 may satisfy: 3<CG8/CT9<5.5.

$$1 < L 5 R 2 / CT 5 < 100 \qquad [ Equation 27 ]$$

In Equation 27, when the curvature radius L5R2 of the tenth surface S10 of the fifth lens 115 and the center thickness CT5 of the fifth lens 115 are satisfied, the optical system 1000 may control the refractive power of the fifth lens 115 and improve the optical performance of light incident on the second lens group LG2. Preferably, Equation 27 may satisfy: 10<L5R2/CT5<30. Preferably, the condition L5R2>0 may be satisfied.

$$0 < L 5 R 1 / L 8 R 1 < 10 \qquad [ Equation 28 ]$$

In Equation 28, when the curvature radius L5R1 of the ninth surface S9 of the fifth lens 115 and the curvature radius L8R1 of the fifteenth surface S15 of the eighth lens 118 are satisfied, optical performance may be improved by controlling the shape and refractive power of the fifth and eighth lenses, and optical performance of the second lens group LG2 may be improved. Preferably, Equation 28 may satisfy: 0<L5R1/L8R1<1. Preferably, the conditions may satisfy: L5R1>0 and L8R1>0.

$$0 < L 1 R 1 / L 1 R 2 < 1 \qquad [ Equation 29 ]$$

Equation 29 can set the curvature radii L1R1 and L1R2 of the object-side first surface S1 and second surface S2 of the first lens 111, and when these are satisfied, the lens size and resolution can be set. Preferably, Equation 29 may satisfy: 0<L1R1/L1R2<0.5. Preferably, L1R1>0 and L1R2>0 may be satisfied.

$$0 < L 2 R 2 / L 2 R 1 < 5 \qquad [ Equation 30 ]$$

Equation 30 can set the curvature radii L2R1 and L2R2 of the object-side third surface S3 and fourth surface S4 of the second lens 112, and when these are satisfied, the resolution of the lens can be determined. Preferably, Equation 30 may satisfy: 0<L2R2/L2R1<1. Preferably, L2R1>0 and L2R2>0 may be satisfied. At least one of Equations 28, 29, and 30 may include at least one of Equations 30-1 to 30-6 below, and can determine the resolution of each lens.

$$1 < L 3 R 1 / L 3 R 2 < 20 and 5 < L 3 R 1 / L 3 R 2 < 15 \qquad [ Equation 30 ‐ 1 ]$$

$$( However , L 3 R 1 , L 3 R 2 < 0. )$$

$$0 < L 4 R 1 / L 4 R 2 < 2 \qquad [ Equation 30 ‐ 2 ]$$

$$The following condition satisfies : 0 < L 5 R 1 / L 5 R 2 < 2 , and \qquad [ Equation 30 ‐ 3 ]$$

$$preferably , the following condition may satisfy : 0 < L 5 R 1 / L 5 R 2 < 1.$$

$$The condition satisfies : 0 < L 6 R 1 / L 6 R 2 < 3 , and \qquad [ Equation 30 ‐ 4 ]$$

$$preferably , the following condition may satisfy : 1 < L 6 R 1 / L 6 R 2 < 2.$$

$$However , L 6 R 1 , L 6 R 2 < 0.$$

$$0 < L 8 R 1 / L 8 R 2 < 1.5 or 0 < L 8 R 1 / L 8 R 2 < 1 \qquad [ Equation 30 ‐ 5 ]$$

$$1 < L 9 R 2 / L 9 R 1 < 5 \qquad [ Equation 30 ‐ 6 ]$$

By setting the center distance and edge distance between two adjacent lenses to the above range using Equations 30, 30-1 to 30-6, the distortion aberration of the aberration characteristic can be corrected.

$$0 < CT\_Max / CG\_Max < 2 \qquad [ Equation 31 ]$$

In Equation 31, when the center thickness of each of the lenses satisfies the thickest thickness CT_Max and the maximum value CG_Max of the air gap or distance in the optical axis between the plurality of lenses, the optical system 1000 has good optical performance at a set FOV and focal length, and the optical system 1000 can be reduced in size, for example, reducing TTL. Preferably, Equation 31 may satisfy: 0<CT_Max/CG_Max<1.

$$0 < \sum CT / \sum CG < 2 \qquad [ Equation 32 ]$$

In Equation 32, ΣCT means the sum of the center thicknesses (mm) of each of the plurality of lenses, and ΣCG means the sum of the distance (mm) in the optical axis OA between two adjacent lenses in the plurality of lenses. When the optical system 1000 according to the second embodiment satisfies Equation 32, the optical system 1000 has good optical performance at the set FOV and focal length, and the optical system 1000 can be reduced in size, for example, TTL can be reduced. Preferably, Equation 32 may satisfy: 0.5<ΣCT/ΣCG<1.2. Accordingly, the optical system can be designed to reduce the center thickness of each lens and increase the distances between adjacent lenses.

$$10 < \sum Index < 20 \qquad [ Equation 33 ]$$

In Equation 33, ΣIndex means the sum of the refractive indices at the d-line of each of the plurality of lenses. When the optical system 1000 according to the second embodiment satisfies Equation 33, the TTL of the optical system 1000 can be controlled and improved resolution can be achieved. Preferably, Equation 33 may satisfy the conditions: 12<ΣIndex<16 and 100<ΣIndex*n, where n is the total number of lenses.

$$10 < \sum Abb / \sum Index < 50 \qquad [ Equation 34 ]$$

In Equation 34, ΣAbbe means the sum of Abbe numbers of each of the plurality of lenses. When the optical system 1000 according to the second embodiment satisfies Equation 34, the optical system 1000 may have improved aberration characteristics and resolution. Preferably, Equation 34 may satisfy: 20<ΣAbb/Index<40. Preferably, the condition may satisfy: 360< (ΣAbb−ΣIndex).

$$0 < \vert Max\_distoition \vert < 5 \qquad [ Equation 35 ]$$

In Equation 35, Max_distortion means the maximum value of distortion in the region from the center (0.0 F) to the diagonal end (1.0 F) based on the optical characteristics detected by the image sensor 300. When the optical system 1000 according to the second embodiment satisfies Equation 35, the optical system 1000 can improve distortion characteristics. Preferably, Equation 35 may satisfy: 1<|Max_distortion|<3.

$$0 < EG\_Max / CT\_Max < 3 \qquad [ Equation 36 ]$$

In Equation 36, CT_Max means the thickest thickness (mm) among the center thicknesses of each of the plurality of lenses, and EG_Max is the maximum distance in edge side between two adjacent lenses. When the optical system 1000 according to the second embodiment satisfies Equation 36, the optical system 1000 has a set FOV and focal length, and can have good optical performance in the periphery portion of the FOV. Preferably, Equation 36 may satisfy: 0<EG_Max/CT_Max<1.

$$0.5 < CA 11 / CA\_Min < 2 \qquad [ Equation 37 ]$$

In Equation 37, when the effective diameter CA11 of the first surface S1 of the first lens 111 and the minimum effective diameter CA_Min of the lens surfaces are satisfied, it is possible to control the amount of light incident through the first lens 111 and provide a slim optical system while maintaining optical performance. Preferably, Equation 37 may satisfy: 1<CA11/CA_Min<1.5.

$$1 < CA\_Max / CA\_Min < 5 \qquad [ Equation 38 ]$$

In Equation 38, CA_Max means the maximum effective diameter among the object-side surfaces and the sensor-side surfaces of the plurality of lenses, and the maximum effective diameter (mm) among the effective diameters (mm) of the first to eighteenth surfaces S1-S18. When the optical system 1000 according to the second embodiment satisfies Equation 38, the optical system 1000 can provide a slim and compact optical system while maintaining optical performance. Preferably, Equation 38 may satisfy: 2<CA_Max/CA_Min<4.5.

$$1 < CA\_Max / CA\_AVR < 3 \qquad [ Equation 39 ]$$

In Equation 39, the maximum effective diameter CA_Max and the average effective diameter CA_AVR are set among the object-side surfaces and the sensor-side surfaces of the plurality of lenses. when these are satisfied, a slim and compact optical system can be provided. Preferably, Equation 39 may satisfy: 1<CA_Max/CA_AVR<2.5.

$$0.1 < CA\_Min / CA\_AVR < 1 \qquad [ Equation 40 ]$$

In Equation 40, the minimum effective diameter CA_Min and average effective diameter CA_AVR can be set among the object-side surfaces and the sensor-side surfaces of the plurality of lenses, and when this is satisfied, a slim and compact optical system can be provided. Preferably, Equation 40 may satisfy: 0.3<CA_Min/CA_AVR<0.9.

$$0.1 < CA\_Max / ( 2 * ImgH ) < 1 \qquad [ Equation 41 ]$$

In Equation 41, set the maximum effective diameter CA_Max among the object-side surfaces and the sensor-side surfaces of the plurality of lenses and the distance (ImgH) from the center (0.0 F) of the image sensor 300 to the diagonal end (1.0 F). when this is satisfied, the optical system 1000 has good optical performance in the center and periphery portions of the FOV and can provide a slim and compact optical system. Here, ImgH may be in the range of 4 mm to 15 mm or 10 mm to 15 mm. Preferably, Equation 41 may satisfy: 0.5≤CA_Max/(2*ImgH)<1. Here, the following condition may satisfy: ImgH<TTL<CA_Max< (2*ImgH).

$$0.1 < TD / CA\_Max < 1.5 \qquad [ Equation 42 ]$$

In Equation 42, TD is the maximum optical axis distance (mm) from the object-side surface of the first lens to the sensor-side surface of the last lens. For example, TD is the distance from the first surface S1 of the first lens 111 to the eighteenth surface S18 of the ninth lens 118 in the optical axis OA. When the optical system 1000 according to the second embodiment satisfies Equation 42, a slim and compact optical system can be provided. Preferably, Equation 42 may satisfy: 0.5<TD/CA_Max<1.

$$0 < F / L 8 R 2 < 5 \qquad [ Equation 43 ]$$

In Equation 43, the total effective focal length F of the optical system 1000 and the curvature radius L8R2 of the sixteenth surface S16 of the eighth lens 118 can be set. when these are satisfied, the optical system 1000 can reduce the size of the optical system 1000, for example, reduce the TTL. Preferably, Equation 43 may satisfy: 1<F/L8R2<2.

Equation 43 may further include Equation 43-1 below.

$$2 < F / F \# < 8 \qquad [ Equation 43 ‐ 1 ]$$

The F # may mean the F number. Preferably, Equation 43-1 may satisfy: 3<F/F #<8.

$$1 < F / L 9 R 2 < 5 \qquad [ Equation 43 ‐ 2 ]$$

Equation 43-2 can set the total effective focal length F of the optical system 1000 and the curvature radius L9R2 of the eighteenth surface S18 of the ninth lens 119. Preferably, Equation 43-2 may satisfy: 2<F/L9R2<4.5.

$$1 < F / L 1 R 1 < 10 \qquad [ Equation 44 ]$$

In Equation 44, the curvature radius L1R1 and the total effective focal length F of the first surface S1 of the first lens 111 can be set, and when this is satisfied, the optical system 1000 can be reduced in size, for example, reducing TTL. Preferably, Equation 44 may satisfy: 1<F/L1R1<5.

$$0 < EPD / L 9 R 2 < 5 \qquad [ Equation 45 ]$$

In Equation 45, EPD means the size (mm) of the entrance pupil diameter of the optical system 1000, and L9R2 means the curvature radius (mm) of the eighteenth surface S18 of the ninth lens 119. When the optical system 1000 according to the second embodiment satisfies Equation 45, the optical system 1000 can control the overall brightness and have good optical performance in the center and periphery portions of the FOV. Preferably, Equation 45 may satisfy: 1<EPD/L9R2<3.

Equation 45 may further include Equation 45-1 below.

$$2 < EPD / F \# < 4 \qquad [ Equation 45 ‐ 1 ]$$

$$0.5 < EPD / L 1 R 1 < 8 \qquad [ Equation 46 ]$$

Equation 46 represents the relationship between the size of the entrance pupil diameter of the optical system and the curvature radius of the first surface S1 of the first lens 111, and can control incident light. Preferably, Equation 46 may satisfy: 0.5<EPD/L1R1<1.5.

$$0 < \vert F 1 / F 2 \vert < 2 \qquad [ Equation 47 ]$$

In Equation 47, the focal lengths F1 and F2 of the first and second lenses 111 and 112 can be set. Accordingly, resolution can be improved by adjusting the refractive power of the incident light of the first and second lenses 111 and 112, and TTL can be controlled. Preferably, Equation 47 may satisfy: 0<|F1/F2|<1, and the conditions may satisfy: F1>0 and F2<0.

$$0 < F 12 / F < 5 \qquad [ Equation 48 ]$$

By setting the composite focal length F12 of the first and second lenses and the total focal length F in Equation 48, the optical system 1000 can improve resolution by adjusting the refractive power of the incident light, and the optical system 1000 can control TTL. Preferably, Equation 48 may satisfy: 1<F12/F<3.

$$0 < \vert F 39 / F 12 \vert < 2 \qquad [ Equation 49 ]$$

In Equation 49, the composite focal length F12 of the first and second lenses, that is, the focal length (mm) of the first lens group, and the composite focal length F39 of the third to ninth lenses, that is, the focus length of the second lens group can be set, and when this is satisfied, the refractive power of the first lens group and the refractive power of the second lens group can be controlled to improve resolution, and the optical system can be provided in a slim and compact size. Additionally, when Equation 49 is satisfied, the optical system 1000 can improve aberration characteristics such as chromatic aberration and distortion aberration. Equation 49 may preferably satisfy: 0.5<F39/F12<1.5. Here, the following conditions may satisfy: F12>0 and F39>0.

$$F 13 < \vert F 49 \vert \qquad [ Equation 49 ‐ 1 ]$$

In Equation 49-1, F13 is the composite focal length of the first to third lenses and may have positive refractive power, and F49 is the composite focal length of the fourth to ninth lenses and may have negative refractive power. When Equation 49-1 is satisfied, the optical system 1000 can improve aberration characteristics such as chromatic aberration and distortion aberration.

$$0 < F 1 / F < 3 \qquad [ Equation 50 ]$$

In Equation 50, the total focal length F and the focal length F1 of the first lens 111 can be set, and resolution can be improved. Equation 50 may satisfy: 0<F1/F<2, and satisfies the following condition: F>0.

$$0 < \vert F 2 \vert / F < 5 ( where , F 2 < 0 ) \qquad [ Equation 50 ‐ 1 ]$$

$$1 < \vert F 3 / F 2 \vert < 10 ( where F 3 > 0 ) \qquad [ Equation 50 ‐ 2 ]$$

$$5 < \vert F 4 / F \vert < 20 ( where F 4 < 0 ) \qquad [ Equation 50 ‐ 3 ]$$

$$1 < F 5 / F < 10 ( where , F 5 > 0 ) \qquad [ Equation 50 ‐ 4 ]$$

$$5 < F 6 / F < 20 ( where , F 6 > 0 ) \qquad [ Equation 50 ‐ 5 ]$$

$$10 < F 7 / F < 30 ( where , F 7 > 0 ) \qquad [ Equation 50 ‐ 7 ]$$

$$5 < F 8 / F < 20 ( where , F 8 > 0 ) \qquad [ Equation 50 ‐ 7 ]$$

$$0 < \vert F 9 \vert / F < 1.5 ( where F 9 < 0 ) \qquad [ Equation 50 ‐ 8 ]$$

In equations 50-1 to 50-8, F3, F4, F5, F6, F7, F8, and F9 mean the third, fourth, fifth, sixth, seventh, eighth, and ninth lenses 113, 114, 115, 116, 117, 118, and 119 mean the focal length mm, when this is satisfied, resolution can be improved by controlling the refractive power of each lens, and the optical system can be provided in a slim and compact size. The focal length of each lens may be distributed to advantageously correct chromatic aberration.

$$0 < F 1 / F 12 < 2 \qquad [ Equation 51 ]$$

In Equation 51, the resolution of the first lens group can be adjusted by setting the focal length F1 of the first lens and the composite focal length F12 of the first and second lenses. Preferably, the condition may satisfy: 10<F12−F1<20.

$$0 < \vert F 1 / F 39 \vert < 2 \qquad [ Equation 52 ]$$

By setting the focal length F1 of the first lens and the composite focal length F39 of the third to ninth lenses in Equation 52, the size and resolution of the optical system can be adjusted. Preferably, Equation 52 may satisfy: 0<F1/F39<1.

$$0 < F 1 / F 4 < 1 \qquad [ Equation 53 ]$$

By setting the focal length F1 of the first lens and the focal length F4 of the fourth lens in Equation 53, the refractive power of light incident on the first and second lens groups can be controlled, and the size and resolution of the optical system can be adjusted. Preferably, Equation 53 may satisfy: 0<F1/F4<0.5.

$$2 mm < TTL < 20 mm \qquad [ Equation 54 ]$$

In Equation 54, TTL means the distance (mm) on the optical axis OA from the vertex of the first surface S1 of the first lens 111 to the image surface of the image sensor 300. Preferably, Equation 54 may satisfy: 10<TTL<20, and thus a slim and compact optical system can be provided.

$$6 mm < ImgH \qquad [ Equation 55 ]$$

Equation 55 sets the diagonal size (2*ImgH) of the image sensor 300 to exceed 6 mm, thereby providing an optical system with high resolution. Equation 55 may preferably satisfy: 8≤ImgH≤15 or 8<ImgH≤14. Equation 55 may include at least one of the following Equations 55-1 to 55-4.

$$0 < \sum CT / ImgH < 1 \qquad [ Equation 55 ‐ 1 ]$$

$$0 < \sum CG / ImgH < 1 \qquad [ Equation 55 ‐ 2 ]$$

$$1 < \sum Index / ImgH < 3 \qquad [ Equation 55 ‐ 3 ]$$

$$20 < \sum Abbe / ImgH < 50 \qquad [ Equation 55 ‐ 4 ]$$

$$( \sum CT / n ) > ( \sum CT / ImgH ) \qquad [ Equation 55 ‐ 5 ]$$

$$( \sum CG / n ) > ( \sum CG / ImgH ) \qquad [ Equation 55 ‐ 6 ]$$

$$( \sum Index / n ) > ( \sum Index / ImgH ) \qquad [ Equation 55 ‐ 7 ]$$

$$( \sum Abbe / n ) > ( \sum Abbe / ImgH ) \qquad [ Equation 55 ‐ 8 ]$$

Equations 55-1 to 55-8 establish the relationship between ImgH and the sum of the center thicknesses of all lenses, the sum of the center distance between lenses, the sum of refractive indices of all lenses, the sum of Abbe numbers of all lenses, and the number of total lenses. Accordingly, the resolution and size of an optical system equipped with an image sensor having a diagonal length of more than 12 mm or more than 16 mm can be adjusted.

$$BFL < 2.5 mm \qquad [ Equation 56 ]$$

Equation 56 shows that by setting the BFL to less than 2.5 mm, the installation space for the filter 500 can be secured, the assembly of components can be improved through the distance between the image sensor 300 and the last lens, and the coupling reliability can be improved. Equation 56 may preferably satisfy: 1<BFL<2.

$$2 mm < F < 20 mm \qquad [ Equation 57 ]$$

In Equation 57, the total focal length F can be set to suit the optical system, and preferably, it may satisfy: 5 mm<F<15 mm.

$$FOV < 120 degrees \qquad [ Equation 58 ]$$

In Equation 58, FOV means the field of view (Degree) of the optical system 1000, and can provide an optical system of less than 120 degrees. The FOV may be 70 degrees or more, for example, in the range of 70 degrees to 100 degrees.

$$0.1 < TTL / CA\_Max < 2 \qquad [ Equation 59 ]$$

By setting the maximum effective diameter CA_Max and TTL among the object-side and sensor-side surfaces of the plurality of lenses in Equation 59, a slim and compact optical system can be provided. Preferably, Equation 59 may satisfy: 0.5<TTL/CA_Max<1.

$$0.5 < TTL / ImgH < 3 \qquad [ Equation 60 ]$$

Equation 60 can set the total optical axis length (TTL) of the optical system and the diagonal length (ImgH) of the optical axis of the image sensor 300. When the optical system 1000 according to the second embodiment satisfies Equation 60, the optical system 1000 includes a relatively large image sensor 300, for example, BFL for application of the large image sensor 300 of around 1 inch or so, and may have a smaller TTL, thereby implementing high-definition image quality and a slim structure. Preferably, Equation 60 may satisfy: 1<TTL/ImgH<1.5. Preferably, the conditions may satisfy: 150<TTL*ImgH<250.

$$0.01 < BFL / ImgH < 0.5 \qquad [ Equation 61 ]$$

Equation 61 can set the optical axis distance between the image sensor 300 and the last lens and the diagonal length from the optical axis of the image sensor 300. When the optical system 1000 according to the second embodiment satisfies Equation 61, the optical system 1000 may secure a relatively large image sensor 300, for example, BFL for application of the large image sensor 300 of around 1 inch in size, and the distance between the last lens and the image sensor 300 may be minimized, so that good optical properties may be obtained on the center and periphery portions of FOV. Preferably, Equation 61 may satisfy: 0.10<BFL/ImgH<0.40.

$$4 < TTL / BFL < 10 \qquad [ Equation 62 ]$$

Equation 62 can set (unit, mm) the total optical axis length TTL of the optical system and the optical axis distance BFL between the image sensor 300 and the last lens. When the optical system 1000 according to the second embodiment satisfies Equation 62, the optical system 1000 secures BFL and can be provided in a slim and compact manner. Equation 62 may satisfy: 6<TTL/BFL<9.

$$0.5 < F / TTL < 1.5 \qquad [ Equation 63 ]$$

Equation 63 can set the total focal length F and total optical axis length TTL of the optical system 1000. Accordingly, a slim and compact optical system can be provided. Equation 63 may preferably satisfy: 0.5<F/TTL<1.

$$0 < F \# / TTL < 0.5 \qquad [ Equation 63 - 1 ]$$

Equation 63-1 can set the F number F # and total optical axis length TTL of the optical system 1000. Accordingly, a slim and compact optical system can be provided.

$$3 > F / BFL < 10 \qquad [ Equation 64 ]$$

Equation 64 can set the total focal length F of the optical system 1000 and the optical axis distance BFL between the image sensor 300 and the last lens. When the optical system 1000 according to the second embodiment satisfies Equation 64, the optical system 1000 can have a set FOV and an appropriate focal length, and a slim and compact optical system can be provided. Additionally, the optical system 1000 can minimize the distance between the last lens and the image sensor 300 and thus have good optical characteristics at the periphery portion of the FOV. Preferably, Equation 64 may satisfy: 4<F/BFL<8.

$$0 < F / ImgH < 3 \qquad [ Equation 65 ]$$

Equation 65 can set the total focal length F (unit: mm) of the optical system 1000 and the diagonal length (ImgH) from the optical axis of the image sensor 300. This optical system 1000 uses a relatively large image sensor 300, for example, around 1 inch in size, and may have improved aberration characteristics. Preferably, Equation 65 may satisfy: 0.7<F/ImgH<1.5.

$$1 < F / EPD < 5 \qquad [ Equation 66 ]$$

Equation 66 can set the total focal length F and EPD of the optical system 1000. Accordingly, the overall brightness of the optical system can be controlled. Preferably, Equation 66 may satisfy: 1.5<F/EPD<3.

$$0 < BFL / TD < 0.5 \qquad [ Equation 67 ]$$

In Equation 67, the optical axis distance BFL between the image sensor 300 and the last lens and the optical axis distance TD of the lenses are set. when this is satisfied, the optical system 1000 can provide a slim and compact optical system. Preferably, Equation 67 may satisfy: 0<BFL/TD<0.3. When BFL/TD exceeds 0.3, BFL is designed to be large compared to TD, so the size of the entire optical system becomes large, making miniaturization of the optical system difficult, and the distance between the ninth lens and the image sensor becomes long, so the amount of unnecessary light can be increased through the ninth lens and the image sensor, resulting in a decrease in resolution, such as deteriorating aberration characteristics.

$$0 < EPD / ImgH / FOV < 0.2 \qquad [ Equation 68 ]$$

In Equation 68, the relationship between the entrance pupil diameter EPD, the length (ImgH) of half the maximum diagonal length of the image sensor, and the FOV can be established. Accordingly, the overall size and brightness of the optical system can be controlled. Equation 68 may preferably satisfy: 0<EPD/ImgH/FOV<0.01.

$$10 < FOV / F \# < 55 \qquad [ Equation 69 ]$$

Equation 69 can establish the relationship between the FOV of the optical system and the F number. Equation 69 may preferably satisfy: 30<FOV/F #<50.

$$0 < n 1 / n 2 < 1.5 \qquad [ Equation 70 ]$$

When the refractive indices n1 and n2 at the d-line of the first and second lenses 111 and 112 of Equation 70 satisfy the above range, the optical system can improve the resolution of incident light. Preferably, the condition may satisfy: 0.5<n1/n2<1.

$$0 < n 3 / n 4 < 1.5 \qquad [ Equation 71 ]$$

If the refractive indices n3 and n5 at the d-line of the third and fourth lenses 113 and 114 of Equation 71 satisfy the above range, the optical system can improve the resolution of the incident light of the second lens group LG2. Preferably, Equation 71 may satisfy: 0.5<n3/n4<1.

$$( v {2}^{*} n 2 ) < ( v {1}^{*} n 1 ) \qquad [ Equation 72 ]$$

In Equation 72, when the refractive index n1 and Abbe number v1 of the first lens 111 and the refractive index n2 and Abbe number v2 of the second lens 112 are satisfied, the first and second lenses 111 and 112, the color dispersion of the transmitted light can be controlled.

$$0 < Inf 91 / Inf 92 < 1 \qquad [ Equation 73 ]$$

In Equation 73, the distance Inf91 from the optical axis OA to the critical point of the seventeenth surface S17 of the ninth lens 119 and the distance Inf92 from the optical axis OA to the critical point of the eighteenth surface S18 can be set, and when this is satisfied, the curvature aberration of the ninth lens can be controlled. Equation 73 may satisfy: 0.2<Inf91/Inf92<0.8.

$$0 < Inf 81 / Inf 82 < 1.5 \qquad [ Equation 74 ]$$

In Equation 74, the distance Inf81 from the optical axis OA to the critical point of the fifteenth surface S15 of the eighth lens 118 and the distance Inf82 from the optical axis OA to the critical point of the sixteenth surface S16 can be set, and when this is satisfied, the curvature aberration of the eighth lens can be controlled. Equation 74 may satisfy: 0.5<Inf81/Inf82<1.

$$0.8 < Inf 82 / Inf 92 < 1.5 \qquad [ Equation 75 ]$$

If Equation 75 is satisfied, the curvature aberration of the eighth and ninth lenses can be controlled. Equation 75 may satisfy: 1<Inf82/Inf92<1.5.

$$1 < ( TTL / ImgH ) * \vert Max\_Sag92 \vert * n < 15 \qquad [ Equation 76 ]$$

Equation 76 can set the edge height of the sensor-side surface of the last lens, TTL, and ImgH and preferably satisfies the following condition: 10< (TTL/ImgH)*|Max_Sag92|*n<15.

$$1 < ( F / ImgH ) * \vert Max\_Sag92 \vert * n < 15 \qquad [ Equation 77 ]$$

Equation 77 can set the edge height of the sensor-side surface of the last lens, F and ImgH and preferably satisfies the following condition: 8< (F/ImgH)*|Max_Sag92|*n<15.

$$30 < ( TD\_LG2 / TD\_LG1 ) * n < 60 \qquad [ Equation 78 ]$$

$$15 < ( CT\_Max + CG\_Max ) * n < 45 \qquad [ Equation 79 ]$$

$$100 < ( FOV * TTL ) / n < 200 \qquad [ Equation 80 ]$$

Preferably, Equation 80 may satisfy the condition: 130< (FOV*TTL)/n<180, depending on the FOV of the optical system and the number n of lenses.

$$FOV < ( TTL * n ) \qquad [ Equation 81 ]$$

$$10 < ( CA\_Max * TD ) / n < 50 \qquad [ Equation 82 ]$$

$$300 < \vert Max\_Sag \vert * TD * n \qquad [ Equation 83 ]$$

In Equation 83, Max_Sag is the maximum Sag value (absolute value) among the object-side and sensor-side surfaces of each lens, and preferably satisfies the following condition: 300<|Max_Sag|*TD*n<500. In the above, * represents multiplication.

In equations 76 to 83, n is the total number of lenses, and relationships between the optical axis distance TD_LG1 of the first lens group LG1, the optical axis distance TD_LG2 of the second lens group LG2, and the maximum center thickness CT_Max of the lenses, maximum center distance CG_Max, FOV, TTL, maximum Sag value on the sensor-side surface of the eighth lens 118 or maximum Sag value Max_Sag in the entire lens, optical axis distance TD of the lenses, and the like may be set according to the total number of lenses. Accordingly, it is possible to control the chromatic aberration, resolution, size, etc. of an optical system with 10 or less lenses.

As shown in FIG. 13, in the second embodiment, at least one or all lens surfaces of the plurality of lenses may include an aspherical surface with a 30th order aspherical coefficient. For example, the first to ninth lenses 111-119 may include lens surfaces having a 30th order aspherical coefficient from the first surface S1 to the eighteenth surface S18. As described above, an aspheric surface with a 30th order aspheric coefficient (a value other than “0”) can particularly significantly change the aspheric shape of the periphery portion, so the optical performance of the periphery portion of the FOV can be well corrected.

The optical system 1000 according to the second embodiment may satisfy at least one or two of Equations 1 to 83. In this case, the optical system 1000 has improved optical characteristics and improved resolution, and can improve aberration and distortion characteristics. In addition, the optical system 1000 can secure the BFL for applying a large-sized image sensor 300, and can minimize the distance between the last lens and the image sensor 300, thereby having good optical performance on the center and periphery portions of FOV. In addition, when the optical system 1000 satisfies at least one of Equations 1 to 83, it may include a relatively large image sensor 300, have a relatively small TTL value, and be slimmer. A compact optical system and a camera module having the same can be provided.

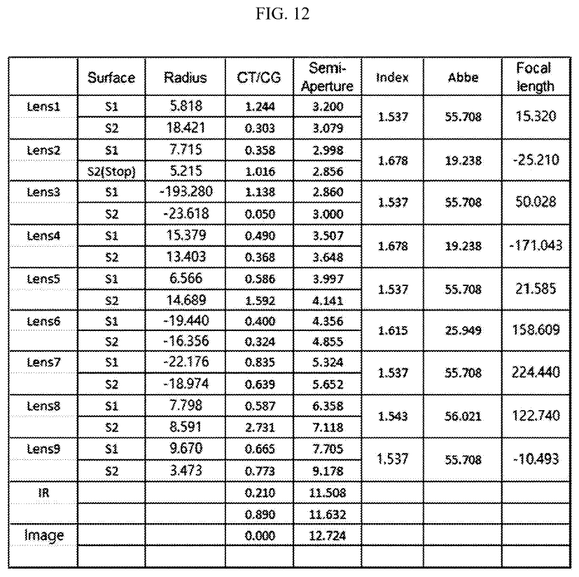

FIG. 12 is an example of lens data according to an embodiment having the optical system of FIG. 10. As shown in FIG. 12, the curvature radius on the optical axis OA of the first to ninth lenses 111-119, the center thickness CT of each lens, and the center distance CG between two adjacent lenses, refractive index at d-line (588 nm), Abbe Number and effective radius (Semi-Aperture), and focal length.

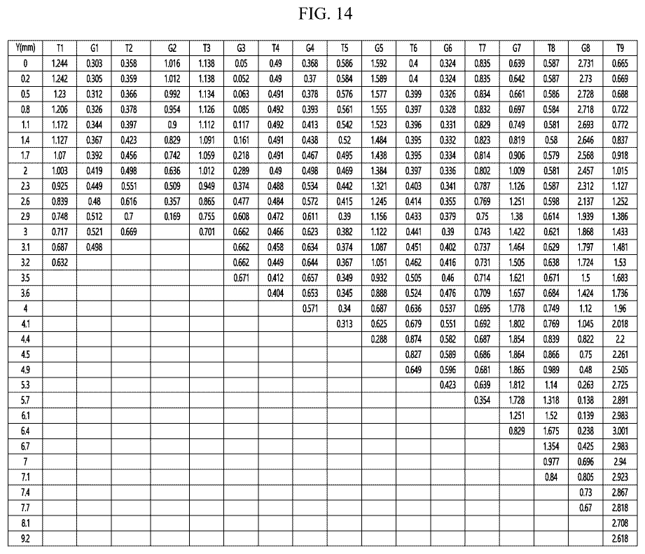

As shown in FIG. 14, the first to ninth thicknesses T1-T9 of the first to ninth lenses 111-119 can be expressed at distances of 0.1 mm or more in the direction Y from the center of each lens to the edge. In addition, the distances between adjacent lenses may be represented by an distance of 0.1 mm or more in the direction from the center toward the edge with respect to the first distance G1 between the first and second lenses, the second distance G2 between the second and third lenses, the third distance G3 between the third and fourth lenses, the fourth distance G4 between the fourth and fifth lenses, the fifth distance G5 between the fifth and sixth lenses, the fifth distance G6 between the sixth and seventh lenses, and the seventh distance G7 between the seventh and eighth lenses. The optical system can be provided in a slim and compact size by correcting distortion aberrations using the above-mentioned first to ninth thicknesses T1-T9 and first to eighth distances G1-G8.

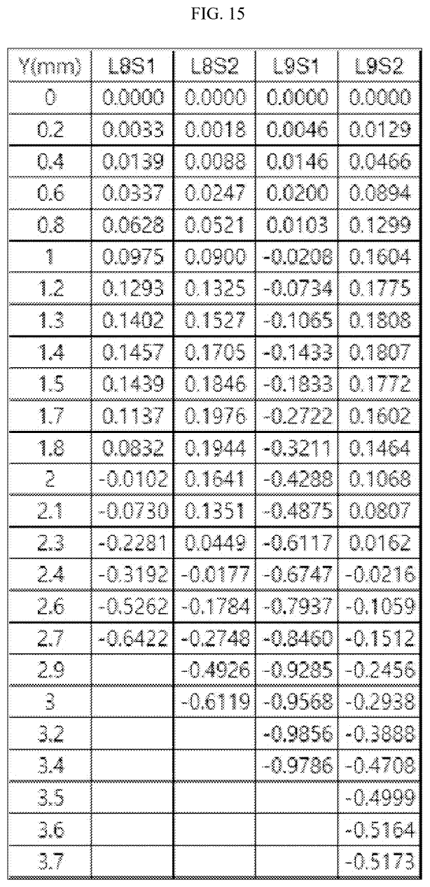

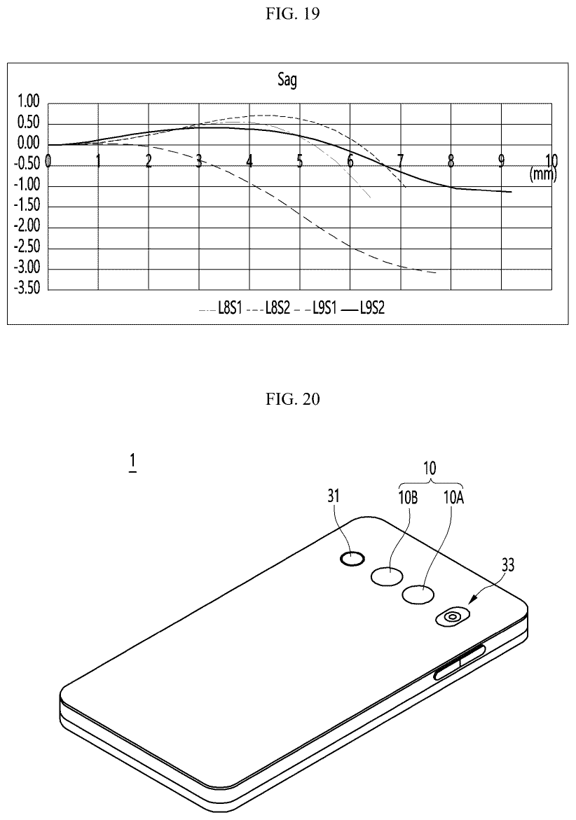

FIG. 15 illustrates a height (Sag value) from a straight line in the Y-axis direction orthogonal to the center of the object-side surface L8S1 and the sensor-side surface L8S2 of the eighth lens 118, and the object-side surface L9S1 and sensor-side surface L9S2 of the ninth lens 119 according to an embodiment of the invention, to a lens surface at distances of 0.1 mm or more, and FIG. 19 is a graph showing data of Sag values of the eighth and ninth lenses of FIG. 15.

Referring to FIGS. 11, 15, and 19, the object-side surface L8S1 and the sensor-side surface L8S2 of the eighth lens have critical points that protrude toward the sensor side based on the center of each lens surface, and it may be seen that the critical point P1 of L8S1 exists at 3.7 mm=0.3 mm from the optical axis, and the critical point P2 of L8S2 exists at 4.3 mm=0.3 mm from the optical axis. The object-side surface L9S1 and the sensor-side surface L9S2 of the ninth lens have a critical point that protrudes toward the sensor side based on the center of each lens surface, and it may be seen that the critical point P3 of the L9S1 exists 1.2 mm+0.3 mm from the optical axis, and the critical point P4 of L9S2 exists at 3.3 mm+0.3 mm from the optical axis.

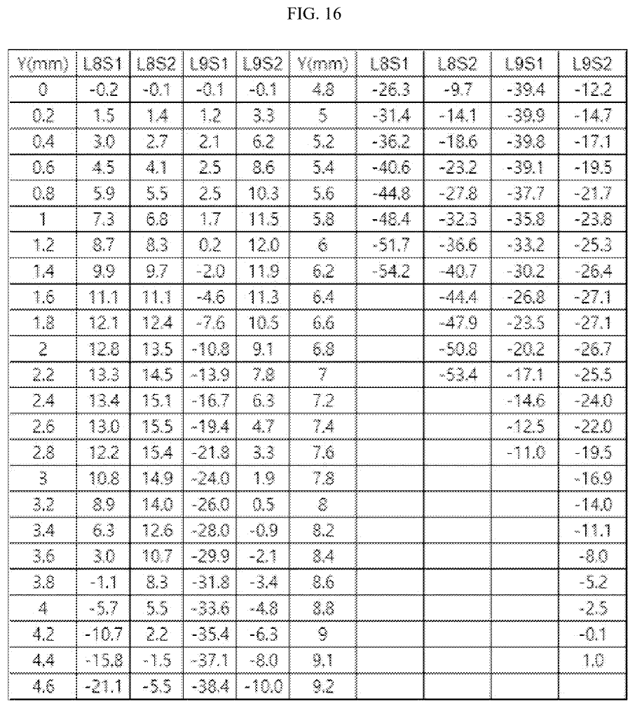

FIG. 16 is a table showing the inclination angle between the object-side surface and the sensor-side surface of the eighth and ninth lenses according to an embodiment of the invention in terms of height (Sag value) from the straight line in the Y-axis direction to the lens surface at distances of 0.1 mm or more. As shown in FIG. 16, it may be seen that the object-side surface L8S1 and the sensor-side surface L8S2 of the eighth lens 118 have the maximum inclination angle (absolute value) greater than the maximum inclination angle (absolute value) of the object-side surface L9S1 and the sensor-side surface L9S2 of the ninth lens 119. In addition, the position of the maximum inclination angle (absolute value) of the object-side surface L8S1 and the sensor-side surface L8S2 of the eighth lens 118 is adjacent to the edge or the edge, and may be disposed further outward than the position of the maximum inclination angle (absolute value) of the object-side surface L9S1 and the sensor-side surface L9S2 of the ninth lens 119. Accordingly, the effective diameter of the ninth lens 119 can be increased, and the ninth lens 119 can guide light traveling through the outer portion of the eighth lens 118 to the image sensor 300.

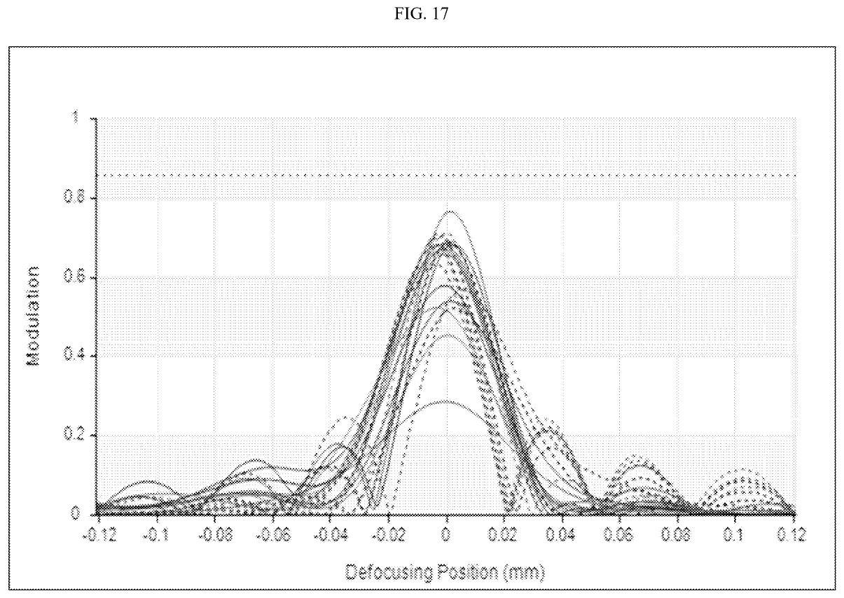

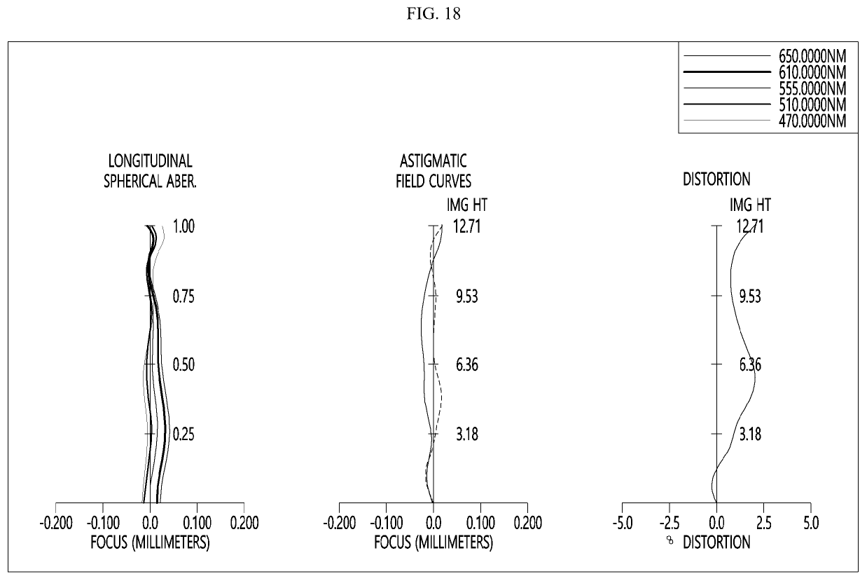

FIG. 17 is a graph showing the diffraction MTF characteristics of an optical system according to an embodiment of the invention, and FIG. 18 is a graph showing aberration characteristics of an optical system according to an embodiment of the invention.

As shown in FIG. 17, in the aberration graph of the optical system according to an embodiment, it is a graph measuring longitudinal aberration, astigmatic field aberration, and distortion from left to right, and a graph measuring from 0.000 mm to 12.722 mm in units of 1.272 mm. The X-axis may represent focal length (mm) and distortion (%), and the Y-axis may represent the height of the image. Additionally, the graph for spherical aberration is a graph for light in the approximately 470 nm, approximately 510 nm, approximately 555 nm, approximately 610 nm, and approximately 660 nm wavelength bands, and the graph for astigmatism and distortion aberration is a graph for light in the approximately 555 nm wavelength band. In the aberration diagram of FIG. 18, it may be interpreted that the closer each curve is to the Y-axis, the better the aberration correction function. Referring to FIG. 18, it may be seen that measurement values of the optical system 1000 according to an embodiment are adjacent to the Y-axis in most regions. That is, the optical system 1000 according to an embodiment may have improved resolution and may have good optical performance not only at the center but also at the periphery portions of the FOV. As confirmed in the second embodiment, the lens system of the second embodiment according to the invention is compact and lightweight with a lens configuration of 10 or less elements, for example, 9 elements, and at the same time has good spherical aberration, astigmatism, distortion aberration, chromatic aberration, and coma aberration. Since it is calibrated and can be implemented at high resolution, it can be used as a built-in camera optical device.

Table 4 shows the items of the above-described equations in the optical system 1000 according to the embodiment, and shows TTL, BFL, F value, ImgH, focal lengths F1, F2, F3, F4, F5, F6, F7, F8, and F9 of each lens, edge thickness, edge distance, composite focal length, and the like of the optical system 1000.

TABLE 4

| Items | Second embodiment | Items | Second embodiment |
|---|---|---|---|
| F | 12.700 | ET1 | 0.627 |
| F1 | 15.320 | ET2 | 0.643 |
| F2 | -25.210 | ET3 | 0.697 |
| F3 | 50.028 | ET4 | 0.401 |
| F4 | -171.043 | ET5 | 0.300 |
| F5 | 21.585 | ET6 | 0.609 |
| F6 | 158.609 | ET7 | 0.402 |
| F7 | 224.440 | ET8 | 0.751 |
| F8 | 122.740 | ET9 | 2.618 |
| F9 | -10.493 | EG1 | 0.502 |
| F12 | 32.085 | EG2 | 0.199 |
| F39 | 30.752 | EG3 | 0.672 |
| Inf81 | 3.7 | EG4 | 0.574 |
| Inf82 | 4.3 | EG5 | 0.358 |
| Inf91 | 1.2 | EG6 | 0.395 |
| Inf92 | 3.3 | EG7 | 0.852 |
| FOV | 88.963 | EG8 | 0.695 |
| EPD | 6.394 | Σbbe | 398.987 |
| BFL | 1.873 | ΣCT | 6.305 |
| TD | 13.327 | ΣCG | 7.023 |
| ImgH | 12.720 | TTL | 15.200 |
| SD | 11.421 | F# | 1.986 |

Table 5 shows the result values for Equations 1 to 42 described above in the optical system 1000 of FIG. 10. Referring to Table 5, it can be seen that the optical system 1000 satisfies at least one, two, or three of Equations 1 to 42. Accordingly, the optical system 1000 can improve optical performance and optical characteristics in the center and periphery portions of the FOV.

TABLE 5

| Equations | | Second embodiment |
|---|---|---|
| 1 | 1 < CT1 / CT2 < 5 | 3.474 |
| 2 | 1 < CT3 / ET3 < 5 | 1.632 |
| 3 | 18 < TTL / CT_AVER < 28 | 21.699 |
| 4 | 1.60 < n2 | 1.678 |
| 5 | 0.8 < Max_Sag92 to Sensor < 1.8 | 1.456 |
| 6 | 0.8 < BFL / Max_Sag92 to Sensor < 2 | 1.286 |
| 7 | 5 < \|L9S2_Max slope\| < 65 | 27.117 |
| 8 | CT1 < \|Max_Sag91\| | Satisfaction |
| 9 | CG2 < \|Max_Sag81\| < CG5 | Satisfaction |
| 10 | 1 < CG8 / EG8 < 10 | 3.927 |
| 11 | 0 < CG8 / CG5 < 3 | 1.715 |
| 12 | 0 < CT1 / CT8 < 3 | 2.119 |
| 13 | 0 < CT7 / CT8 < 3 | 1.422 |
| 14 | 0 < L8R2 / L9R1 < 20 | 0.888 |
| 15 | 0 < (CG8-EG8) / (CG8) < 1 | 0.745 |
| 16 | 0 < CA11 / CA22 < 2 | 1.121 |
| 17 | 1 < CA82 / CA31 < 5 | 2.489 |
| 18 | 0.5 < CA22 / CA31 < 1.5 | 0.998 |
| 19 | 0.1 < CA52 / CA72 < 2 | 0.733 |
| 20 | 1 < CA92 / CA11 < 5 | 2.868 |
| 21 | 1 < CG2 / EG2 < 10 | 5.107 |
| 22 | 0 < CG7 / EG7 < 2 | 0.749 |
| 23 | 0 < G8_Max / CG8 < 2 | 1.000 |
| 24 | 0 < CT7 / CG8 < 1 | 0.306 |
| 25 | 1 < CG8 / CT8 < 7 | 4.650 |
| 26 | 2 < CG8 / CT9 < 6 | 4.106 |
| 27 | 1 < L5R2 / CT5 < 100 | 25.063 |
| 28 | 0 < L5R1 / L8R1 < 10 | 0.842 |
| 29 | 0 < L1R1 / L1R2 < 1 | 0.316 |
| 30 | 0 < L2R2 / L2R1 < 5 | 0.676 |
| 31 | 0 < CT_Max / CG_Max < 2 | 0.456 |
| 32 | 0 < ΣCT / ΣCG < 2 | 0.898 |
| 33 | 10 < ΣIndex < 20 | 14.196 |
| 34 | 10 < ΣAbb / ΣIndex < 50 | 28.105 |
| 35 | 0 < \|Max_distoriton\| < 5 | 2.002 |
| 36 | 0 < EG_Max / CT_Max < 3 | 0.685 |
| 37 | 0.5 < CA11 / CA_Min < 2 | 1.121 |
| 38 | 1 < CA_Max / CA_Min < 5 | 3.214 |
| 39 | 1 < CA_Max / CA_AVR < 3 | 1.971 |
| 40 | 0.1 < CA_Min / CA_AVR < 1 | 0.613 |
| 41 | 0.1 < CA_Max / (2*ImgH) < 1 | 0.722 |
| 42 | 0.1 < TD / CA_Max < 1.5 | 0.726 |

Table 6 shows the result values for Equations 43 to 83 described above in the optical system 1000 of FIG. 10. Referring to Table 6, the optical system 1000 may satisfy at least one or two of Equations 1 to 42. In detail, it can be seen that the optical system 1000 according to the second embodiment satisfies all of the above equations 1 to 83. Accordingly, the optical system 1000 can improve optical performance and optical characteristics in the center and periphery portions of the FOV.

TABLE 6

| Equations | | Second embodiment |
|---|---|---|
| 43 | 0 < F / L8R2 < 5 | 1.478 |
| 44 | 1 < F / L1R1 < 10 | 2.183 |
| 45 | 0 < EPD / L9R2 < 5 | 1.841 |
| 46 | 0.5 < EPD / L1R1 < 8 | 1.099 |
| 47 | 0 < \|F1 / F2\| < 2 | 0.608 |
| 48 | 0 < F12 / F < 5 | 2.526 |
| 49 | 0 < \|F39 / F12\| < 2 | 0.958 |
| 50 | 0 < F1 / F < 3 | 1.206 |
| 51 | 0 < F1 / F12 < 2 | 0.728 |
| 52 | 0 < \|F1 / F39 \| < 2 | 0.498 |
| 53 | 0 < F1 / F4 < 1 | 0.090 |
| 54 | 2 < TTL< 20 | 15.200 |
| 55 | 6 < ImgH | 12.720 |
| 56 | BFL < 2.5 | 1.873 |
| 57 | 2 < F < 20 | 12.700 |
| 58 | FOV < 120 | 88.963 |
| 59 | 0.1 < TTL / CA_Max < 2 | 0.828 |
| 60 | 0.5 < TTL / ImgH < 3 | 1.195 |
| 61 | 0.01 < BFL / ImgH < 0.5 | 0.147 |
| 62 | 4 < TTL / BFL < 10 | 8.116 |
| 63 | 0.5 < F / TTL < 1.5 | 0.836 |
| 64 | 3 < F / BFL < 10 | 6.781 |
| 65 | 0 < F / ImgH < 3 | 0.998 |
| 66 | 1 < F / EPD < 5 | 1.986 |
| 67 | 0 < BFL / TD < 0.5 | 0.141 |
| 68 | 0 < EPD / ImgH / FOV < 0.2 | 0.006 |
| 69 | 10 < FOV / F# < 55 | 44.792 |
| 70 | 0 < n1 / n2 < 1.5 | 0.916 |
| 71 | 0 < n3 / n4 < 1.5 | 0.916 |
| 72 | (v2*n2) < (v1*n1) | Satisfaction |
| 73 | 0 < Inf91 / Inf92 < 1 | 0.364 |
| 74 | 0 < Inf81 / Inf82 < 1.5 | 0.860 |
| 75 | 0.8 < Inf82 / Inf92 < 1.5 | 1.303 |
| 76 | 1 < (TTL / ImgH)*\|Max_Sag92\|*n < 15 | 12.214 |
| 77 | 1 < (F / ImgH)*\|Max_Sag92\|*n < 15 | 10.205 |
| 78 | 30 < (TD_LG2 / TD_LG1)*n < 60 | 49.138 |
| 79 | 15 < (CT_Max+CG_Max)*n < 45 | 35.774 |
| 80 | 100 < (FOV*TTL) / n < 200 | 150.249 |
| 81 | FOV < (TTL*n) | Satisfaction |
| 82 | 10 < (CA_Max*TD) / n < 50 | 27.181 |
| 83 | 300 < \|Max_Sag\|*TD*n | 370.020 |

FIG. 20 is a diagram showing a camera module according to an embodiment applied to a mobile terminal. Referring to FIG. 20, the mobile terminal 1 may include a camera module 10 provided on the rear side. The camera module 10 may include an image capturing function. Additionally, the camera module 10 may include at least one of an auto focus, zoom function, and OIS function.

The camera module 10 can process image frames of still images or videos obtained by the image sensor 300 in shooting mode or video call mode. The processed image frame may be displayed on a display unit (not shown) of the mobile terminal 1 and may be stored in a memory (not shown). In addition, although not shown in the drawing, the camera module may be further disposed on the front of the mobile terminal 1. For example, the camera module 10 may include a first camera module 10A and a second camera module 10B. At this time, at least one of the first camera module 10A and the second camera module 10B may include the optical system 1000 described above. Accordingly, the camera module 10 can have a slim structure and have improved distortion and aberration characteristics. Additionally, the camera module 10 can have good optical performance even in the center and periphery portions of the FOV.

Additionally, the mobile terminal 1 may further include an autofocus device 31. The autofocus device 31 may include an autofocus function using a laser. The autofocus device 31 can be mainly used in conditions where the autofocus function using the image of the camera module 10 disclosed above is degraded, for example, in close proximity of 10 m or less or in dark environments. The autofocus device 31 may include a light emitting unit including a vertical cavity surface emitting laser (VCSEL) semiconductor device, and a light receiving unit such as a photo diode that converts light energy into electrical energy. Additionally, the mobile terminal 1 may further include a flash module 33. The flash module 33 may include a light emitting device inside that emits light. The flash module 33 can be operated by operating a camera of a mobile terminal or by user control.

The features, structures, effects, etc. described in the embodiments above are included in at least one embodiment of the present invention and are not necessarily limited to only one embodiment. Furthermore, the features, structures, effects, etc. illustrated in each embodiment can be combined or modified and implemented in other embodiments by a person with ordinary knowledge in the field to which the embodiments belong. Therefore, contents related to such combinations and modifications should be construed as being included in the scope of the present invention. In addition, although the above description has been made focusing on the examples, this is only an example and does not limit the present invention, and those skilled in the art will understand the above examples without departing from the essential characteristics of the present embodiment. You will be able to see that various modifications and applications are possible. For example, each component specifically shown in the examples can be modified and implemented. And these variations and differences in application should be construed as being included in the scope of the present invention as defined in the appended claims.

1. An optical system comprising:
first to eighth lenses disposed along an optical axis from an object side toward a sensor side,
wherein the first lens has positive refractive power on the optical axis and has a shape in which an object-side surface is convex,
wherein an object-side surface of the third lens has a concave shape on an optical axis,
wherein a number of meniscus-shaped lenses convex on the optical axis toward the object side among the first to eighth lenses is 5 or more,
wherein each of an object-side surface and a sensor-side surface of the seventh lens has a critical point,
wherein each of an object-side surface and a sensor-side surface of the eighth lens has a critical point,
wherein the critical point of the object-side surface of the eighth lens is disposed closer to the optical axis than the critical points of the object-side surface and the sensor-side surface of the seventh lens, and
wherein the following equations satisfy:
$$1.5 < ImgH / ΣCT / < 2.2$$
$$1.6 < ImgH / ΣCG / < 2.3$$
(ImgH is ½ of a maximum diagonal length of an image sensor, ΣCT is a sum of center thicknesses of the first to eighth lenses, and ΣCG is a sum of center distances of the first to eighth lenses).

2. The optical system of claim 1, wherein the critical point of the object-side surface of the eighth lens is located closer to the optical axis than the critical point of the sensor-side surface of the eighth lens.

3. The optical system of claim 2, wherein each of an object-side surface and a sensor-side surface of the fourth lens has a critical point.

4. The optical system of claim 3, wherein each of an object-side surface and a sensor-side surface of the fifth lens has a critical point.

5. The optical system of claim 1, which the following equation satisfies:
$$( TTL * n ) > F O V$$
(TTL is an optical axis distance from a center of the object-side surface of the first lens to an image surface of the image sensor, n is a total number of lenses, and FOV is field of view).

6. The optical system of claim 1,
wherein the following equations satisfy:
$$ImgH < TTL$$
$$150 mm < TTL * ImgH$$
(ImgH is ½ of the maximum diagonal length of the image sensor, and TTL is an optical axis distance from a center of the object-side surface of the first lens to tan image surface of the image sensor).

7. The optical system of claim 1, wherein a refractive index of the first lens satisfies: 1.50<n1<1.6,
wherein a refractive index of the second lens satisfies: 1.60<n2, and
wherein n2 is a largest among the refractive indices of lenses.

8. The optical system of claim 1, wherein the first, second, fourth, fifth, and seventh lenses have a meniscus shape convex on the optical axis toward the object side,
wherein the eighth lens as a meniscus shape convex on the optical axis toward the object side.

9. The optical system of claim 1, wherein a maximum effective diameter CA_Max of object-side surfaces and sensor-side surfaces of the first to eighth lenses satisfies the following equations:
$$0.1 < CA\_Max / ( 2 * ImgH ) < 1$$
$$0.5 < TTL / CA\_Max < 2$$
(ImgH is ½ of the maximum diagonal length of the image sensor, and TTL is an optical axis distance from the object-side surface of the first lens to an image surface of the image sensor).

10. The optical system of claim 1,
wherein the following equation satisfies:
$$( v 2 * n 2 ) < ( v 1 * n 1 )$$
(v1 is an Abbe number of the first lens, v2 is an Abbe number of the second lens, n1 is a refractive index of the first lens, and n2 is a refractive index of the second lens).

11. An optical system comprising:
a first lens having a meniscus shape convex toward the object;
a second lens disposed on a sensor side of the first lens;
n-th lens closest to an image sensor;
an n−1th lens disposed on an object side of the n-th lens;
three or more lenses disposed between the second lens and the n−1th lens,
wherein the second lens has a minimum effective diameter among the lenses of the optical system,
wherein the three or more lenses include a third lens disposed on a sensor side of the second lens,
wherein an object-side surface of the third lens has a concave shape on an optical axis,
wherein the n-th lens has a maximum effective diameter among the lenses of the optical system,
wherein the first lens to the n-th lens are aligned with the optical axis (where n is 10 or less),
wherein a number of lenses with positive refractive power among n lenses is greater than a number of lenses with negative refractive power,
wherein a sensor-side surface of the n-th lens is a minimum among curvature radii of the object-side and sensor-side surfaces of the lenses,
wherein a lens surface with a maximum effective diameter among the above lenses is CA_max,
wherein ½ of a diagonal length of the image sensor is ImgH,
wherein the following Equation satisfies: 0.5≤CA_max/(2*ImgH)<1.

12. The optical system of claim 11,
wherein a total effective focal length is F,
wherein a curvature radius of the object-side surface of the first lens is L1R1,
wherein a curvature radius of the sensor-side surface of the n-th lens is LnR2,
wherein the following equation satisfies: 1<F/L1R1<5 wherein the following equation satisfies: 2<F/LnR2<4.5.

13. The optical system of claim 11,
wherein a sum of center thicknesses of the lenses is ΣCT,
wherein a sum of an optical axis distance between two adjacent lenses is ΣCG,
wherein a maximum center thickness of the lenses is CT_Max,
wherein a maximum optical axis distance between the adjacent lenses is CG_Max,
wherein the following equation satisfies: 0.5<ΣCT/ΣCG<1.2
wherein the following equation satisfies: 15<(CT_Max+CG_Max)*n<45.

14. The optical system of claim 11,
wherein the object-side surface and the sensor-side surface of the n-th lens have a critical point,
wherein the object-side surface and the sensor-side surface of the n−1th lens have a critical point,
wherein the critical point of the sensor-side surface of the n-th lens is disposed closer to the optical axis than the critical point of the object-side surface and the critical point of the sensor-side surface of the n−1th lens.

15. A camera module comprising:
an optical system including a plurality of lenses;
an image sensor disposed on a sensor side of the plurality of lenses; and
an optical filter disposed between the image sensor and a last lens,
wherein the optical system includes an optical system of claim 1.

16. The optical system of claim 1,
wherein the thickness of the first lens in the optical axis is CT1,
wherein the thickness of the second lens in the optical axis is CT2,
wherein the thickness of the third lens in the optical axis is CT3,
wherein following equation satisfies: (CT2+CT3)ΣCT1.

17. The optical system of claim 1,
wherein a focal length of the first lens is F1,
wherein a focal length of the third lens is F3,
wherein the following equation satisfies: F1<F3.

18. The optical system of claim 1, comprising:
an aperture stop disposed around an object-side surface of the second lens.

19. The optical system of claim 11,
wherein the thickness of the first lens in the optical axis is CT1,
wherein the thickness of the second lens in the optical axis is CT2,
wherein the thickness of the third lens in the optical axis is CT3,
wherein following equation satisfies: (CT2+CT3)ΣCT1.

20. The optical system of claim 11,
wherein a focal length of the first lens is F1,
wherein a focal length of the third lens is F3,
wherein the following equation satisfies: F1<F3.
